(19) United States
(12) Patent Application Publication
(10) Pub. No.: US 2012/0099657 A1
(43) Pub. Date: Apr. 26, 2012

(54) IMAGE DECODING DEVICE, IMAGE CODING DEVICE, IMAGE DECODING METHOD, IMAGE CODING METHOD, PROGRAM, AND INTEGRATED CIRCUIT

(76) Inventors: Takeshi Tanaka, Osaka (JP); Naoki Yoshimatsu, Aichi (JP)

(21) Appl. No.: 13/379,442

(22) PCT Filed: Jul. 5, 2010
(86) PCT No.: PCT/JP2010/004384

§ 371 Date: Dec. 20, 2011

(30) Foreign Application Priority Data
Jul. 6, 2009 (JP) 2009-160090

(51) Int. Cl. H04N 7/26

(52) U.S. Cl. 375/240.23; 375/240.24; 375/E07.2; 375/E07.047

(57) ABSTRACT

An image decoding device and an image coding device are each capable of using spatial dependence across a boundary between slices to smoothly execute parallel processing. The image decoding device includes: a first decoding unit (801) decoding a block in a first slice; a second decoding unit (802) decoding a block in a second slice; and a first storage unit (811) storing inter-slice neighboring information (i) generated by decoding a boundary block included in the first slice and adjacent to the second slice and (ii) referenced when a boundary neighboring block included in the second slice and adjacent to the boundary block is decoded. The first decoding unit (801) generates the inter-slice neighboring information by decoding the boundary block and stores the generated information into the first storage unit (811). The second decoding unit (802) decodes the boundary neighboring block by reference to the stored inter-slice neighboring information.

### TECHNICAL FIELD

The present invention relates to image decoding devices for decoding coded images and image coding devices for coding images, and particularly to an image decoding device which performs parallel decoding and an image coding device which performs parallel coding.

### BACKGROUND ART

A conventional image coding device for coding a video sequence divides each picture included in the video sequence into macroblocks, and performs coding for each of the macroblocks. The size of a macroblock is 16 pixels high and 16 pixels wide. Then, the conventional image coding device generates a coded stream, that is, a coded video sequence. After this, a conventional image decoding device decodes this coded stream on a macroblock-by-macroblock basis to reproduce the pictures of the original video sequence.

The conventional coding methods include the International Telecommunication Union Telecommunication Standardization Sector (ITU-T) H.264 standard (see Non Patent Literature 1 and Non Patent Literature 2, for example).

An image coding device and an image decoding device compliant with the H.264 standard use spatial dependence, or more specifically, spatial similarity. By using such similarity, the compression rate is increased.

The H.264 standard employs variable-length coding. By the variable-length coding process, each macroblock is coded into a variable-length code. Here, the image decoding device needs to decode the stream of a picture from the beginning. For this reason, the image coding device and the image decoding device compliant with variable-length coding cannot employ parallel processing with which the processing speed is increased and, therefore, have to speed up the processing by increasing an operating frequency.

With this being the situation, the H.264 standard has adopted the concept of “slice” to implement parallel processing. For example, as shown in FIG. 54A, a picture is divided into slices. Moreover, as shown in FIG. 54B, a start code is placed at the beginning of a slice, so that a start position can be detected. Accordingly, the image coding device and the image decoding device can execute the parallel processing in such a way that the slices are processed simultaneously.

However, when the picture is divided into slices, the image decoding device cannot reference to decoding information across a boundary between the slices. That is, the conventional image coding device and the conventional decoding device cannot use the correlation between data in the same picture, which causes a reduction in the compression rate. Moreover, this results in increasing the bit rate and deteriorating the image quality.

Here, some of the technologies having been proposed as next-generation image coding standards solve such a problem (see Non Patent Literature 3, for example).

In Non Patent Literature 3, a picture is divided into slices each of which can be referenced by another slice (such slices are referred to as “entropy slices” in Non Patent Literature 3), as shown in FIG. 55A. The slice can reference to another slice, across the boundary between the slices. At the beginning of the slice, the variable-length code is initialized. Here, the term “variable-length code” is used for generally referring to a code, such as a Huffman code, a run-length code, or an arithmetic code, which is compressed into a variable-length code. The image decoding device can change a variable-length code table or update context information in the arithmetic code, on the basis of the decoding information of a neighboring slice obtained by using these referable slices.

In this way, the use of referable slices allows the parallel processing to be performed and thus increases the compression rate.

Moreover, in Non Patent Literature 3, an entropy slice is scanned according to the zigzag scanning instead of the conventional raster scanning, as shown in FIG. 55B. By the zigzag scanning, each processing element (PE) which is a unit for executing the processing implements the parallel processing efficiently.

More specifically, as shown in FIG. 55C, when a PE0 completes the processing for a macroblock (MB) 8 of a slice 0, a PE1 can start the processing for an MB 0 of a slice 1. With the conventional raster scanning, the decoding process is performed in a lateral direction. For this reason, the start of the processing performed by the PE1 for the MB 0 is significantly delayed, thereby reducing efficiency.

Furthermore, as shown in FIG. 55C, the units (i.e., the PEs) implement the parallel processing in synchronization with each other on a macroblock-by-macroblock basis.

Note that when the image coding device or the image decoding device codes or decodes the slice 1 by reference to the slice 0, this process may be described by a simple expression such as “the slice 1 references to the slice 0” hereafter. Note also that when the image coding device or the image decoding device codes or decodes an MB 1 by reference to the MB 0, this process may be described by a simple expression such as “the MB 1 references to the MB 0” hereafter.

### CITATION LIST

### Non Patent Literature

### [NPL 1]

ITU-T H.264 Standard: “Advanced video coding for generic audiovisual services”, published in March, 2005.

### [NPL 2]

Thomas Wiegand et al., “Overview of the H.264/AVC Video Coding Standard”, IEEE TRANSACTIONS ON CIRCUITS AND SYSTEMS FOR VIDEO TECHNOLOGY, July 2003, pp. 1-19.

### [NPL 3]

Xun Guo et al., “Ordered Entropy Slices for Parallel CABAC” (online), ITU-T Video Coding Experts Group, Apr. 15, 2009, (searched on Jun. 29, 2009), <URL:http://wftp3.itu.int/av-arch/video-site/0904_Yok/VCEG-AK25. zip> on the Internet.

### SUMMARY OF INVENTION

### Technical Problem

The aforementioned conventional technology (Non Patent Literature 3) describes that the coding efficiency is improved by making reference between the slices. However, a specific structure allowing such reference made between the slices is not disclosed.

Although each PE executes the processing as shown in FIG. 55C, time taken for the processing is different for each PE. For example, PE1 cannot start the processing for the MB 0 of the slice 1 until the PE0 completes the processing for the MB 8 of the slice 0. In addition, the time taken to process the MB 8 of the slice 0 is irregular. Furthermore, since each of the PE0 and PE1 executes the processing independently, the PE1 cannot determine whether or not the PE0 has completed the processing for the MB 8 of the slice 0.

Here, the PE1 may start the processing after the PE0 completes the processing for the entire slice. In this case, however, the parallel processing cannot be executed.

Alternatively, after processing a macroblock, the PE0 may send information on this macroblock to the PE1. However, even when the PE0 sends the information, the PE1 may not be able to start the processing appropriately.

For example, when the PE0 completes the processing for an MB 11 of the slice 0, the PE1 may be currently processing the MB 0 of the slice 1. In this case, even when the PE0 sends information on the MB 11 of the slice 0 to the PE1, the PE1 may not be able to receive the information from the PE0 because the PE1 cannot start the processing for the MB 1 of the slice 1 yet. Therefore, the PE1 cannot receive necessary information when necessary, meaning that the processing may not be executed smoothly.

That is, since the necessary information cannot be referenced when necessary, parallel processing cannot be smoothly implemented by the PEs.

In view of the aforementioned problem, the present invention has an object to provide an image decoding device and an image coding device capable of smoothly executing parallel processing by using spatial dependence across a boundary between slices.

### Solution to Problem

In order to solve the aforementioned problem, the image decoding device in an aspect of the present invention is an image decoding device that decodes an image having a plurality of slices each including at least one block and includes: a first decoding unit which decodes at least one block included in a first slice among the slices; a second decoding unit which decodes at least one block included in a second slice different from the first slice among the slices; and a first storage unit which stores inter-slice neighboring information that is (i) generated by decoding a boundary block that is one of the at least one block included in the first slice and is adjacent to the second slice and (ii) referenced when a boundary neighboring block that is one of the at least one block included in the second slice and is adjacent to the boundary block is decoded, wherein the first decoding unit generates the inter-slice neighboring information by decoding the boundary block and stores the generated inter-slice neighboring information into the first storage unit, and the second decoding unit decodes the boundary neighboring block by reference to the inter-slice neighboring information stored in the first storage unit.

According to this configuration, the image decoding device in the present invention can use the spatial dependence across the boundary between the slices. Moreover, the storage unit accommodates variations in the time taken for the decoding process. This allows the parallel processing to be executed smoothly.

Moreover, the first decoding unit may (i) generate, by decoding an inside first-slice block that is one of the at least one block included in the first slice, inside first-slice neighboring information that is referenced when an inside first-slice neighboring block that is one of the at least one block included in the first slice and is adjacent to the inside first-slice block is decoded, (ii) store the generated inside first-slice neighboring information into the first storage unit, and (iii) decode the inside first-slice neighboring block by reference to the inside first-slice neighboring information stored in the first storage unit, and the second decoding unit may (i) generate, by decoding an inside second-slice block that is one of the at least one block included in the second slice, inside second-slice neighboring information that is referenced when an inside second-slice neighboring block that is one of the at least one block included in the second slice and is adjacent to the inside second-slice block is decoded, (ii) store the generated inside second-slice neighboring information into the first storage unit, and (iii) decode the inside second-slice neighboring block by reference to the inside second-slice neighboring information stored in the first storage unit.

According to this configuration, the information used within the slice is stored in the single storage unit. This can reduce the cost of manufacturing.

Furthermore, the second decoding unit may decode a block that is the boundary neighboring block and is the inside second-slice neighboring block, by reference to the inter-slice neighboring information stored in the first storage unit and the inside second-slice neighboring information stored in the first storage unit.

According to this configuration, the image decoding device in the present invention can use both the spatial dependence across the boundary between the slices and the spatial dependence within the slice.

Moreover, the image decoding device may further include: a second storage unit which stores inside first-slice neighboring information that is (i) generated by decoding an inside first-slice block that is one of the at least one block included in the first slice and (ii) referenced when an inside first-slice neighboring block that is one of the at least one block included in the first slice and is adjacent to the inside first-slice block is decoded; and a third storage unit which stores inside second-slice neighboring information that is (i) generated by decoding an inside second-slice block that is one of the at least one block included in the second slice and (ii) referenced when an inside second-slice neighboring block that is one of the at least one block included in the second slice and is adjacent to the inside second-slice block is decoded, wherein the first decoding unit may generate the inside first-slice neighboring information by decoding the inside first-slice block, store the generated inside first-slice neighboring information into the second storage unit, and decode the inside first-slice neighboring block by reference to the inside first-slice neighboring information stored in the second storage unit, and the second decoding unit may generate the inside second-slice neighboring information by decoding the inside second-slice block, store the generated inside second-slice neighboring information into the third storage unit, and decode the inside second-slice neighboring block by reference to the inside second-slice neighboring information stored in the third storage unit.

According to this configuration, the image decoding device in the present invention can reduce the amount of data to be stored in the storage unit which is accessed by the plurality of decoding units. This can prevent capacity shortage from occurring to the storage unit. Moreover, the access to the storage unit is distributed and, therefore, it is easy to construct the storage unit.

Furthermore, the second decoding unit may decode a block that is the boundary neighboring block and is the inside second-slice neighboring block, by reference to the inter-slice neighboring information stored in the first storage unit and the inside second-slice neighboring information stored in the third storage unit.

According to this configuration, the image decoding device in the present invention can use both the spatial dependence across the boundary between the slices and the spatial dependence within the slice.

Moreover, after making reference to the inter-slice neighboring information stored in the first storage unit, the second decoding unit may release an area storing the inter-slice neighboring information in the first storage unit when the inter-slice neighboring information is not to be referenced again.

According to this configuration, capacity shortage can be more prevented from occurring to the storage unit.

Furthermore, the image decoding device may further include: a first data buffer; and a second data buffer, wherein the first decoding unit may perform a variable-length decoding process on the at least one block included in the first slice, and store first variable-length decoded data obtained as a result of the variable-length decoding process into the first data buffer, the second decoding unit may perform a variable-length decoding process on the at least one block included in the second slice, and store second variable-length decoded data obtained as a result of the variable-length decoding process into the second data buffer, and the image decoding device may further include: a first pixel decoding unit which converts, into a pixel value, the first variable-length decoded data stored in the first data buffer; and a second pixel decoding unit which converts, into a pixel value, the second variable-length decoded data stored in the second data buffer.

According to this configuration, even when the operating frequency is low, the decoding process can be achieved smoothly. Thus, the image decoding device in the present invention can be implemented at a low cost.

Moreover, the first storage unit may store a management table indicating whether or not the inter-slice neighboring information is stored in the first storage unit, the first decoding unit may update the management table to indicate that the inter-slice neighboring information is stored in the first storage unit, when storing the inter-slice neighboring information into the first storage unit, and the second decoding unit may decode the boundary neighboring block by reference to the inter-slice neighboring information stored in the first storage unit, after verifying by reference to the management table that the inter-slice neighboring information is stored in the first storage unit.

According to this configuration, it is notified that the block has been decoded. Thus, the plurality of decoding units can execute the decoding process in synchronization with each other.

Furthermore, the first decoding unit may notify the second decoding unit that the inter-slice neighboring information is stored in the first storage unit, after storing the inter-slice neighboring information into the first storage unit, and the second decoding unit may decode the boundary neighboring block by reference to the inter-slice neighboring information stored in the first storage unit, after being notified by the first decoding unit that the inter-slice neighboring information is stored in the first storage unit.

According to this configuration, the plurality of decoding units can execute the decoding process in synchronization with each other.

Moreover, the second decoding unit may verify whether or not the inter-slice neighboring information is stored in the first storage unit at predetermined intervals and, after verifying that the inter-slice neighboring information is stored in the first storage unit, decode the boundary neighboring block by reference to the inter-slice neighboring information stored in the first storage unit.

According to this configuration, the plurality of decoding units can execute the decoding process in synchronization with each other via a simple process by which whether or not the information has been written into the storage unit is determined.

Furthermore, the first decoding unit may generate, by decoding the boundary block, coefficient information indicating whether or not a non-zero coefficient is present, and store the generated coefficient information as the inter-slice neighboring information into the first storage unit, and the second decoding unit may decode the boundary neighboring block by reference to the coefficient information stored as the inter-slice neighboring information in the first storage unit.

According to this configuration, the variable-length decoding process dependent on the presence or absence of a non-zero coefficient in a neighboring block is implemented across the boundary between the slices. This can increase the image compression rate and the image quality.

The image coding device in another aspect of the present invention is an image coding device that codes an image having a plurality of slices each including at least one block and includes: a first coding unit which codes at least one block included in a first slice among the slices; a second coding unit which codes at least one block included in a second slice different from the first slice among the slices; and a first storage unit which stores inter-slice neighboring information that is (i) generated by coding a boundary block that is one of the at least one block included in the first slice and is adjacent to the second slice and (ii) referenced when a boundary neighboring block that is one of the at least one block included in the second slice and is adjacent to the boundary block is coded, wherein the first coding unit generates the inter-slice neighboring information by coding the boundary block and stores the generated inter-slice neighboring information into the first storage unit, and the second coding unit codes the boundary neighboring block by reference to the inter-slice neighboring information stored in the first storage unit.

According to this configuration, the image coding device in the present invention can use the spatial dependence across the boundary between the slices. Moreover, the storage unit accommodates variations in the time taken for the coding process. This allows the parallel processing to be executed smoothly.

The image decoding method in another aspect of the present invention is an image decoding method of decoding an image having a plurality of slices each including at least one block, the image decoding method including: decoding at least one block included in a first slice among the slices; and decoding at least one block included in a second slice different from the first slice among the slices, wherein, in the decoding of the at least one block included in the first slice, inter-slice neighboring information is generated and stored into a first storage unit, the inter-slice neighboring information being (i) generated by decoding a boundary block that is one of the at least one block included in the first slice and is adjacent to the second slice and (ii) referenced when a boundary neighboring block that is one of the at least one block included in the second slice and is adjacent to the boundary block is decoded, and in the decoding of the at least one block included in the second slice, the boundary neighboring block is decoded by reference to the inter-slice neighboring information stored in the first storage unit.

According to this configuration, the spatial dependence across the boundary between the slices can be used in the decoding process.

The image decoding method in another aspect of the present invention is an image decoding method of coding an image having a plurality of slices each including at least one block, the image coding method including: coding at least one block included in a first slice among the slices; and coding at least one block included in a second slice different from the first slice among the slices, wherein, in the coding of the at least one block included in the first slice, inter-slice neighboring information is generated and stored in a first storage unit, the inter-slice neighboring information being (i) generated by coding a boundary block that is one of the at least one block included in the first slice and is adjacent to the second slice and (ii) referenced when a boundary neighboring block that is one of the at least one block included in the second slice and is adjacent to the boundary block is coded, and in the coding of the at least one block included in the second slice, the boundary neighboring block is coded by reference to the inter-slice neighboring information stored in the first storage unit.

According to this configuration, the spatial dependence across the boundary between the slices can be used in the coding process.

The program in another aspect of the present invention may be a program for causing a computer to execute the steps included in the aforementioned image decoding method.

According to this configuration, the image decoding method can be implemented as a computer program.

The program in another aspect of the present invention may be a program for causing a computer to execute the steps included in the aforementioned image coding method.

According to this configuration, the image coding method can be implemented as a computer program.

The integrated circuit in another aspect of the present invention is an integrated circuit that decodes an image having a plurality of slices each including at least one block and includes: a first decoding unit which decodes at least one block included in a first slice among the slices; a second decoding unit which decodes at least one block included in a second slice different from the first slice among the slices; and a first storage unit which stores inter-slice neighboring information that is (i) generated by decoding a boundary block that is one of the at least one block included in the first slice and is adjacent to the second slice and (ii) referenced when a boundary neighboring block that is one of the at least one block included in the second slice and is adjacent to the boundary block is decoded, wherein the first decoding unit generates the inter-slice neighboring information by decoding the boundary block and stores the generated inter-slice neighboring information into the first storage unit, and the second decoding unit decodes the boundary neighboring block by reference to the inter-slice neighboring information stored in the first storage unit.

According to this configuration, the image decoding device can be implemented as an integrated circuit.

The integrated circuit in another aspect of the present invention is an integrated circuit that codes an image having a plurality of slices each including at least one block and includes: a first coding unit which codes at least one block included in a first slice among the slices; a second coding unit which codes at least one block included in a second slice different from the first slice among the slices; and a first storage unit which stores inter-slice neighboring information that is (i) generated by coding a boundary block that is one of the at least one block included in the first slice and is adjacent to the second slice and (ii) referenced when a boundary neighboring block that is one of the at least one block included in the second slice and is adjacent to the boundary block is coded, wherein the first coding unit generates the inter-slice neighboring information by coding the boundary block and stores the generated inter-slice neighboring information into the first storage unit, and the second coding unit codes the boundary neighboring block by reference to the inter-slice neighboring information stored in the first storage unit.

According to this configuration, the image coding device can be implemented as an integrated circuit.

### Advantageous Effects of Invention

According to the present invention, the spatial dependence across the boundary between the slices is used and therefore the parallel processing is executed smoothly.

### BRIEF DESCRIPTION OF DRAWINGS

FIG. 1 is a block diagram showing a configuration of an image decoding device in Embodiment 1.

FIG. 2 is a block diagram showing configurations of variable-length decoding units included in the image decoding device in Embodiment 1.

FIG. 3 is a block diagram showing configurations of pixel decoding units included in the image decoding device in Embodiment 1.

FIG. 4A is a diagram showing slices in Embodiment 1.

FIG. 4B is a diagram showing a stream in Embodiment 1.

FIG. 4C is a diagram showing an order of processing within a slice.

FIG. 5A is a diagram showing a reference relationship between blocks in Embodiment 1.

FIG. 5B is a diagram showing a reference relationship between slices in Embodiment 1.

FIG. 6 is a flowchart showing an operation performed by the image decoding device in Embodiment 1.

FIG. 7 is a diagram showing a pointer operation in Embodiment 1.

FIG. 8 is a flowchart showing an operation performed by the variable-length decoding unit included in the image decoding device in Embodiment 1.

FIG. 9 is a flowchart showing an operation performed to check for neighboring information in Embodiment 1.

FIG. 10 is a flowchart showing an operation performed to write neighboring information in Embodiment 1.

FIG. 11 is a diagram showing a management table of neighboring information in Embodiment 1.

FIG. 12 is a flowchart showing an operation performed by the pixel decoding unit included in the image decoding device in Embodiment 1.

FIG. 13 is a flowchart showing an operation performed by the pixel decoding unit included in the image decoding device in Embodiment 1.

FIG. 14 is a diagram showing an overview of a motion vector calculation method in Embodiment 1.

FIG. 15 is a diagram showing a reference relationship in the case of intra-picture prediction in Embodiment 1.

FIG. 16 is a diagram showing a state of an inter-slice neighboring information memory in Embodiment 1.

FIG. 17A is a diagram showing parallel processing in Embodiment 1.

FIG. 17B is a diagram showing a modification of the parallel processing of Embodiment 1.

FIG. 18A is a block diagram showing a characteristic configuration of the image decoding device in Embodiment 1.

FIG. 18B is a flowchart showing a characteristic operation performed by the image decoding device in Embodiment 1.

FIG. 19 is a diagram showing an example of a coded table in Embodiment 2.

FIG. 20 is a block diagram showing configurations of variable-length decoding units included in an image decoding device in Embodiment 3.

FIG. 21 is a flowchart showing an operation performed by the variable-length decoding unit included in the image decoding device in Embodiment 3.

FIG. 22 is a flowchart showing an arithmetic decoding process in Embodiment 3.

FIG. 23 is a flowchart showing an arithmetic decoding process in Embodiment 3.

FIG. 24 is a diagram showing de-binarization methods in Embodiment 3.

FIG. 25 is a block diagram showing a configuration of an image decoding device in Embodiment 4.

FIG. 26 is a block diagram showing configurations of variable-length decoding units included in the image decoding device in Embodiment 4.

FIG. 27 is a block diagram showing configurations of pixel decoding units included in the image decoding device in Embodiment 4.

FIG. 28 is a flowchart showing an operation performed to check for neighboring information in Embodiment 4.

FIG. 29 is a flowchart showing an operation performed to write neighboring information in Embodiment 4.

FIG. 30A is a diagram showing a state of an inside-slice neighboring information memory in Embodiment 4.

FIG. 30B is a diagram showing a state of an inter-slice neighboring information memory in Embodiment 4.

FIG. 31A is a diagram showing a pointer operation in Embodiment 4.

FIG. 31B is a diagram showing a state of pointers in Embodiment 4.

FIG. 32 is a block diagram showing a characteristic configuration of the image decoding device in Embodiment 4.

FIG. 33 is a block diagram showing a configuration of an image decoding device in Embodiment 5.

FIG. 34 is a block diagram showing a configuration of an image coding device in Embodiment 6.

FIG. 35 is a block diagram showing configurations of variable-length coding units included in the image coding device in Embodiment 6.

FIG. 36 is a block diagram showing configurations of pixel coding units included in the image coding device in Embodiment 6.

FIG. 37 is a flowchart showing an operation performed by the image coding device in Embodiment 6.

FIG. 38 is a flowchart showing an operation performed by the pixel coding unit included in the image coding device in Embodiment 6.

FIG. 39 is a flowchart showing an operation performed by the variable-length coding unit included in the image coding device in Embodiment 6.

FIG. 40A is a block diagram showing a characteristic configuration of the image coding device in Embodiment 6.

FIG. 40B is a flowchart showing a characteristic operation performed by the image coding device in Embodiment 6.

FIG. 41 is a block diagram showing a configuration of an image decoding device in Embodiment 7.

FIG. 42 is a block diagram showing a characteristic configuration of the image decoding device in Embodiment 7.

FIG. 43 is a block diagram showing a configuration of an image coding device in Embodiment 8.

FIG. 44 is a block diagram showing a configuration of a system large scale integration (LSI) in Embodiment 9.

FIG. 45 is a block diagram showing a configuration of a system LSI in Embodiment 10.

FIG. 46 is a diagram showing an overall configuration of a content providing system implementing content distribution service in Embodiment 11.

FIG. 47 is a diagram showing an overall configuration of a digital broadcast system in Embodiment 11.

FIG. 48 is a block diagram showing an example of a configuration of a TV in Embodiment 11.

FIG. 49 is a block diagram showing an example of a configuration of an information reproducing-recording unit which reads/writes information from/into a recording medium that is an optical disk.

FIG. 50 is a diagram showing an example of a structure of a recording medium that is an optical disk.

FIG. 51 is a block diagram showing a configuration of an integrated circuit implementing the image decoding process.

FIG. 52 is a block diagram showing a configuration of an integrated circuit implementing the image coding process.

FIG. 53 is a block diagram showing an example of a configuration of an integrated circuit implementing the image coding process and the image decoding process.

FIG. 54A is a diagram showing a slice according to a conventional technology.

FIG. 54B is a diagram showing a stream according to the conventional technology.

FIG. 55A is a diagram showing referable slices according to the conventional technology.

FIG. 55B is a diagram showing a processing order within a slice according to the conventional technology.

FIG. 55C is a schematic view showing an operation according to the conventional technology.

### DESCRIPTION OF EMBODIMENTS

The following is a description of image decoding devices according to Embodiments of the present invention, with reference to the drawings.

### Embodiment 1

### [1-1. Overview]

Firstly, an overview of an image decoding device according to Embodiment 1 of the present invention is described.

The image decoding device according to Embodiment 1 of the present invention reads a video stream separated from an AV-multiplexed stream by a system decoder, using a plurality of decoding units. The video stream is previously constructed so as be read by the decoding units. The decoding units execute the decoding process in synchronization with each other, by reference to each other's partial decoding result via a neighboring information memory.

This is the overview of the image decoding device according to Embodiment 1.

### [1-2. Configuration]

Next, a configuration of the image decoding device according to Embodiment 1 is described.

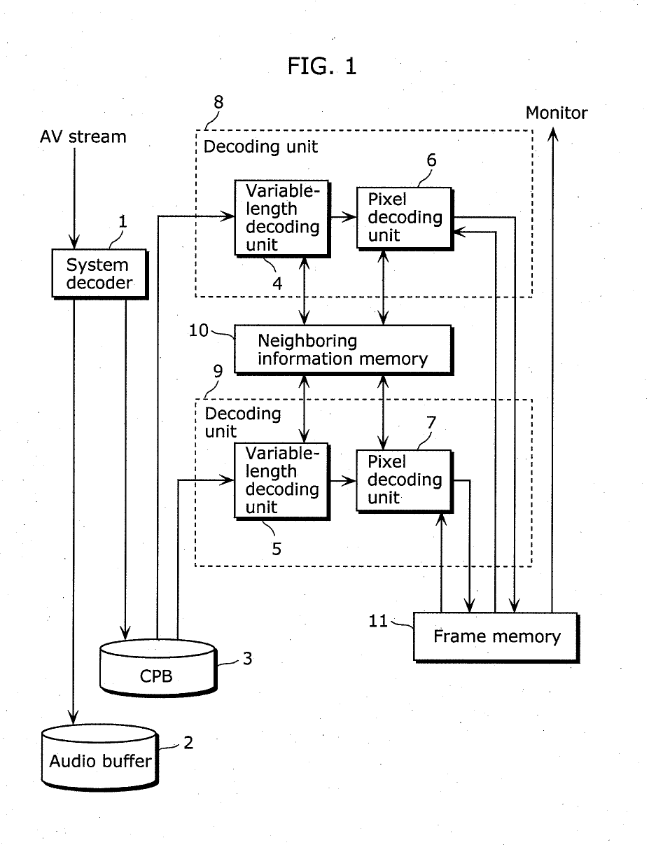

FIG. 1 is a block diagram showing the configuration of the image decoding device according to Embodiment 1. The image decoding device in Embodiment 1 includes a system decoder 1, a coded picture buffer (CPB) 3, an audio buffer 2, two variable-length decoding units 4 and 5, two pixel decoding units 6 and 7, a neighboring information memory 10, and a frame memory 11.

The system decoder 1 separates an AV stream into an audio stream and a video stream. The CPB 3 buffers the video stream. The audio buffer 2 buffers the audio stream. Each of the two variable-length decoding units 4 and 5 decodes variable-length coded data. Each of the two pixel decoding units 6 and 7 performs the decoding process, such as inverse frequency transformation, pixel by pixel. The neighboring information memory 10 stores information to be used for decoding a neighboring macroblock. The frame memory 11 stores decoded image data.

Note that the variable-length decoding unit 4 and the pixel decoding unit 6 are collectively called a decoding unit 8, and that the variable-length decoding unit 5 and the pixel decoding unit 7 are collectively called a decoding unit 9.

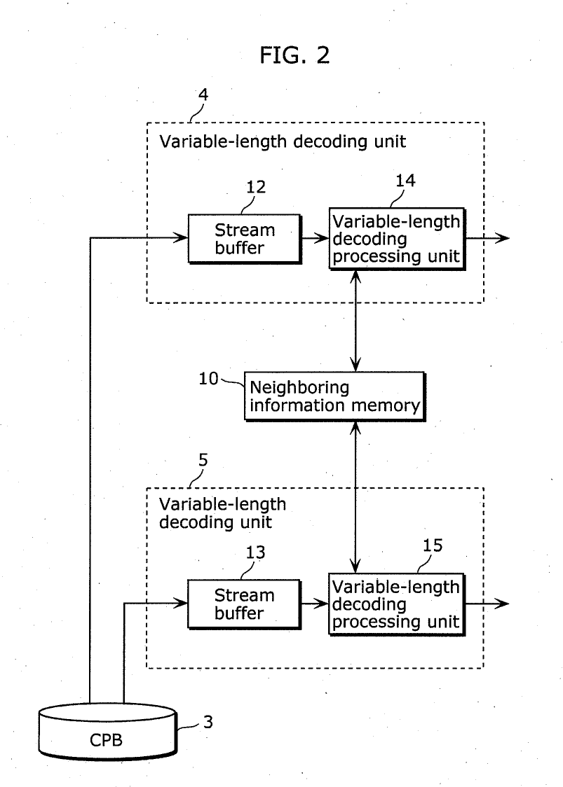

FIG. 2 is a block diagram showing configurations of the two variable-length decoding units 4 and 5 shown in FIG. 1. Components identical to those shown in FIG. 1 are not explained again here. The variable-length decoding unit 4 includes: a stream buffer 12 which stores a stream; and a variable-length decoding processing unit 14 which decodes variable-length coded data. Similarly, the variable-length decoding unit 5 includes a stream buffer 13 and a variable-length decoding processing unit 15.

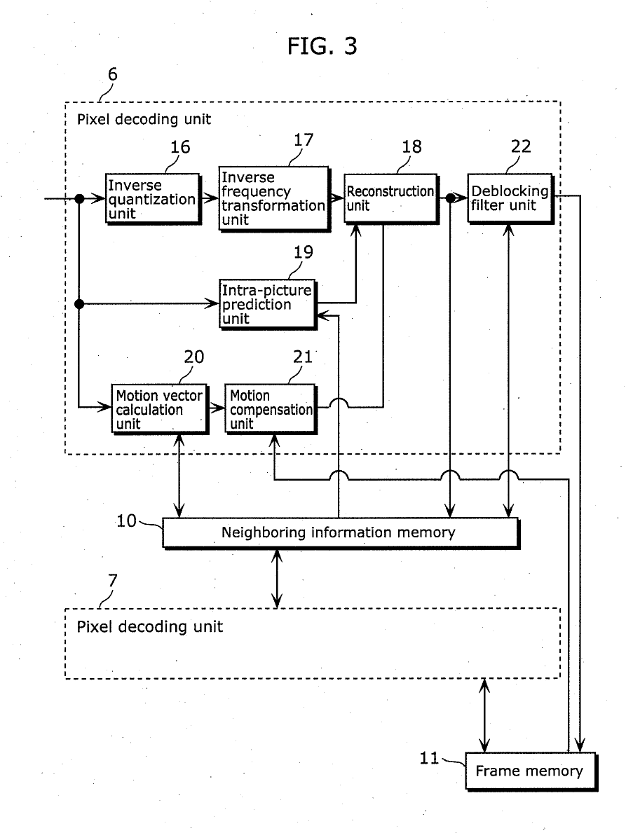

FIG. 3 is a block diagram showing configurations of the pixel decoding units 6 and 7 shown in FIG. 1. Components identical those shown in FIG. 1 or FIG. 2 are not explained again here.

The pixel decoding unit 6 includes an inverse quantization unit 16, an inverse frequency transformation unit 17, a reconstruction unit 18, an intra-picture prediction unit 19, a motion vector calculation unit 20, a motion compensation unit 21, and a deblocking filter unit 22.

The inverse quantization unit 16 performs an inverse quantization process. The inverse frequency transformation unit 17 performs an inverse frequency transformation process.

The reconstruction unit 18 reconstructs an image using the data on which the inverse frequency transformation process has been performed and the predicted data on which either motion compensation or intra-picture prediction has been performed. The intra-picture prediction unit 19 generates the predicted data using images of blocks within the current picture that are located on the above and left of a target block. The motion vector calculation unit 20 calculates a motion vector. The motion compensation unit 21 obtains a reference image located at a position indicated by the motion vector, and then performs a filtering process on the obtained image to generate the predicted data.

The deblocking filter unit 22 performs a filtering process on the reconstructed image data to reduce block noise.

Components included in the pixel decoding unit 7 are identical to those included in the pixel decoding unit 6 and, therefore, illustrations of the components in the pixel decoding unit 7 are omitted in FIG. 3.

This is the description of the configuration of the image decoding device according to Embodiment 1.

### [1-3. Operation]

Next, an operation performed by the image decoding device shown in FIG. 1 to FIG. 3 is described.

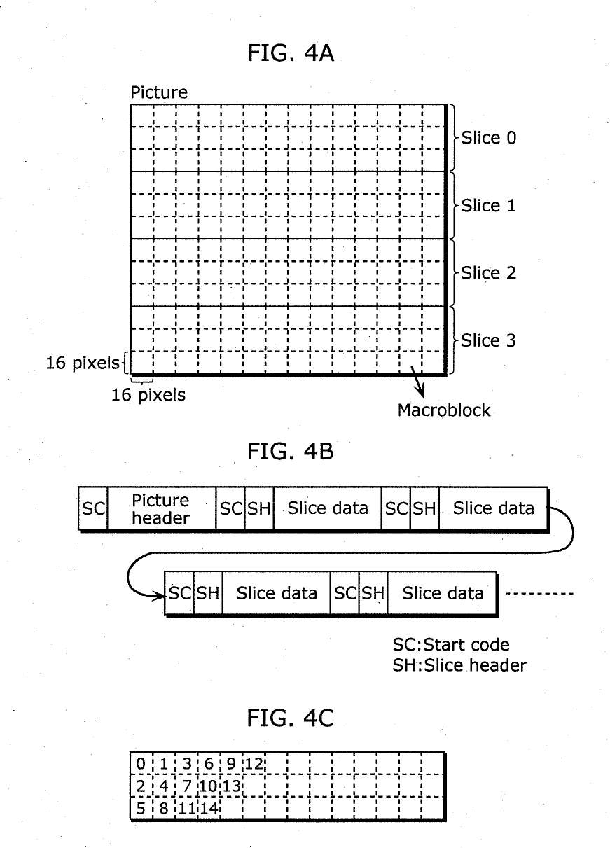

FIG. 4A is a diagram showing a structure of a target picture. One picture is divided into a plurality of slices. Here, reference can be made between the slices. A slice is divided into macroblocks each of which is 16 pixels high and 16 pixels wide. Each of the coding process and the decoding process is performed on a macroblock-by-macroblock basis.

FIG. 4B is a diagram showing a coded picture stream. A start code is firstly placed, and then a picture header follows. After this, the stream includes a start code, a slice header, and slice data. That is, a stream of one picture is structured by such a stream sequence.

The picture header indicates information on various headers attached picture by picture, such as a picture parameter set (PPS) and a sequence parameter set (SPS) according to the H.264 standard. The start code is also called a synchronization word, and is structured by a specific pattern which does not appear in the slice data or the like. The decoding unit detects the start code by searching the stream in order from the beginning. By doing so, the decoding unit can find a start position of the picture header or the slice header.

FIG. 4C is a diagram showing an order of processing the macroblocks in a slice. The processing order in the slice is indicated by numbers assigned to the macroblocks shown in FIG. 4C. When each of the macroblocks is indicated by coordinates, the processing is performed on the macroblocks in a zigzag order as follows: (0, 0), (1, 0), (0, 1), (2, 0), (1, 1), (0, 2), (3, 0), (2, 1), and (1, 2).

The structure of a picture used in Embodiment 1 is identical to the structure defined in the H.264 standard, except that the picture in Embodiment 1 includes slices between which reference is allowed and that the processing order in the slice is different.

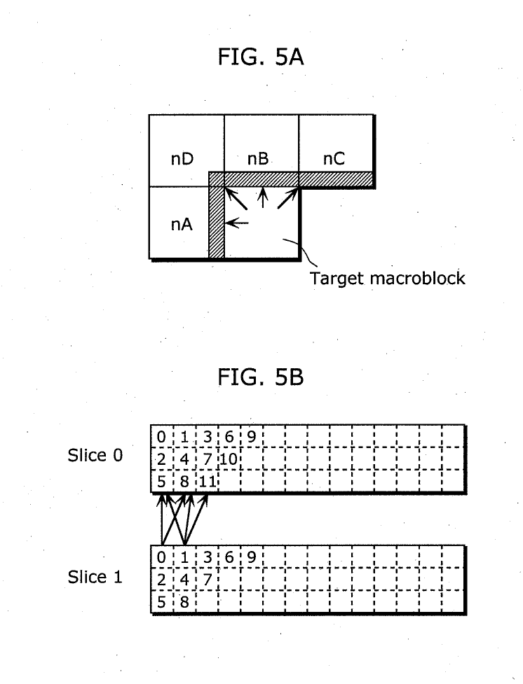

FIG. 5A is a diagram showing a reference relationship between a target macroblock and neighboring macroblocks. Although depending on the processing details, when the target macroblock is decoded, four macroblock located on the left, immediately above, upper right, and upper left of the target macroblock are referenced. The macroblocks to be referenced are referred to as “nA”, “nB”, “nC”, and “nD”. As to the macroblocks located above the target macroblock, data present in the lower part of the corresponding macroblock is referenced. As to the macroblock located on the left of the target macroblock, data present in the right part of this macroblock is referenced.

Such references across the boundary between the slices are allowed in the case of the stream that is to be decoded by the image decoding device in Embodiment 1. As shown in FIG. 5B, an MB 0 in a slice 1 is decoded by reference to an MB 5 and an MB 8 in a slice 0.

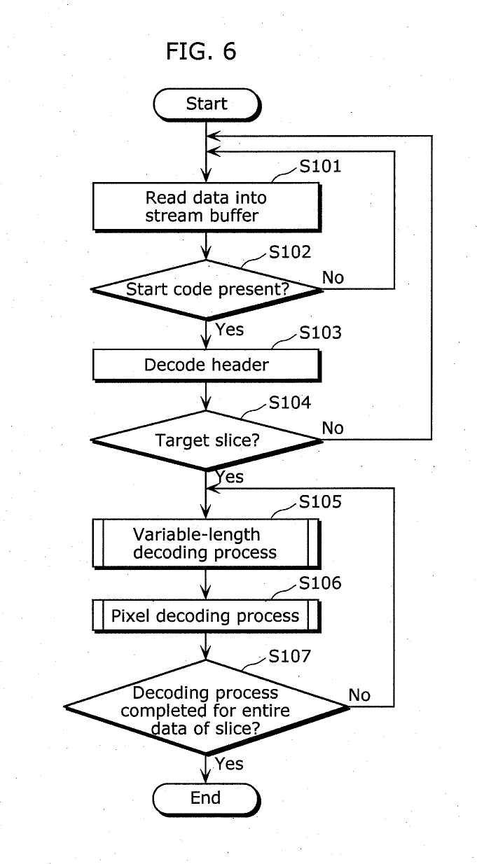

FIG. 6 is a flowchart showing an operation performed by the image decoding device shown in FIG. 1. In Embodiment 1, the decoding unit 8 decodes slices 0 and 2, and the decoding unit 9 decodes slices 1 and 3.

The variable-length decoding unit 4 reads, into the stream buffer 12, the video stream separated by the system decoder 1 via the AV separation process and stored into the CPB 3 (S101).

The variable-length decoding unit 4 for the stream data searches the stream data read into the stream buffer 12 for the start code (S102). When no start code is present (No in S102), the variable-length decoding unit 4 reads out the stream from the stream buffer 12 until the start code is detected. When no stream data is present any more in the stream buffer 12, a stream is transferred from the CPB 3 to the stream buffer 12. This transfer from the CPB 3 to the stream buffer 12 is described in detail later.

When the start code is detected (Yes in S102), the variable-length decoding unit 4 decodes the header (S103). Then, the variable-length decoding unit 4 determines whether or not the stream includes a target header or slice to be processed by the variable-length decoding unit 4 (S104). The target slice to be processed by the variable-length decoding unit 4 is the slice 0 or 2 shown in FIG. 4A.

When the stream includes the target slice to be processed by the variable-length decoding unit 4 (Yes in S104), the variable-length decoding processing unit 14 performs a variable-length decoding process (S105) and a pixel decoding process (S106). When the decoding process is not completed for the entire data of the slice (No in S107), the variable-length decoding unit 4 performs the processing on the data that follows (S105 and S106).

On the other hand, when the stream does not include the target slice (No in S104), the variable-length decoding unit 4 researches for a start code (S101 and S102); and repeats the subsequent processing.

As is the case with the variable-length decoding unit 4, the variable-length decoding unit 5 decodes the slices 1 and 3 shown in FIG. 4A.

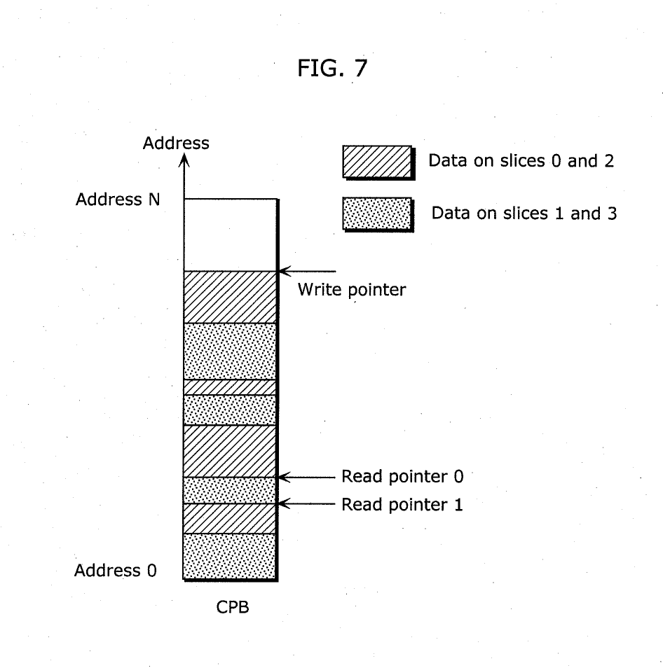

FIG. 7 is a diagram showing an operation performed when a stream is transferred from the CPB 3 to the two stream buffers 12 and 13.

The CPB 3 receives one video stream separated via the AV separation process, sequentially from the system decoder 1. Here, since the two variable-length decoding units perform processing on one video stream, the video stream is controlled as follows.

As shown in FIG. 7, the CPB 3 is configured as a single ring buffer. This ring buffer includes a write pointer for the system decoder 1 to write data and two read pointers for the stream buffers 12 and 13 to transfer data.

The write pointer for the system decoder 1 to write data changes sequentially in a direction from an address 0 to an address N of the ring buffer. That is, the system decoder 1 writes the video stream into the ring buffer sequentially in the direction from the address 0 to the address N. The CPB 3 serves as the ring buffer that returns to the address 0 when the write pointer reaches the address N.

Moreover, the write pointer is controlled so as not to pass either of the two read pointers. For example, when the write pointer is apt to pass the read pointer, the CPB 3 stops the process of writing from the system decoder 1 to the CPB 3, and then performs control so as not to pass the read pointer.

As in the case with the write pointer, the read pointer also changes sequentially in a direction from the address 0 to the address N of the ring buffer. That is, the two stream buffers 12 and 13 read the video stream sequentially in the direction from the address 0 to the address N. The CPB 3 serves as the ring buffer which returns to the address 0 when the read pointer reaches the address N.

Here, when the read pointer indicates an address identical to the address indicated by the write pointer, the CPB 3 determines that no valid data is present and thus stops the pointer. Then, the CPB 3 stops the transfer to the two stream buffers 12 and 13. When the transfer to the two stream buffers 12 and 13 is stopped and no stream data is present any more in the two stream buffers 12 and 13, the two variable-length decoding units 4 and 5 have no data to process. In such a case, the two variable-length decoding units 4 and 5 stops the respective operations and wait for new stream data to come.

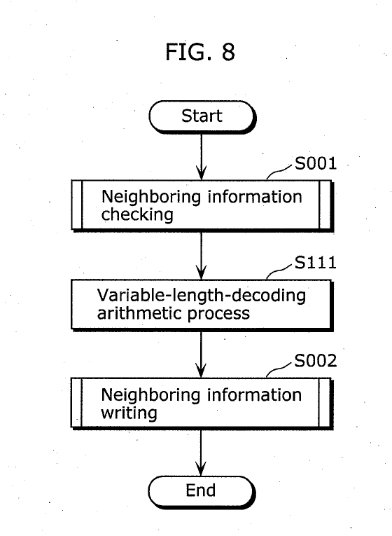

Next, the decoding process performed by the variable-length decoding processing unit 14 on the variable-length coded data (S105) is described, with reference to FIGS. 8, 9, and 10.

Firstly, the variable-length decoding processing unit 14 checks whether or not data necessary for variable-length decoding is present in the neighboring information memory 10 (S001).

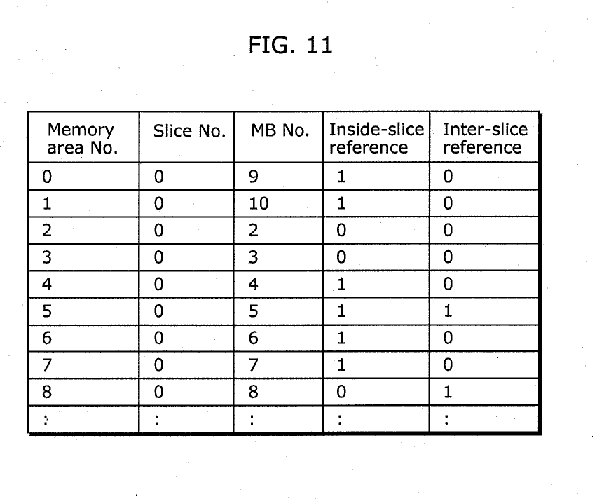

This check is executed by using a management table shown in FIG. 11 that is stored in the neighboring information memory.

For example, when the MB 1 of the slice 0 is processed, data on the MB 0 of the slice 0 is required as the neighboring information. The variable-length decoding processing unit 14 searches slice numbers and macroblock numbers in the management table shown in FIG. 11. When the management table indicates the MB 0 of the slice 0 and also an inside-slice reference flag or an inter-slice reference flag is “1”, the variable-length decoding processing unit 14 obtains a corresponding memory area number. Then, the variable-length decoding processing unit 14 can read the neighboring information from a memory area corresponding to the obtained memory area number.

At this time, when the neighboring information is not to be referenced again within the slice, the variable-length decoding processing unit 14 changes the inside-slice reference flag to “0”. When the neighboring information is not to be referenced again by another slice, the variable-length decoding processing unit 14 changes the inter-slice reference flag to “0”. For example, after processing the MB 1 of the slice 2 by reference to the MB 5 of the slice 1, the variable-length decoding processing unit 14 does not reference to the MB 5 of the slice 1 again. In this case, the variable-length decoding processing unit 14 changes the inter-slice reference flag to “0”.

Whether or not the neighboring information is to be referenced again can be determined from the reference relationship between the macroblocks shown in FIGS. 5A and 5B.

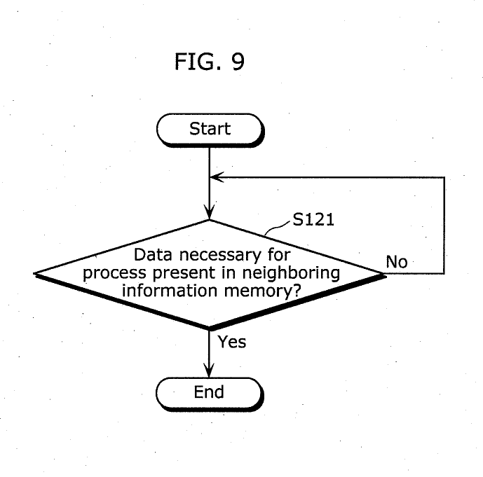

Since the macroblocks included in the slice are sequentially processed, inside-slice neighboring information definitely exists. However, inter-slice neighboring information may not be generated depending on an operating status of the variable-length decoding processing unit 15 that operates in parallel with the variable-length decoding processing unit 14. As shown in FIG. 9, when no neighboring information exists, the variable-length decoding processing unit 14 keeps searching the management table all the time or at predetermined intervals until the neighboring information necessary for variable-length decoding is written into the neighboring information memory 10 (S121).

When the necessary neighboring information is stored in the neighboring information memory 10, the variable-length decoding processing unit 14 performs a variable-length-decoding arithmetic process (S111).

Following this, the variable-length decoding processing unit 14 performs a process of writing the neighboring information into the neighboring information memory 10 (S002).

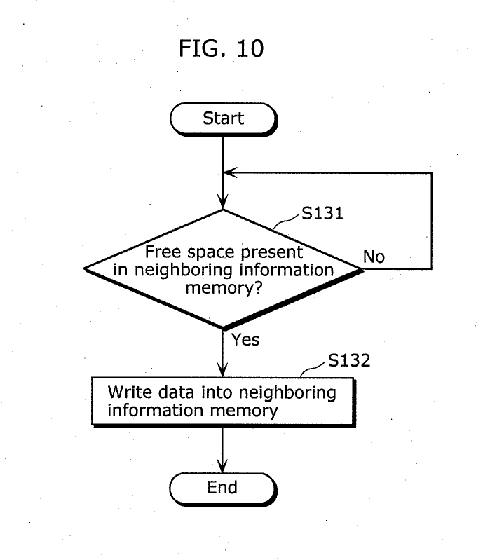

In the process of writing the neighboring information, the variable-length decoding processing unit 14 firstly checks whether or not the neighboring information memory has free space, as shown in FIG. 10 (S131). In the management table shown in FIG. 11, when both the inside-slice reference flag and, the inter-slice reference flag are “0”, the current area is determined to be free space.

As shown in FIG. 10, when the neighboring information memory 10 has free space (Yes in S131), the variable-length decoding processing unit 14 writes, into the neighboring information memory 10, the neighboring information which is a partial result of the variable-length decoding process (S132). Moreover, the variable-length decoding processing unit 14 writes the slice number and the macroblock number into the management table.

When the neighboring information is to be referenced within the slice, the variable-length decoding processing unit 14 writes “1” as the inter-slice reference flag. When the neighboring information is to be referenced by another slice, the variable-length decoding processing unit 14 writes “1” as the inter-slice reference flag. When the neighboring information memory 10 has no free space (No in S131), the variable-length decoding processing unit 14 keeps searching the management table all the time or at predetermined intervals, and then performs the writing process as soon as free space becomes available.

Whether or not the neighboring information is to be referenced within the slice or by another slice can be determined from the reference relationship between the macroblocks shown in FIGS. 5A and 5B.

In this way, the variable-length decoding processing unit 14 and the variable-length decoding processing unit 15 notify each other, via the management table, that the neighboring information has been written.

Here, the variable-length decoding processing unit 14 and the variable-length decoding processing unit 15 notify each other, via the management table, that the neighboring information has been written. However, the variable-length decoding processing unit 14 and the variable-length decoding processing unit 15 may notify each other that the neighboring information has been written, by sending signals directly to each other. Alternatively, instead of using the management table as described, the variable-length decoding processing unit 14 and the variable-length decoding processing unit 15 may verify, all the time or at predetermined intervals, whether or not the neighboring information has been written.

Accordingly, the variable-length decoding processing unit 14 and the variable-length decoding processing unit 15 can exchange the neighboring information with each other.

The neighboring information memory 10 may store a management table which has the same structure as the management table shown in FIG. 11, corresponding to each of the components such as the motion vector calculation unit, the intra-picture prediction unit, and the deblocking filter unit described later.

It should be noted that the operation performed by the variable-length decoding processing unit 14 described above may be replaced by an operation performed by the variable-length decoding unit 4. Note also that the operation performed by the variable-length decoding processing unit 15 is identical to that performed by the variable-length decoding processing unit 14. Moreover the operation performed by the variable-length decoding unit 5 is identical to that performed by the variable-length decoding unit 4.

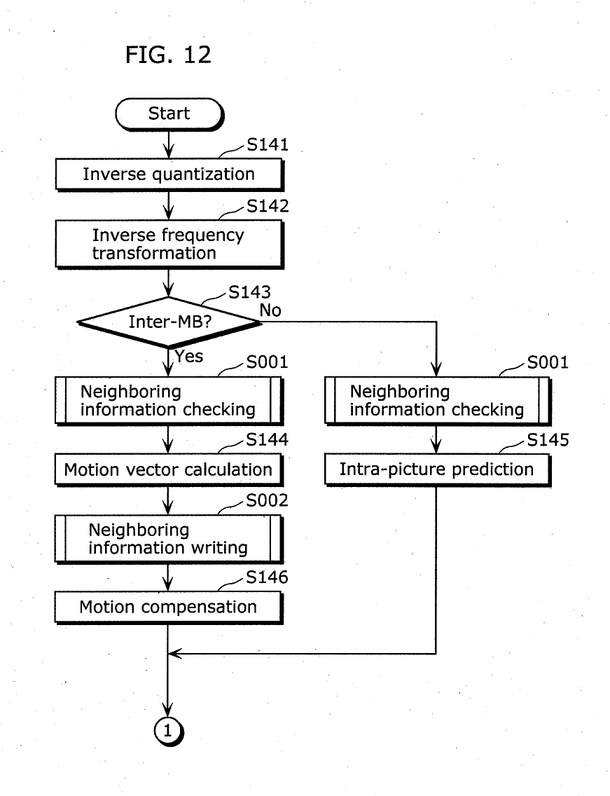

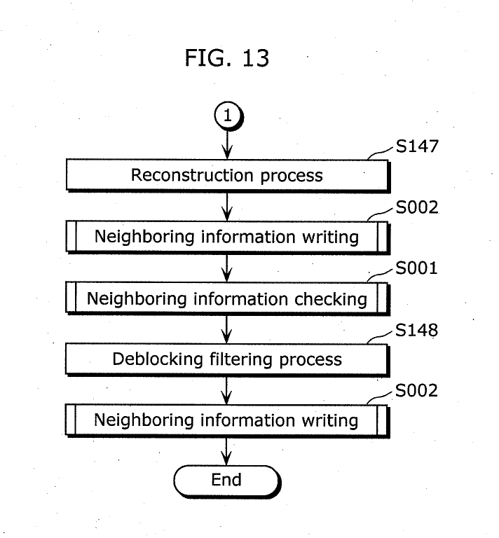

Next, an operation performed by the pixel decoding unit 6 is described, with reference to the flowcharts shown in FIGS. 12 and 13.

The inverse quantization unit 16 performs inverse quantization on the data received from the variable-length decoding unit 4 (S141). Then, the inverse frequency transformation unit 17 performs inverse frequency transformation on the inversely-quantized data (S142).

When the target macroblock to be decoded is an inter-macroblock (Yes in S143), the motion vector calculation unit 20 checks whether or not information necessary for motion vector calculation is present in the neighboring information memory 10 (S001). When the necessary information is not present, the motion vector calculation unit 20 waits until the necessary information is written into the neighboring information memory 10. This operation is identical to the operation performed by the variable-length decoding processing unit 14 to check for the neighboring information (S001).

When the necessary information is present, the motion vector calculation unit 20 calculates a motion vector using this information (S144).

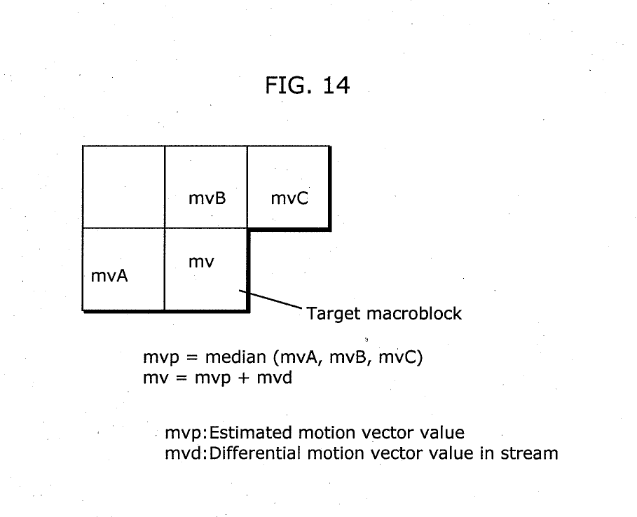

FIG. 14 is a diagram showing an overview of a motion vector calculation method. The motion vector calculation unit 20 calculates an estimated motion vector value mvp from a median value of motion vector values mvA, mvB, and mvC of neighboring macroblocks. Then, the motion vector calculation unit 20 adds a differential motion vector value mvd in the current stream to the estimated motion vector value mvp. As a result, a motion vector value my is obtained.

When the motion vector calculation is finished, the motion vector calculation unit 20 checks whether or not the neighboring information memory 10 has free space (S002). This operation is identical to the operation performed by the variable-length decoding processing unit 14 to write the neighboring information (S002). When the neighboring information memory 10 has free space, the motion vector calculation unit 20 writes the calculated motion vector into the neighboring information memory 10. Otherwise, the motion vector calculation unit 20 waits until the neighboring information memory 10 has free space.

For the sake of simplicity, FIG. 14 shows the case where each of the macroblocks has only one motion vector. In reality, however, a plurality of motion vectors may exist. The motion vectors to be referenced out of the plurality of motion vectors are: motion vectors in each lower part of the above macroblocks; and a motion vector in the right part of the left macroblock. On account of this, the information to be written into the neighboring information memory 10 may be only the motion vectors to be referenced later out of the plurality of motion vectors. By storing only the motion vectors to be referenced later, the capacity of the neighboring information memory 10 can be reduced.

The motion compensation unit 21 obtains a reference image from the frame memory 11 on the basis of the calculated motion vector, and performs motion compensation such as a filtering process (S146).

When the target macroblock to be decoded is an intra-MB (i.e., an MB for intra-picture prediction) (No in S143), the intra-picture prediction unit 19 checks whether or not information necessary for intra-picture prediction calculation is present in the neighboring information memory 10 (S001). When the necessary information is not present, the intra-picture prediction unit 19 waits until the necessary information is written into the neighboring information memory 10. This operation is identical to the operation performed by the variable-length decoding processing unit 14 to check for the neighboring information (S001).

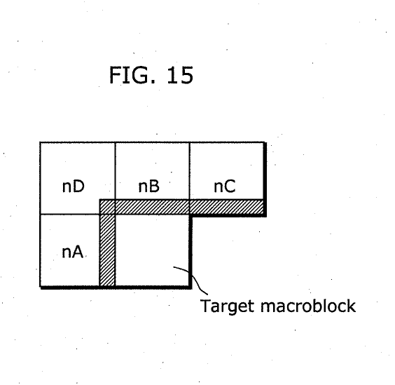

When the necessary information is present, the intra-picture prediction unit 19 performs intra-picture prediction using this information (S145). Although depending on an intra-picture prediction mode, the intra-picture prediction requires, as the neighboring information, reconstructed pixel data of nA, nB, nC, and nD as shown in FIG. 15.

After the motion compensation (S146) or the intra-picture prediction (S145) is finished, the reconstruction unit 18 adds the generated predicted image data to the differential data obtained by the inverse frequency transformation (S147). As a result, a reconstructed image is obtained.

Next, the reconstruction unit 18 checks whether or not the neighboring information memory 10 has free space (S002). This operation is identical to the operation performed by the variable-length decoding processing unit 14 to write the neighboring information (S002). When the neighboring information memory 10 has free space, the reconstruction unit 18 writes, into the neighboring information memory 10, the reconstructed image generated in the reconstruction process (S147). Otherwise, the reconstruction unit 18 waits until the neighboring information memory 10 has free space.

Here, the reconstructed image to be written into the neighboring information memory 10 may be an image of only one row at the lower part or only one column at the right part of the macroblock to be referenced later, instead of the reconstructed image of the entire macroblock. By storing only the reconstructed image to be referenced later, the capacity of the neighboring information memory 10 can be reduced.

Next, the deblocking filter unit 22 checks whether or not data necessary for a deblocking filtering process is present in the neighboring information memory 10 (S001). When the necessary data is not present in the neighboring information memory 10, the deblocking filter unit 22 waits until the necessary data is written into the neighboring information memory 10. This operation is identical to the operation performed by the variable-length decoding processing unit 14 to check for the neighboring information (S001).

When the necessary data is present in the neighboring information memory 10, the deblocking filter unit 22 performs the deblocking filtering process using this data (S148) and writes the decoded image into the frame memory 11.

When the deblocking filtering process is finished, the deblocking filter unit 22 checks whether or not the neighboring information memory 10 has free space (S002). This operation is identical to the operation performed by the variable-length decoding processing unit 14 to write the neighboring information (S002). When the neighboring information memory 10 has free space, the deblocking filter unit 22 writes the result of the deblocking filtering process into the neighboring information memory 10. Then, the pixel decoding unit 6 terminates the processing.

Here, the result of the deblocking filtering process to be written into the neighboring information memory 10 may be a partial result to be referenced later corresponding to the lower or right part of the macroblock, instead of the entire result of the deblocking filtering process performed on this macroblock. By storing only the partial result of the deblocking filtering process to be referenced later, the capacity of the neighboring information memory 10 can be reduced.

An operation performed by the pixel decoding unit 7 is identical to the operation performed by the pixel decoding unit 6.

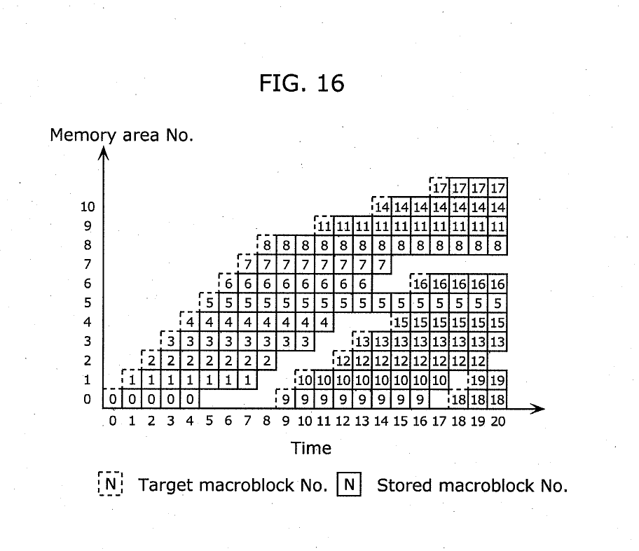

Next, the following describes an operation performed by the decoding unit 8 and a state of data stored in the neighboring information memory 10, with reference to FIG. 16. FIG. 16 shows the case where the operation of the decoding unit 9 is currently suspended. The horizontal axis represents time, and the vertical axis represents numbers assigned to memory areas in the neighboring information memory. A dashed-line rectangle indicates a number assigned to a target macroblock currently being decoded, and a solid-line rectangle indicates a number assigned to a macroblock held for reference.

When decoding the MB 0, the decoding unit 8 writes data on the MB 0 into the neighboring information memory. Then, the decoding unit 8 decodes the MB 1 by reference to the data on the MB 0 stored in the neighboring information memory.

Since the data on the MB 0 is not referenced again later, the area storing the data on the MB 0 becomes free space when the MB 5 is decoded. Then, data on the MB 2 and the MB 4 referenced by the MB 5 is stored in the neighboring information memory 10. Moreover, data on the MB 1 and the MB 3 referenced by a subsequent macroblock is stored in the neighboring information memory 10.

Respective pieces of data on the MB 5, the MB 8, the MB 11, the MB 14, and the MB 17 referenced by another slice vary in timing from which the data is not referenced again, depending on the operation of the decoding unit 9. In the example shown in FIG. 16, since the decoding unit 9 is at rest, the data on the MB 5, the MB 8, the MB 11, the MB 14, and the MB 17 remains in the neighboring information memory.

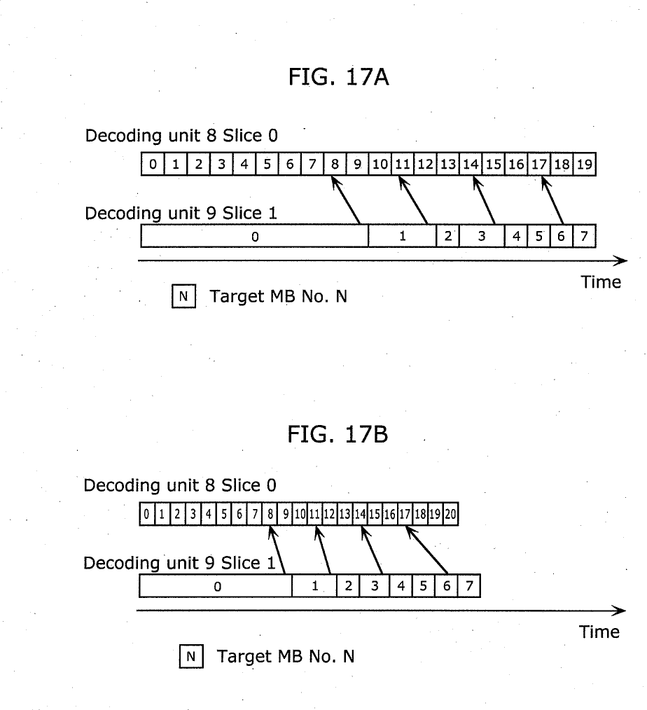

Next, the operations of the decoding unit 8 and the decoding unit 9 are explained with reference to FIG. 17A.

In the example shown in FIG. 17A, the decoding unit 8 and the decoding unit 9 start the respective decoding processes at the same time, and the respective times taken to perform the decoding processes on the target macroblocks are the same. The slice 0 decoded by the decoding unit 8 is the uppermost slice in the picture, meaning that the slice 0 does not need to reference to another slice. Therefore, when the data can be written into the neighboring information memory 10, the decoding unit 8 can decode the slice 0 without a waiting time for reading out the data.

In order to decode the MB 0 of the slice 1, the decoding unit 9 needs the data on the MB 5 and the MB 8 of the slice 0 decoded by the decoding unit 8. On this account, even when the decoding unit 8 and the decoding unit 9 start decoding at the same time, the decoding unit 9 puts the processing on standby until the decoding unit 8 finishes decoding the MB 8. Moreover, in order to decode the MB 1 of the slice 1, the decoding unit 9 needs the data on the MB 11 of the slice 0. Thus, the decoding unit 9 puts the processing on standby until the decoding unit 8 finishes decoding the MB 11 of the slice 0. As a consequence, when decoding the MB 4 and from then on, the decoding unit 9 does not need to wait. However, the decoding unit 9 decodes the slice 1, lagging 12 macroblocks behind the decoding unit 8.

FIG. 17B is a diagram showing an operation of when the decoding unit 8 can always perform the decoding process at twice the speed of the decoding unit 9. As in the case shown in FIG. 17A, since the decoding unit 8 does not need to reference to another slice, the decoding unit 8 decodes the slice 0 at high speed. The decoding unit 9 waits for the result given by the decoding unit 8. However, the waiting time is reduced as compared to the case shown in FIG. 17A.

In reality, each of the decoding unit 8 and the decoding unit 9 has variations in the time taken to decode a macroblock. However, by using the neighboring information memory 10, each of the decoding unit 8 and the decoding unit 9 executes the decoding process when possible. Accordingly, the waiting time is reduced, so that the decoding unit 8 and the decoding unit 9 can efficiently perform the respective decoding processes.

This is the description of the operation performed by the image decoding device.

### [1-4. Characteristic Components]

The following describes the characteristic components in Embodiment 1.

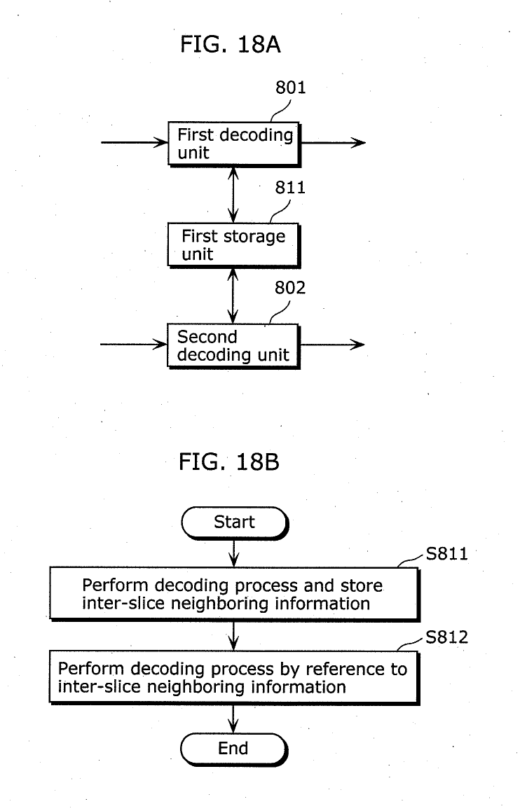

FIG. 18A is a block diagram showing a characteristic configuration of the image decoding device shown in FIG. 1.

The image decoding device shown in FIG. 18A includes a first decoding unit 801, a second decoding unit 802, and a first storage unit 811. The first decoding unit 801, the second decoding unit 802, and the first storage unit 811 are implemented by the decoding unit 8, the decoding unit 9, and the neighboring information memory 10 shown in FIG. 1, respectively. The image decoding device shown in FIG. 18A decodes an image having a plurality of slices.

The first decoding unit 801 is a processing unit which decodes a block included in a first slice among the slices.

The second decoding unit 802 is a processing unit which decodes a block included in a second slice different from the first slice among the slices.

The first storage unit 811 is a storage unit which stores inter-slice neighboring information used in the decoding process. The inter-slice neighboring information is generated by decoding a boundary block that is included in the first slice and is adjacent to the second slice. Moreover, the inter-slice neighboring information is referenced when a boundary neighboring block that is included in the second slice and is adjacent to the boundary block is decoded.

It should be noted that the adjacent blocks of the target block include not only the immediately above, below, left, and right blocks, but also the upper-left, upper-right, lower-left, and lower-right blocks.

The first decoding unit 801 stores, into the first storage unit 811, the inter-slice neighboring information generated by decoding the boundary block.

The second decoding unit 802 decodes the boundary neighboring block by reference to the inter-slice neighboring information stored in the first storage unit 811.

FIG. 18B is a flowchart showing a characteristic operation performed by the image decoding device shown in FIG. 18A.

Firstly, the first decoding unit 801 decodes a block included in the first slice among the slices. Here, the first decoding unit 801 stores, into the first storage unit 811, the inter-slice neighboring information generated by decoding the boundary block (S811).

Following this, the second decoding unit 802 decodes a block included in the second slice different from the first slice, among the slices. Here, the second decoding unit 802 decodes the boundary neighboring block by reference to the inter-slice neighboring information stored in the first storage unit 811 (S812).

It should be noted that the information referenced only within the slice may be stored in the first storage unit 811 or a separate storage unit.

This is the description of the characteristic components in Embodiment 1.

### [1-5. Advantageous Effect]

As described thus far, the two decoding units 8 and 9 and the neighboring information memory 10 are provided in Embodiment 1. The neighboring information memory 10 stores only the data necessary for reference. The data which is not to be referenced again is discarded, so that new data necessary for reference can be written. This can reduce the capacity of the neighboring information memory 10.

Moreover, since the necessary information is stored in the neighboring information memory 10, each of the two decoding units 8 and 9 can independently operate while sharing the necessary information with each other. Furthermore, sufficient space can be ensured in the neighboring information memory 10. This can further reduce the waiting times of the two decoding units 8 and 9 and thus increase the operational efficiency of the parallel processing. Accordingly, even when an operating frequency of the image decoding device is low, high-speed image decoding can be achieved.

### [1-6. Supplemental Remarks]

Embodiment 1 has described an example of the application to the variable-length coding method. However, the coding method may be any other coding method, such as arithmetic coding, Huffman coding, or run-length coding, as long as the method references to data on a neighboring macroblock.

Moreover, the number of decoding units is two in Embodiment 1. However, the number of decoding units is not limited two, and may be three, four, or more.

Furthermore, the number of macroblocks in a slice in a vertical direction is three in Embodiment 1. However, the number of macroblocks in a slice in the vertical direction is not limited to three, and may be less or more than three. Moreover, although the number of slices in a picture is four in Embodiment 1, a picture may include any number of slices.

Furthermore, the management table stored in the neighboring information memory is described as an example to show a management structure in Embodiment 1. However, the data may be managed according to any other structure as long as an area storing data that is not referenced again is released so that new reference data can be written into this area.

Moreover, in Embodiment 1, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 1 describes each process based on an example compliant with the H.264 standard, except for the process of making reference between the slices. However, the coding method may be any other method, such as Moving Picture Experts Group (MPEG)-2, MPEG-4, or VC-1, as long as the method performs coding by reference to information on a neighboring macroblock.

Moreover, in Embodiment 1, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 1. However, the component which stores information may be any other memory element, such as a flip-flop.

Moreover, in Embodiment 1, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Furthermore, in Embodiment 1, the two decoding units start the processing at the same time. However, the two decoding unit do not need to start the processing at the same time, and one of the two may start the processing after the other.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 2

### [2-1. Overview]

Next, an overview of an image decoding device according to Embodiment 2 of the present invention is described.

Embodiment 2 employs context adaptive variable length coding (CAVLC) adopted by the H.264 standard as one of the variable-length coding methods.

This is the overview of the image decoding device according to Embodiment 2.

### [2-2. Configuration]

A configuration of the image decoding device according to Embodiment 2 is identical to the configuration according to Embodiment 1.

### [2-3. Operation]

Next, an operation performed in Embodiment 2 is described with reference to FIG. 8 which is used for describing the operation in Embodiment 1. The operation of Embodiment 2 is different from that of Embodiment 1 in a variable-length-decoding arithmetic process (S111).

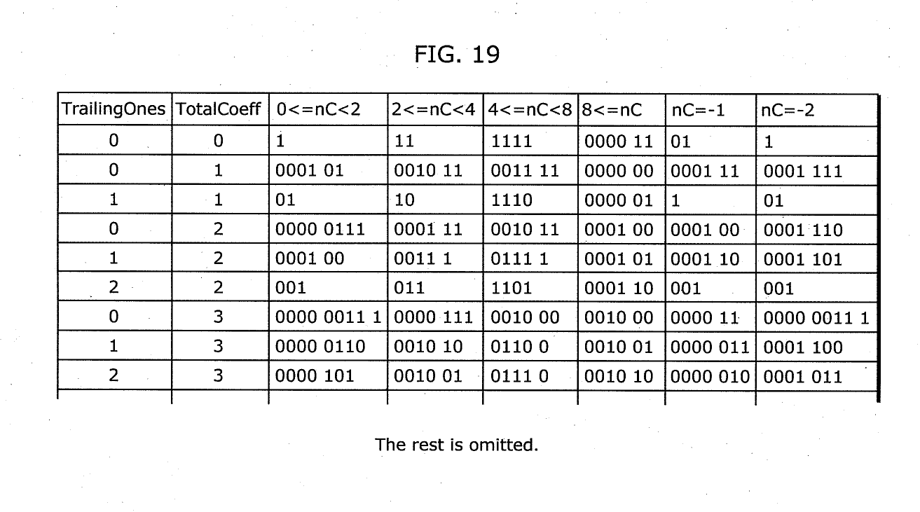

FIG. 19 is a diagram showing an example of a coded table in Embodiment 2. In FIG. 19, nC represents the number of non-zero coefficients in a neighboring macroblock.

As shown by the example shown in FIG. 19, in the variable-length-decoding arithmetic process (S111), a table column is changed depending on the number nC of non-zero coefficients in the neighboring macroblock. Although every case is different, it is typical for nC to be calculated from an average value between the number nA of non-zero coefficients in the left block and the number nB of non-zero coefficients in the immediately-above block.

Each of the two variable-length decoding processing units 14 and 15 reads nA and nB from the neighboring information memory 10. Then, by calculating nC, each of the two variable-length decoding 20, processing units 14 and 15 accordingly changes the table column to perform the variable-length decoding process on the target macroblock. To be more specific, in the example shown in FIG. 19, “TrailingOnes” and “TotalCoeff” are decoded.

This method is described in detail in Non Patent Literature 1 and, therefore, the explanation is omitted here.

### [2-4. Advantageous Effect]

In this way, the image decoding device in Embodiment 2 is capable of the CAVLC method defined in the H.264 standard, using the configuration in Embodiment 1.

### [2-5. Supplemental Remarks]

Embodiment 2 has described an example of the process for decoding data coded according to the CAVLC method defined in the H.264 standard. However, the coding method may be any other coding method as long as the method references to data on a neighboring macroblock.

Moreover, the number of decoding units is two in Embodiment 2. However, the number of decoding units is not limited two, and may be three, four, or more.

Furthermore, the number of macroblocks in a slice in a vertical direction is three in Embodiment 2. However, the number of macroblocks in a slice in the vertical direction is not limited to three, and may be less or more than three. Moreover, although the number of slices in a picture is four in Embodiment 2, a picture may include any number of slices.

Moreover, in Embodiment 2, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 2 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 2, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 2. However, the component which stores information may be any other memory element, such as a flip-flop.

Moreover, in Embodiment 2, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 3

### [3-1. Overview]

Next, an overview of an image decoding device according to Embodiment 3 of the present invention is described.

In Embodiment 3, a variable-length coding method is used for arithmetic coding. A variable-length decoding unit includes an arithmetic decoding unit, which allows the image decoding device in Embodiment 3 to be capable of arithmetic decoding.

This is the overview of the image decoding device according to Embodiment 3.

### [3-2. Configuration]

Next, a configuration of the image decoding device according to Embodiment 3 is described.

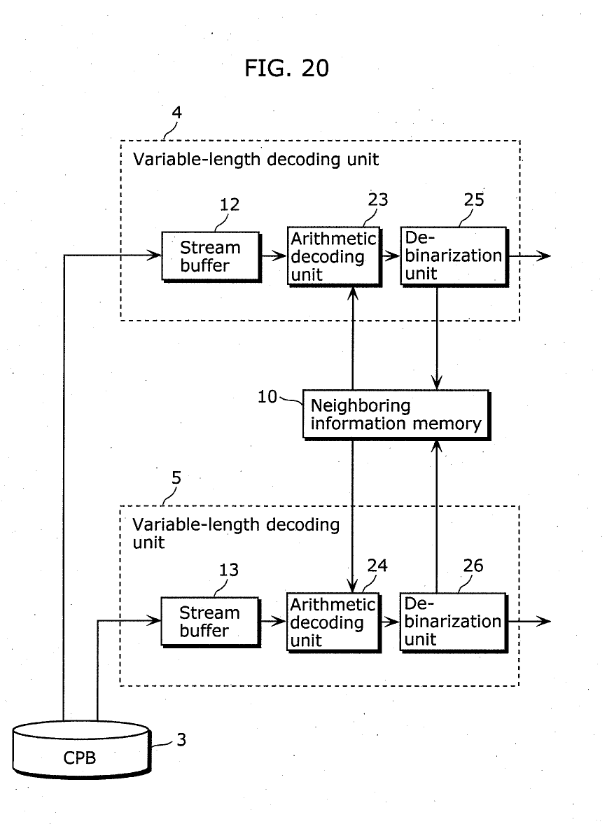

FIG. 20 is a block diagram showing configurations of the variable-length decoding units included in the image decoding device in Embodiment 3. Components in FIG. 20 which are identical to those in FIG. 2 are not explained again here. The variable-length decoding unit 4 in Embodiment 3 supports arithmetic coding, and includes an arithmetic decoding unit 23 which performs arithmetic decoding and a de-binarization unit 25 which performs a de-binarization process. Similarly, the variable-length decoding unit 5 includes an arithmetic decoding unit 24 and a de-binarization unit 26.

### [3-3. Operation]

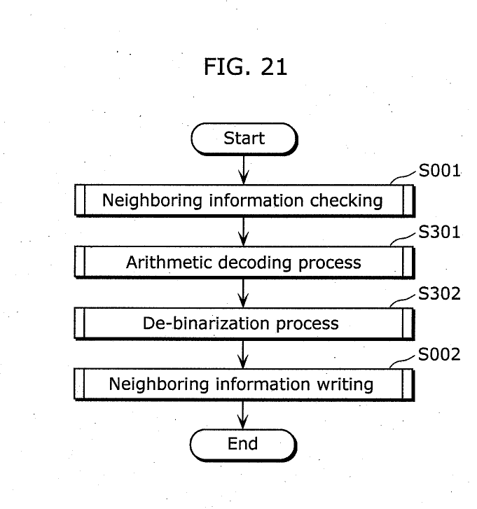

FIG. 21 is a flowchart showing an operation performed by the variable-length decoding unit shown in FIG. 20.

Firstly, each of the arithmetic decoding units 23 and 24 checks whether or not data necessary to decode arithmetic coded data is present in the neighboring information memory 10 (S001). This process is the same as in Embodiment 1.

After this, each of the two arithmetic decoding units 23 and 24 performs an arithmetic decoding process (S301).

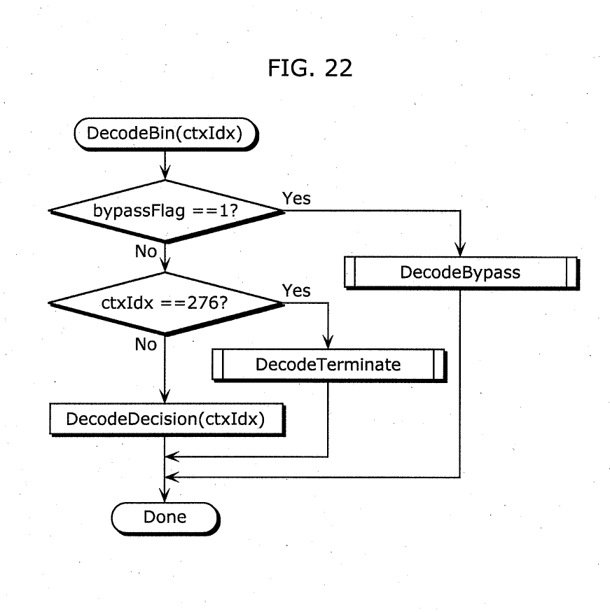

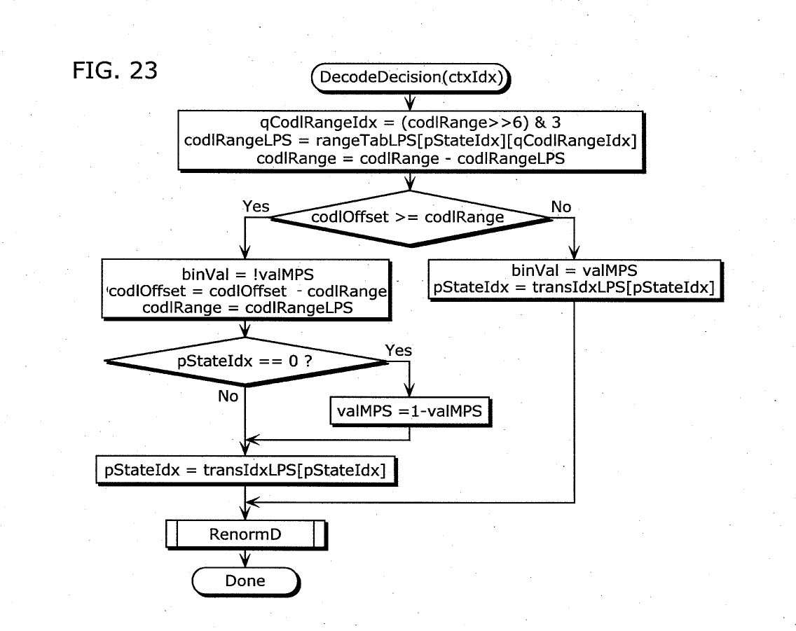

In the arithmetic decoding process, each of the two arithmetic decoding units 23 and 24 calculates each binarized syntax value from an input bit, using a binary-signal occurrence probability generated based on a neighboring macroblock, as shown in FIG. 22 and FIG. 23. This process is identical to the arithmetic decoding process described in Non Patent Literature 1 and, therefore, the explanation is omitted here.

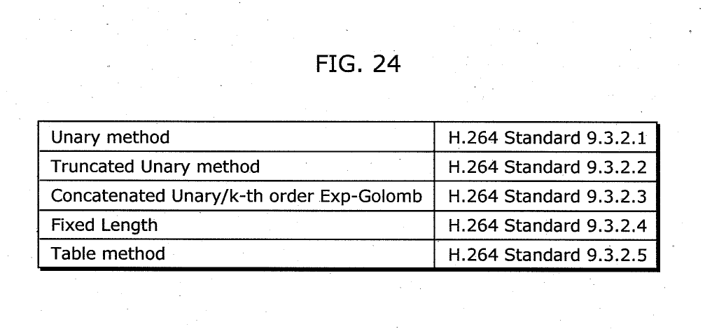

Next, each of the de-binarization units 25 and 26 de-binarizes the binarized data received from the arithmetic decoding processing unit (S302). Examples of the de-binarization method are shown in FIG. 24. These methods are the same as those described in Non Patent Literature 1 and, therefore, the explanation is omitted here.

Lastly, each of the de-binarization units 25 and 26 writes the data, out of the de-binarized data, that is to be referenced when decoding another macroblock, into the neighboring information memory 10 (S002). This process is the same as in Embodiment 1.

As described in Non Patent Literature 1, the values which are to be used in the arithmetic decoding process and are stored into the neighboring information memory 10 include: mb_skip_flag, mb_type, coded_block_pattern, ref_idx_I0, ref_idx_I1, mvd_I0, and mvd_I1. Note that “coded_block_pattern” is coefficient information indicating the presence or absence of a non-zero coefficient.

### [3-4. Advantageous Effect]

In this way, the image decoding device in Embodiment 3 is capable of arithmetic coding, using the same configuration as in Embodiment 1. In the case of arithmetic coding, variations in the processing time from macroblock to macroblock are larger as compared to the cases of other variable-length decoding methods. That is to say, an increase in the processing efficiency via a reduction in waiting time and a reduction in the operating frequency are noticeable.

### [3-5. Supplemental Remarks]

Embodiment 3 has described an example of the application to the arithmetic coding defined in the H.264 standard. However, the coding method may be any coding method other than the arithmetic coding defined in the H.264 standard as long as the method references to data on a neighboring macroblock.

Moreover, the number of decoding units is two in Embodiment 3. However, the number of decoding units is not limited two, and may be three, four, or more.

Furthermore, the number of macroblocks in a slice in a vertical direction is three in Embodiment 3. However, the number of macroblocks in a slice in the vertical direction is not limited to three, and may be less or more than three. Moreover, although the number of slices in a picture is four in Embodiment 3, a picture may include any number of slices.

Moreover, in Embodiment 3, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 3 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 3, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 3. However, the component which stores information may be any other memory element, such as a flip-flop.

Moreover, in Embodiment 3, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 4

### [4-1. Overview]

Next, an overview of an image decoding device according to Embodiment 4 of the present invention is described.

In Embodiment 4, the neighboring information memory described in Embodiment 1 is divided into an inside-slice neighboring information memory and an inter-slice neighboring information memory. That is, the neighboring information memory is divided into the inside-slice neighboring information memory that is accessed by only one decoding unit and the inter-slice neighboring information memory that is accessed by a plurality of decoding units. This division facilitates memory management. Moreover, since the memory accessed asynchronously by the two decoding units is divided, it becomes easy to make compensation for performance.

This is the overview of the image decoding device according to Embodiment 4.

### [4-2. Configuration]

Next, a configuration of the image decoding device according to Embodiment 4 is described.

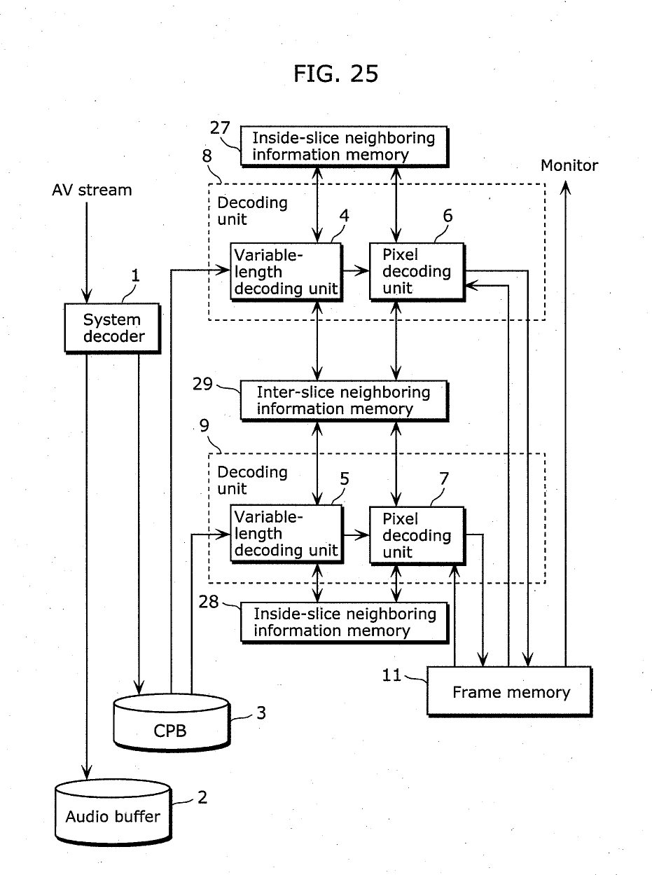

FIG. 25 is a block diagram showing a configuration of the image decoding device in Embodiment 4. Components identical to those in Embodiment 1 are not explained again here. The image decoding device in Embodiment 4 includes an inter-slice neighboring information memory 29 which stores information referenced by a different slice. Moreover, the image decoding device in Embodiment 4 includes two inside-slice neighboring information memories 27 and 28, each of which stores information referenced within the same slice.

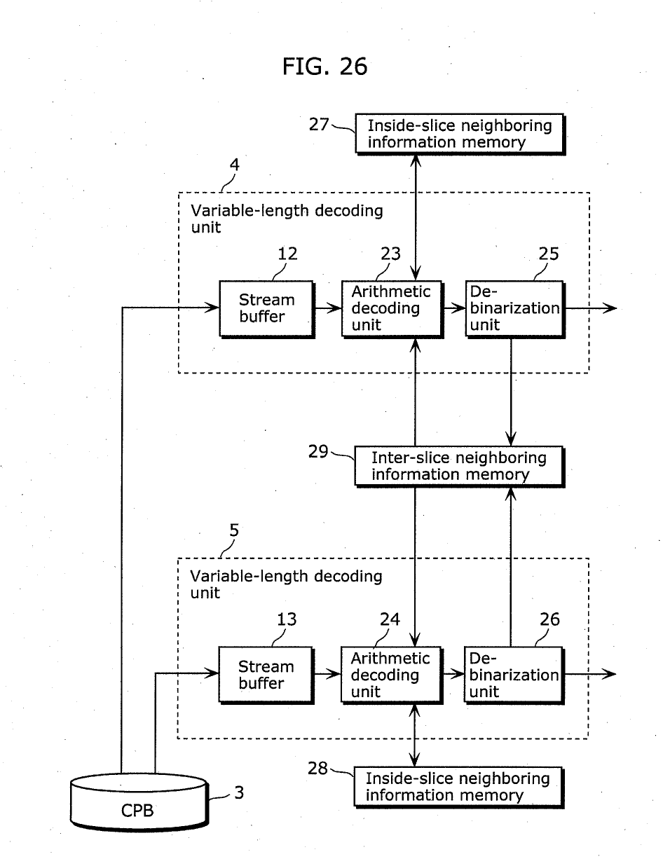

FIG. 26 is a block diagram showing configurations of variable-length decoding units in Embodiment 4. Components identical to those shown in FIG. 2 or FIG. 25 are not explained again here.

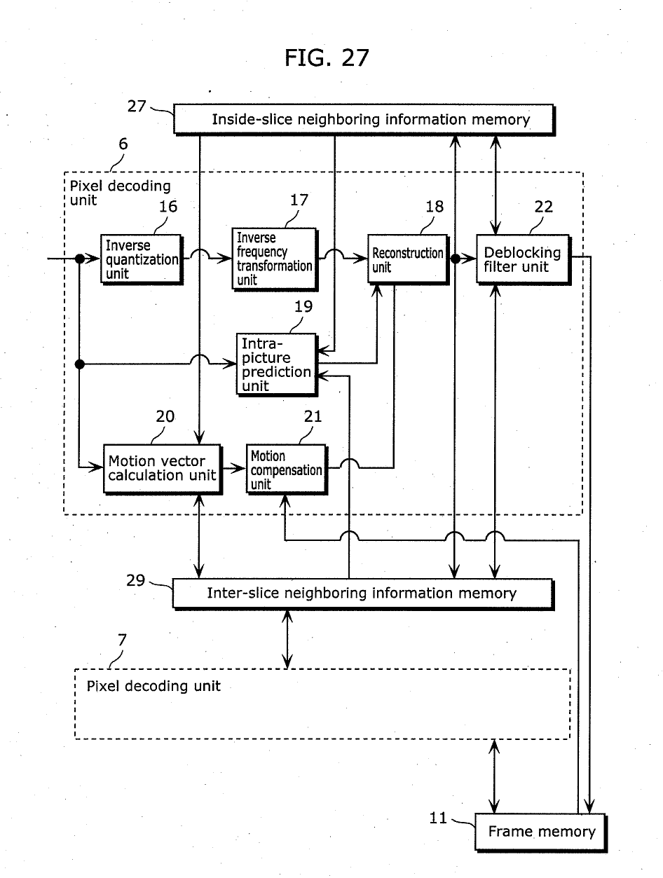

FIG. 27 is a block diagram showing configurations of pixel decoding units in Embodiment 4. Components identical to those shown in FIG. 3 or FIG. 25 are not explained again here.

The neighboring information memory 10 described in Embodiment 1 is divided into the two inside-slice neighboring information memories 27 and 28 and the inter-slice neighboring information memory 29. Other than this, the configurations shown in FIGS. 25, 26, and 27 are identical to those shown in FIGS. 1, 2, and 3, respectively. The information stored in each of the two inside-slice neighboring information memories 27 and 28 is limited to information referenced only within the same slice. The information stored in the inter-slice neighboring information memory 29 is limited to information referenced only between the slices.

In order to distribute memory access, it is preferable for the inside-slice neighboring information memory 27 to be inaccessible by the decoding unit 9. Similarly, it is preferable for the inside-slice neighboring information memory 28 to be inaccessible by the decoding unit 8. In other words, it is preferable for the inter-slice neighboring information memory 29 and the two inside-slice neighboring information memories 27 and 28 to be physically separated.

For example, the inside-slice neighboring information memory 27 may be accessible only by the decoding unit 8, and the inside-slice neighboring information memory 28 may be accessible only by the decoding unit 9. Then, the decoding unit 8 may include the inside-slice neighboring information memory 27, and the decoding unit 9 may include the inside-slice neighboring information memory 28.

However, in order to avoid a complex configuration, the inter-slice neighboring information memory 29 and the two inside-slice neighboring information memories 27 and 28 may be physically configured as a single memory that is logically divided.

This is the description of the configuration of the image decoding device in Embodiment 4.

### [4-3. Operation]

Next, an operation performed by the image decoding device in Embodiment 4 is described.

Except for the neighboring information checking (S001) and the neighboring information writing (S002), the processes performed by the image decoding device in Embodiment 4 are identical to those shown in FIGS. 6, 8, 12, and 13 in Embodiment 1.

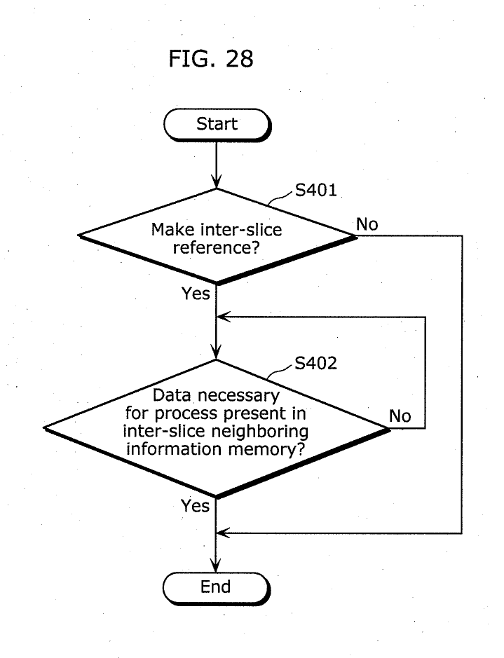

The operation performed by the variable-length decoding unit 4 to check for the neighboring information (S001) is described in detail with reference to FIG. 28.

Firstly, the variable-length decoding unit 4 checks whether or not the target macroblock makes inter-slice reference (S401). Since the macroblocks included in a slice are sequentially processed, data referenced within the slice definitely exists in the inside-slice neighboring information memory 27. Therefore, in the case where the target macroblock does not make inter-slice reference (No in S401), this means that the necessary data definitely exists and thus the variable-length decoding unit 4 terminates this checking process here.

In the case where the target macroblock makes inter-slice reference, the variable-length decoding unit 4 checks whether or not necessary information is present in the inter-slice neighboring information memory 29 (S402). When the necessary information is not present (No in S402), the variable-length decoding unit 4 waits until the necessary information is written by the variable-length decoding unit 5. Then, after the necessary information is written, the variable-length decoding unit 4 terminates this checking process and executes a subsequent process.

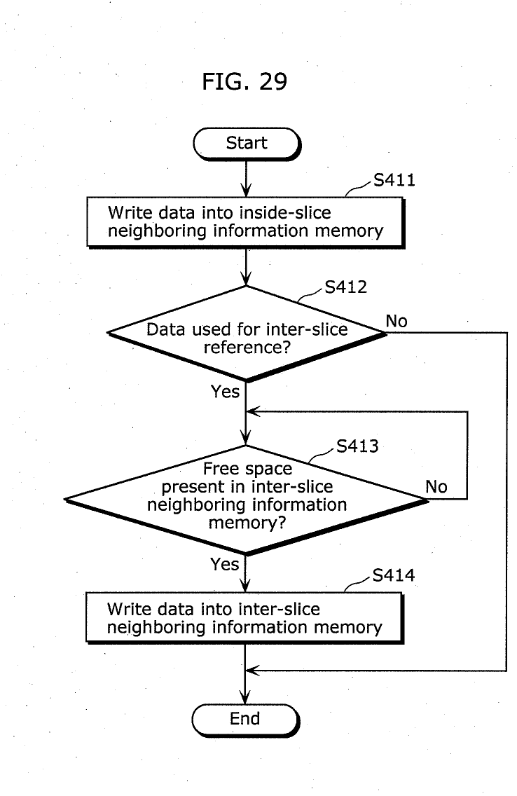

Next, the process of writing information into the neighboring information memory (S002) is described in detail with reference to FIG. 29. This example describes the case where the information is written into the inside-slice neighboring information memory 27 and the inter-slice neighboring information memory 29.

Firstly, the variable-length decoding unit 4 writes, into the inside-slice neighboring information memory 27, the information to be referenced within the slice (S411).

Next, the variable-length decoding unit 4 determines whether or not the decoded data is used for inter-slice reference (S412).

When the decoded data is not used for inter-slice reference (No in S412), the variable-length decoding unit 4 terminates the writing process.

When the decoded data is used for inter-slice reference (Yes in S412), the variable-length decoding unit 4 checks whether or not the inter-slice neighboring information memory 29 has free space (S413).

When the inter-slice neighboring information memory 29 has no free space (No in S413), the variable-length decoding unit 4 waits until the inter-slice neighboring information memory 29 has free space.

When the inter-slice neighboring information memory 29 has free space (Yes in S413), the variable-length decoding unit 4 writes, into the inter-slice neighboring information memory 29, the information to be referenced by another macroblock (S144).

It should be noted that the variable-length decoding unit 5 performs the same operation as the variable-length decoding unit 4. Moreover, as is the case with the two variable-length decoding units 4 and 5, the two pixel decoding units 6 and 7 decode blocks using the inter-slice neighboring information memory 29 and the two inside-slice neighboring information memories 27 and 28.

Next, a method of storing data into the inside-slice neighboring information memory 27 and the inter-slice neighboring information memory 29 is described.

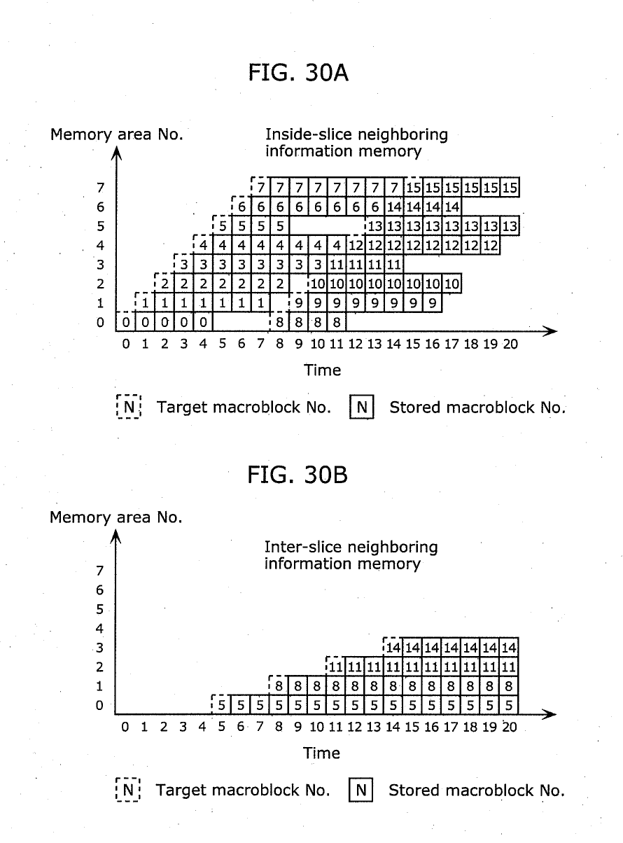

FIG. 30A is a diagram showing the data stored in the inside-slice neighboring information memory 27.

The inside-slice neighboring information memory 27 has eight memory areas. Of the eight memory areas, a memory area storing data can be uniquely determined by three least significant bits (LSB). In other words, these eight memory areas facilitate the determination of the memory area.

An order in which macroblocks included in a slice are processed is defined so that the macroblocks can be sequentially decoded. Thus, when the inside-slice neighboring information memory 27 has sufficient space, the neighboring information definitely exists and has been written into the inside-slice neighboring information memory 27.

Moreover, when the eight memory areas are provided, it is unnecessary to store the inside-slice neighboring information corresponding to more than the eight memory areas. Thus, an area which becomes unnecessary can be overwritten. To be more specific, since there is no such a case where the data cannot be written, the variable-length decoding unit 4 can always write the data into the inside-slice neighboring information memory 27 (S411), as shown in the flowchart of FIG. 29.

Similarly, data is written into the inside-slice neighboring information memory 28 by, for example, the variable-length decoding unit 5.

FIG. 30B is a diagram showing the data stored in the inter-slice neighboring information memory 29.

The data is stored into the inter-slice neighboring information memory 29, in order of increasing macroblock number. Moreover, the data stored in the inter-slice neighboring information memory 29 is read out in order of increasing macroblock number. Since the data is not randomly accessed, the processes of checking for the necessary data (S001) and of checking for free space to write the data (S002) can be performed via the control of the write and read pointers.

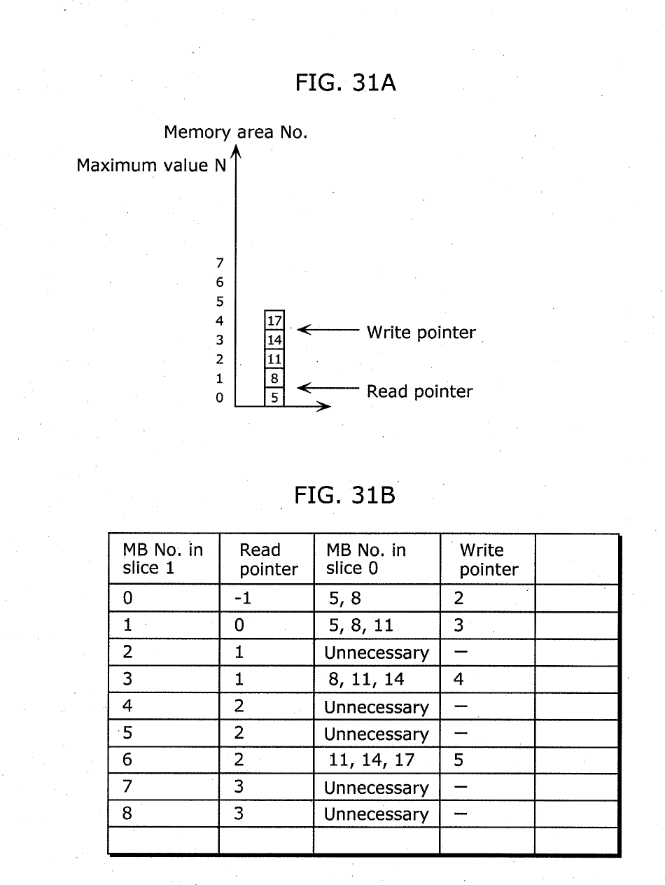

Each of FIGS. 31A and 31B is a diagram showing a pointer operation in the inter-slice neighboring information memory 29.

When the decoding unit 9 processes the MB 0 of the slice 1, the read pointer is −1. In order to process the MB 0 of the slice 1, the decoding unit 9 needs the data on the MB 5 and the MB 8 of the slice 0 processed by the decoding unit 8.

The decoding unit 8 writes the data into the inter-slice neighboring information memory 29 using the write pointer. When the decoding unit 8 processes the MB 0 of the slice 0, the write pointer is 0. After the decoding unit 8 processes the MB 5, the write pointer becomes 1. Then, after the decoding unit 8 processes the MB 8, the write pointer becomes 2. In this way, every time the data is written into the inter-slice neighboring information memory 29, the write pointer is counted up.

Moreover, every time the data is read out from the inter-slice neighboring information memory 29, the read pointer is counted up.

The number of macroblocks referenced between the slices is three at the maximum. This means that when a difference between the write pointer and the read pointer is three or more, the decoding unit 9 can process the macroblocks. More specifically, when the difference is three or more, it is considered that the data necessary for the decoding process is present in the inter-slice neighboring information memory 29. Moreover, when the write pointer never passes the read pointer, it is determined that there is free space. For this reason, the write pointer is controlled so as not to pass the read pointer.

In this way, writing and reading are controlled via the pointer management, without using a management table.

The inter-slice neighboring information memory 29 is configured as a ring buffer. When the pointer reaches the maximum value of the buffer, i.e., the end of the buffer, the pointer returns to the beginning of the buffer. The inter-slice neighboring information memory 29 needs space proportionate to a difference in the operation timing between the decoding units.

When the four slices shown in FIG. 4 are processed, one macroblock in the slice 1 references to data on three macroblocks in the slice 0 at the maximum. Therefore, based on the reference relationship between the slice 0 and the slice 1, the inter-slice neighboring information memory 29 needs to store data on at least three macroblocks.

While processing the slice 0, the decoding unit 8 cannot process the slice 2. Thus, data on the slice 1 needs to be saved during this period. On this account, based on the reference relationship between the slice 1 and slice 2, it is preferable for the inter-slice neighboring information memory 29 to be able to store data on one macroblock line.

When the capacity of the inter-slice neighboring information memory 29 is large, discrepancies in processing speed are absorbed more. On the other hand, when the capacity is small, discrepancies in processing speed are absorbed less. Hence, performance can be more easily improved by increasing the capacity within the cost limit.

### [4-4. Characteristic Components]

The following describes the characteristic components in Embodiment 4.

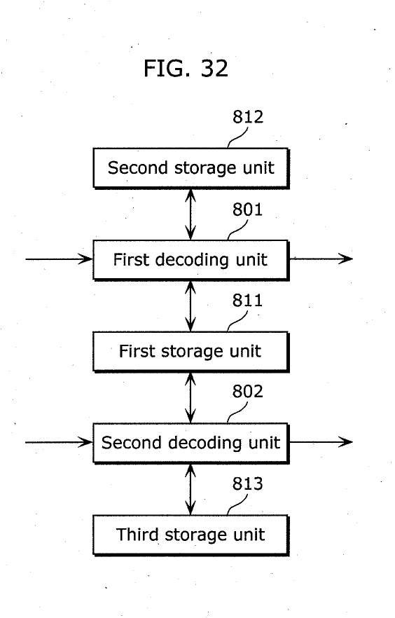

FIG. 32 is a block diagram showing a characteristic configuration of the image decoding device shown in FIG. 25.

The image decoding device shown in FIG. 32 includes a first decoding unit 801, a second decoding unit 802, a first storage unit 811, a second storage unit 812, and a third storage unit 813. The first decoding unit 801, the second decoding unit 802, the first storage unit 811, the second storage unit 812, and the third storage unit 813 are implemented by the decoding unit 8, the decoding unit 9, the inter-slice neighboring information memory 29, and the two inside-slice neighboring information memories 27 and 28 shown in FIG. 25, respectively. The image decoding device shown in FIG. 32 decodes an image having a plurality of slices.

The first decoding unit 801 is a processing unit which decodes a block included in a first slice among the slices.

The second decoding unit 802 is a processing unit which decodes a block included in a second slice different from the first slice among the slices.

The first storage unit 811 is a storage unit which stores the inter-slice neighboring information.

The above components are identical to those of the image decoding device shown in FIG. 18A in Embodiment 1. The second storage unit 812 and the third storage unit 813 are further added to the image decoding device in FIG. 32.

The second storage unit 812 is a storage unit which stores inside first-slice neighboring information used by the first decoding unit 801. The inside first-slice neighboring information is generated by decoding an inside first-slice block which is one of blocks included in the first slice. Moreover, the first inside-slice neighboring information is referenced when an inside first-slice neighboring block that is included in the first slice and adjacent to the inside first-slice block is decoded.

The first decoding unit 801 stores, into the second storage unit 812, the first inside-slice neighboring information generated by decoding the inside first-slice block. Then, the first decoding unit 801 decodes the inside first-slice neighboring block by reference to the first inside-slice neighboring information stored in the second storage unit 812.

The third storage unit 813 is a storage unit which stores inside second-slice neighboring information used by the second decoding unit 802. The second inside-slice neighboring information is generated by decoding an inside second-slice block which is one of blocks included in the second slice. Moreover, the second inside-slice neighboring information is referenced when an inside second-slice neighboring block that is included in the second slice and adjacent to the inside second-slice block is decoded.

The second decoding unit 802 stores, into the third storage unit 813, the second inside-slice neighboring information generated by decoding the inside second-slice block. Then, the second decoding unit 802 decodes the inside second-slice neighboring block by reference to the second inside-slice neighboring information stored in the third storage unit 813.

In order to distribute the access, the first storage unit 811, the second storage unit 812, and the third storage unit 813 may be physically separated. Alternatively, in order to avoid a complex configuration, the first storage unit 811, the second storage unit 812, and the third storage unit 813 may be physically configured as a single memory that is logically divided.

This is the description of the characteristic components in Embodiment 4.

### [4-5. Advantageous Effect]

In Embodiments 1, 2, and 3, free space is detected by using the management table shown in FIG. 11, and whether or not the necessary data is present in the neighboring information memory is determined. In Embodiment 4, the neighboring information memory is divided into the inside-slice neighboring information memory and the inter-slice neighboring information memory. With this configuration, whether or not the necessary data is present in the neighboring information memory and whether or not free space is present are determined via a simple process of pointer comparison, without using a management table.

Moreover, each of the two decoding units 8 and 9 can decode a block which is not adjacent to the slice boundary using the inside-slice neighboring information, without having to wait for the other unit to finish the processing. This improves the operational efficiency and increases the processing speed.

### [4-6. Supplemental Remarks]

It should be noted that, in Embodiment 4, each of the inside-slice neighboring information memories 27 and 28 has eight memory areas. However, the number of memory areas does not need to be eight, and may be any number as long as the areas are at least in the size necessary to store information.

In Embodiment 4, the two inside-slice neighboring information memories 27 and 28 store data without distinguishing between the cases where a macroblock is referenced as a left macroblock and where a macroblock is referenced as an upper macroblock. However, when the information is different between the cases where the macroblock is referenced as a left macroblock and where the macroblock is referenced as an upper macroblock, the information may be distinguished and stored in storage elements such as memories.

Embodiment 4 has described an example of the application to the variable-length coding method. However, the coding method may be any other coding method, such as arithmetic coding, Huffman coding, or run-length coding, as long as the method references to data on a neighboring macroblock.

Moreover, the number of decoding units is two in Embodiment 4. However, the number of decoding units is not limited two, and may be three, four, or more.

Furthermore, the number of macroblocks in a slice in a vertical direction is three in Embodiment 4. However, the number of macroblocks in a slice in the vertical direction is not limited to three, and may be less or more than three. Moreover, although the number of slices in a picture is four in Embodiment 4, a picture may include any number of slices.

Moreover, in Embodiment 4, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 4 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 4, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 4. However, the component which stores information may be any other memory element, such as a flip-flop.

Moreover, in Embodiment 4, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 5

### [5-1. Overview]

Next, an overview of an image decoding device according to Embodiment 5 of the present invention is described.

In Embodiment 5, the inter-slice neighboring information memory described in Embodiment 4 is divided into two. This division distributes access, and facilitates configuration of memories. Moreover, with this division, the number of decoding units is easily increased.

This is the overview of the image decoding device according to Embodiment 5.

### [5-2. Configuration]

Next, a configuration of the image decoding device according to Embodiment 5 is described.

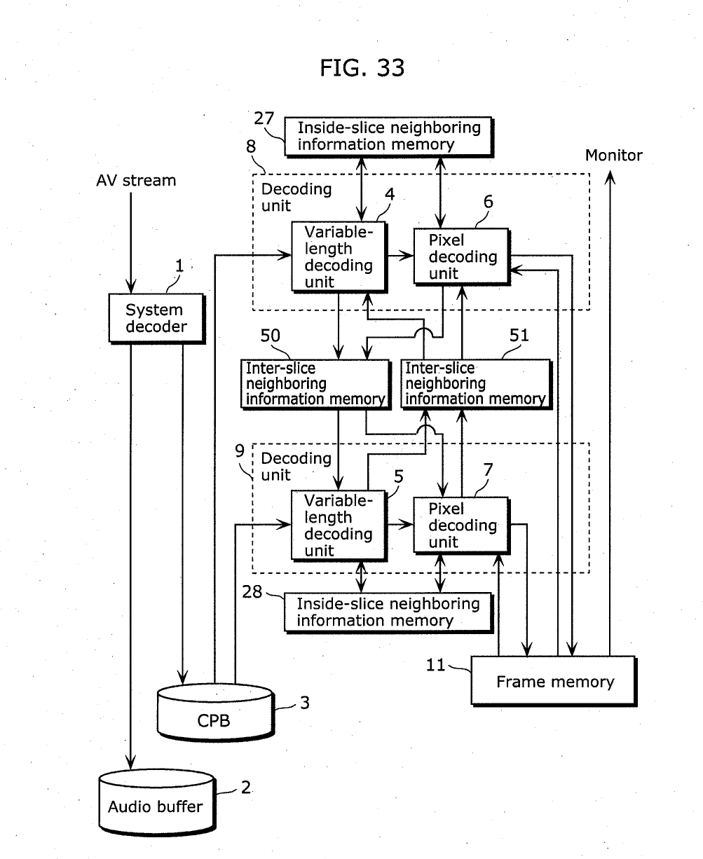

FIG. 33 is a block diagram showing the configuration of the image decoding device in Embodiment 5. Components identical to those shown in FIG. 25 are not explained again here. The image decoding device in Embodiment 5 includes two inter-slice neighboring information memories 50 and 51 each of which stores information to be referenced by a different slice.

This is the description of the configuration of the image decoding device according to Embodiment 5.

### [5-3. Operation]

An operation performed in Embodiment 5 is identical to the operation performed in Embodiment 4 and, therefore, the description is given with reference to FIGS. 28 and 29. In FIG. 28, in order to check for data used for the decoding process (S402), the decoding unit 8 checks whether or not the data is present in the inter-slice neighboring information memory 51 managed by the decoding unit 9. In FIG. 29, when writing data obtained as a result of the decoding process (S414), the decoding unit 8 writes the data into the inter-slice neighboring information memory 50 managed by the decoding unit 8.

On the other hand, in FIG. 28, in order to check for data used for the decoding process (S402), the decoding unit 9 checks whether or not the data is present in the inter-slice neighboring information memory 50 managed by the decoding unit 8. In FIG. 29, when writing data obtained as a result of the decoding process (S414), the decoding unit 9 writes the data into the inter-slice neighboring information memory 51 managed by the decoding unit 9.

Here, each of the decoding units manages the inter-slice neighboring information memory that is a write destination. However, the inter-slice neighboring information memory that is a read destination may be managed.

### [5-4. Advantageous Effect]

Embodiment 4 describes the configuration in which the plurality of decoding units access the single inter-slice neighboring information memory. However, in the case where the number of decoding units is increased, access is concentrated on the inter-slice neighboring information memory and thus the memory management becomes difficult. In Embodiment 5, on the other hand, each of the decoding units manages the corresponding inter-slice neighboring information memory. According to this configuration, the inter-slice neighboring information memory is accessed only by the decoding unit that processes the adjacent slice. In other words, the concentrated access is prevented and the memory management is easy.

### [5-5. Supplemental Remarks]

Embodiment 5 has described an example of the application to the variable-length coding method. However, the coding method may be any other coding method, such as arithmetic coding, Huffman coding, or run-length coding, as long as the method references to data on a neighboring macroblock.

Moreover, the number of decoding units is two in Embodiment 5. However, the number of decoding units is not limited two, and may be three, four, or more.

Furthermore, the number of macroblocks in a slice in a vertical direction is three in Embodiment 5. However, the number of macroblocks in a slice in the vertical direction is not limited to three, and may be less or more than three. Moreover, although the number of slices in a picture is four in Embodiment 5, a picture may include any number of slices.

Moreover, in Embodiment 5, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 5 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 5, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 5. However, the component which stores information may be any other memory element, such as a flip-flop.

Moreover, in Embodiment 5, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 6

### [6-1. Overview]

Next, an overview of an image coding device according to Embodiment 6 of the present invention is described.

The image coding device in Embodiment 6 codes an image using a plurality of coding units to convert the image into a video stream. Moreover, a system encoder multiplexes the video stream and an audio stream that has been separately coded, and outputs the resulting stream. The coded video stream is constructed so as to be read out by a plurality of decoding units.

The coding units make reference to each other via a neighboring information memory to obtain a coded parameter and a partial result of a local decoding process. Then, the coding units perform the image coding process in synchronization with each other.

This is the overview of the image coding device according to Embodiment 6.

### [6-2. Configuration]

Next, a configuration of the image coding device according to Embodiment 6 is described.

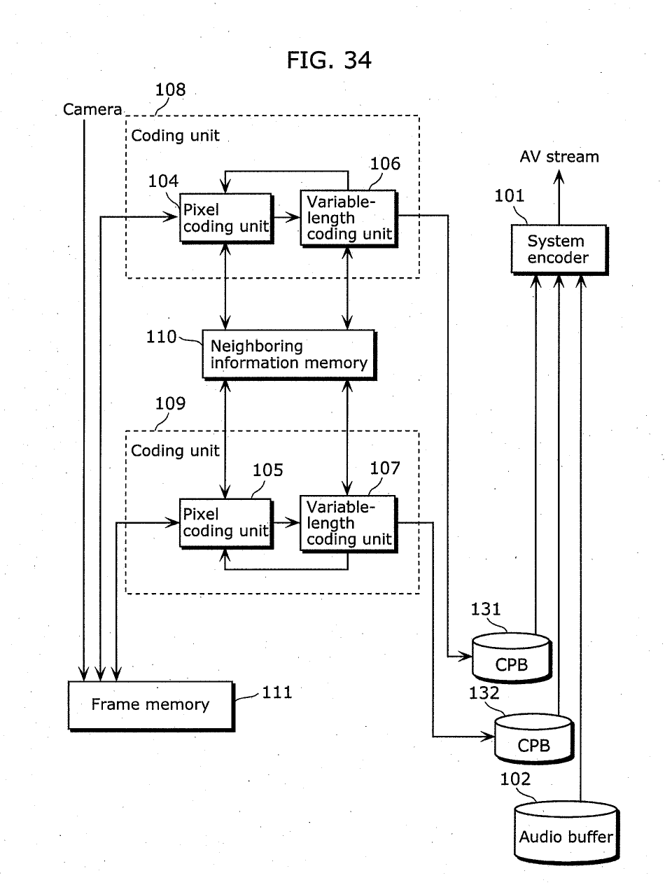

FIG. 34 is a block diagram showing the configuration of the image coding device in Embodiment 6. The image coding device in Embodiment 6 includes a frame memory 111, two pixel coding units 104 and 105, two variable-length coding units 106 and 107, a neighboring information memory 110, two CPBs 131 and 132, an audio buffer 102, and a system encoder 101.

The frame memory 111 stores an input image and a local decoded image. Each of the two pixel coding units 104 and 105 extracts a part of the image stored in the frame memory and codes the extracted part. Each of the two variable-length coding units 106 and 107 performs a variable-length coding process. The neighboring information memory 110 stores information on a neighboring macroblock used for the coding process.

Each of the two CPBs 131 and 132 buffers the variable-length coded stream. To be more specific, the CPB 131 buffers the stream generated by a coding unit 108, and the CPB 132 buffers the stream generated by a coding unit 109. The audio buffer 102 buffers the audio stream having been separately coded. The system encoder 101 multiplexes the audio stream and the video stream.

The pixel coding unit 104 and the variable-length coding unit 106 are collectively called the coding unit 108. The pixel coding unit 105 and the variable-length coding unit 107 are collectively called the coding unit 109.

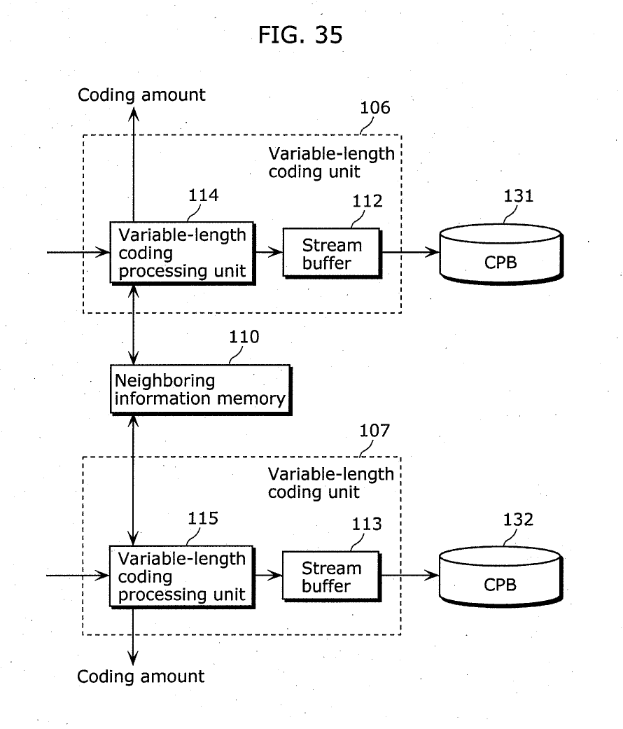

FIG. 35 is a block diagram showing configurations of the two variable-length coding units 106 and 107 shown in FIG. 34. Components identical to those shown in FIG. 34 are not explained again here. The variable-length coding unit 106 includes: a stream buffer 112 which stores a stream; and a variable-length coding processing unit 114 which performs a variable-length coding process on input data. Similarly, the variable-length coding unit 107 includes a stream buffer 113 and a variable-length coding processing unit 115.

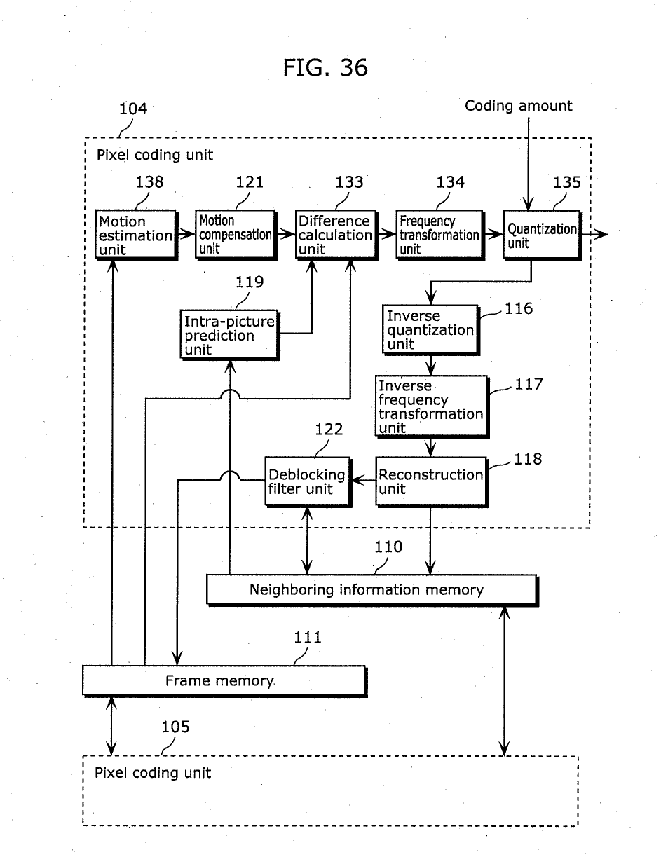

FIG. 36 is a block diagram showing configurations of the two pixel coding units 104 and 105 shown in FIG. 34. Components identical to those shown in FIG. 34 or FIG. 35 are not explained again here.

The pixel coding unit 104 includes a motion estimation unit 138, a motion compensation unit 121, an intra-picture prediction unit 119, a difference calculation unit 133, a frequency transformation unit 134, a quantization unit 135, an inverse quantization unit 116, an inverse frequency transformation unit 117, a reconstruction unit 118, and a deblocking filter unit 122.

The motion estimation unit 138 performs motion estimation. The motion compensation unit 121 performs motion compensation using a motion vector obtained via the motion estimation, to generate a predicted image. The intra-picture prediction unit 119 performs intra-picture prediction to generate a predicted image. The difference calculation unit 133 calculates a difference between the input image and the predicted image.

The frequency transformation unit 134 performs frequency transformation. The quantization unit 135 performs quantization corresponding to a target bit rate, depending on a generated coding amount. The inverse frequency transformation unit 117 performs inverse frequency transformation together with the inverse quantization unit 116 which performs inverse quantization. The reconstruction unit 118 reconstructs an image from the predicted image and a result of the inverse frequency transformation. The deblocking filter unit 122 performs a deblocking filtering process on the reconstructed decoded result.

Components included in the pixel coding unit 105 are identical to those included in the pixel coding unit 104 and, therefore, illustrations of the components in the pixel coding unit 105 are omitted in FIG. 36.

This is the description of the configuration of the image coding device according to Embodiment 6.

### [6-3. Operation]

Next, an operation performed by the image coding device shown in FIGS. 34, 35, and 36 is described.

Embodiment 6 uses the stream structure shown in FIG. 4B in Embodiment 1 and the order of processing macroblocks shown in FIG. 4C in Embodiment 1. As is the case with Embodiment 1, the structure of a picture is identical to the structure defined in the H.264 standard, except that the picture in Embodiment 6 includes slices between which reference is allowed and that the processing order in the slice is different. Similarly, the reference relationship between the macroblocks is the same as shown in FIG. 5A. The coding unit 108 codes the slice 0 and the slice 2, and the coding unit 109 codes the slice 1 and the slice 3.

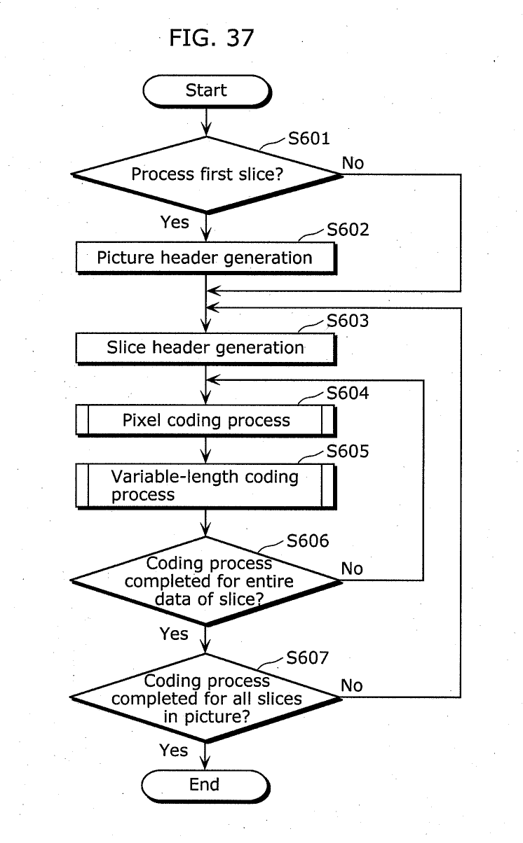

Next, an operation performed by the coding unit 108 included in the image coding device shown in FIG. 34 is described with reference to a flowchart shown in FIG. 37. FIG. 37 shows the flowchart of an operation performed to code one picture.

Firstly, the coding unit 108 determines whether to process a first slice (S601). In the case of processing the first slice (Yes in S601), the coding unit 108 generates a picture header including a start code (S602). The generated picture header is written into the CPB 131.

Following this, the coding unit 108 generates a slice header of a target slice to be processed (S603).

Next, the pixel coding unit 104 of the coding unit 108 executes a pixel coding process on a macroblock-by-macroblock basis (S604). Then, the variable-length coding unit 106 of the coding unit 108 performs a variable-length coding process (S605).

After the pixel coding process and the variable-length coding process, when the coding process is not completed for entire data on the slice (No in S606), the pixel coding unit 104 of the coding unit 108 executes the pixel coding process on a macroblock-by-macroblock basis again (S604).

When the coding process is completed for the entire data on the slice (Yes in S606), the coding unit 108 determines whether or not the coding process is completed for all the target slices, in the picture, to be processed by the coding unit 108 (S607).

When the coding process is not completed for all the target slices (No in S607), the coding unit 108 generates a slice header again (S603). When the coding process is completed (Yes in S607), the coding unit 108 terminates the coding process for the picture.

An operation performed by the coding unit 109 is identical to the operation performed by the coding unit 108, except that target slices are different.

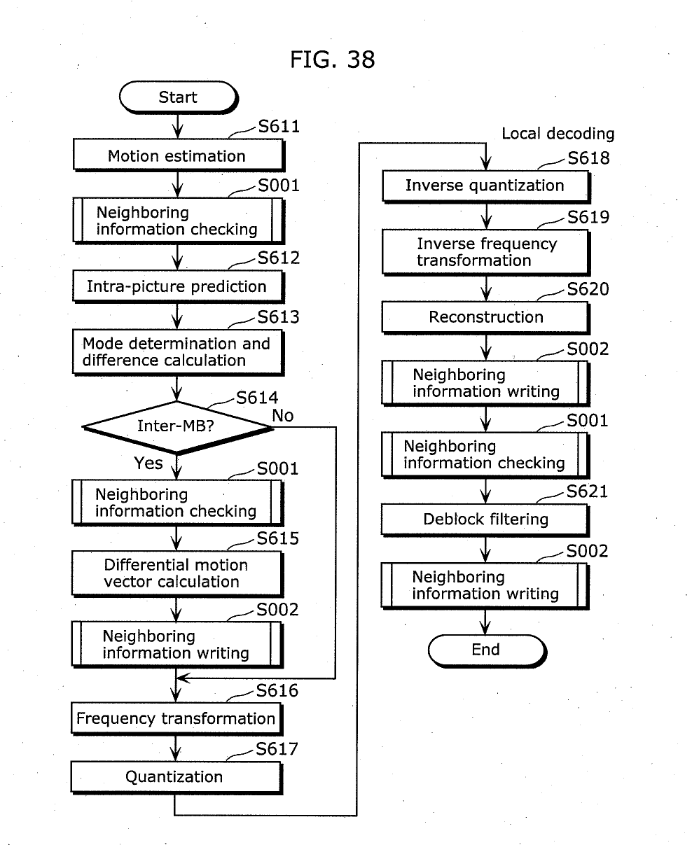

Next, the pixel coding process (S604) in FIG. 37 is described with reference to FIG. 38.

Firstly, the motion estimation unit 138 of the pixel coding unit 104 performs a motion estimation process to detect a part of a target macroblock to be coded that has the highest correlation with a local picture which has been previously decoded (S611).

Following this, the pixel coding unit 104 checks for neighboring information for an intra-picture prediction process performed by the intra-picture prediction unit 119 (S001). The process of checking for the neighboring information (S001) is identical to the process shown in FIG. 9 in Embodiment 1.

The intra-picture prediction unit 119 generates an intra-picture predicted image using images of neighboring macroblocks shown in FIG. 15 (S612).

Next, the difference calculation unit 133 compares an inter-MB obtained by the motion estimation and an intra-MB obtained by the intra-picture prediction to find out which has a smaller coding amount. Then, the difference calculation unit 133 accordingly determines a coding mode, and calculates data on a difference between the predicted image and the target macroblock (S613).

When the inter-MB has the smaller coding amount (Yes in S614), the difference calculation unit 133 checks for the neighboring information (S001). The process of checking for the neighboring information (S001) is identical to the process shown in FIG. 9 in Embodiment 1.

When the data necessary to calculate a differential motion vector is present in the neighboring information memory 110, the difference calculation unit 133 calculates the differential motion vector (S615). Here, the differential motion vector can be obtained by calculating mvd shown in FIG. 14 in Embodiment 1 and, therefore, the explanation is not repeated here.

After calculating the differential motion vector, the difference calculation unit 133 performs a process of writing the neighboring information (S002) in order to write the determined motion vector into the neighboring information memory 110. The process of writing the neighboring information is identical to the process performed in Embodiment 1.

Next, the frequency transformation unit 134 performs frequency transformation on the differential data calculated by the difference calculation unit 133 (S616).

Following this, the quantization unit 135 quantizes the data on which the frequency transformation has been performed (S617). At this time, the quantization unit 135 determines a quantization parameter from the generated coding amount calculated by the variable-length coding unit 106 and accordingly quantized the data.

When the generated coding amount is expected to be larger as compared to a target coding amount predetermined on a slice-by-slice basis, the quantization unit 135 increases a quantization width to reduce the generated coding amount. On the other hand, when the generated coding amount is expected to be smaller than the target coding amount, the quantization unit 135 decreases a quantization width to increase the generated coding amount. Such feedback control allows the coding amount to be closer to the target coding amount.

Here, the pixel coding process for generating a coded stream is completed. However, in order to match the reference image to the reference image in an image decoding device, a local decoding process is executed. The local decoding process is described as follows.

In the local decoding process, the inverse quantization unit 116 firstly performs inverse quantization on the quantized data (S618).

Next, the inverse frequency transformation unit 117 performs inverse frequency transformation on the inversely-quantized data (S619).

In the case of the inter-MB, the reconstruction unit 118 performs a reconstruction process using the data on which the inverse frequency transformation has been performed and the reference image generated by the motion estimation unit 138 (S620). In the case of the intra-MB, the reconstruction unit 118 performs the reconstruction process using the data on which the inverse frequency transformation has been performed and the reference image generated by the intra-picture prediction unit 119 (S620).

After finishing the reconstruction process, the reconstruction unit 118 performs the process of writing the neighboring information (S002) for the intra-picture prediction process performed on a next macroblock. The process of writing the neighboring information is identical to the process performed in Embodiment 1.

Next, the deblocking filter unit 122 checks for the neighboring information necessary for the deblocking filtering process (S001).

When the neighboring information necessary for the deblocking filtering process is present, the deblocking filter unit 122 performs the deblocking filtering process and stores the result into the frame memory 111 (S621).

After finishing the deblocking filtering process, the deblocking filter unit 122 performs the process of writing the neighboring information (S002). Accordingly, the pixel coding unit 104 completes the pixel coding process.

The process performed by the pixel coding unit 105 is identical to the process performed by the pixel coding unit 104.

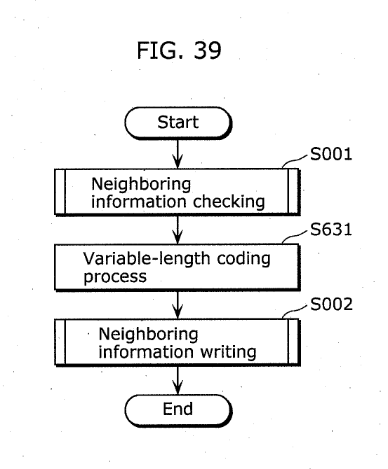

Next, a process performed by the variable-length coding unit 106 is described with reference to FIG. 39.

The variable-length coding unit 106 checks for the neighboring information (S001). When the necessary neighboring information is not present in the neighboring information memory 110, the variable-length coding unit 106 waits until the necessary information is written into the neighboring information memory 110. When the necessary information is present, the variable-length coding unit 106 performs the variable-length coding process on the data received from the pixel coding unit 104 (S631). Then, the variable-length coding unit 106 writes the result of the variable-length coding process into the neighboring information memory 110 (S002).

An operation performed by the variable-length coding unit 107 is identical to the operation performed by the variable-length coding unit 106.

In this way, as is the case with the image decoding device according to Embodiment 1, the two coding units operate in synchronization with each other via the neighboring information memory to code an image.

This is the description of the operation performed by the image coding device according to Embodiment 6.

### [6-4. Characteristic Components]

The following describes the characteristic components in Embodiment 6.

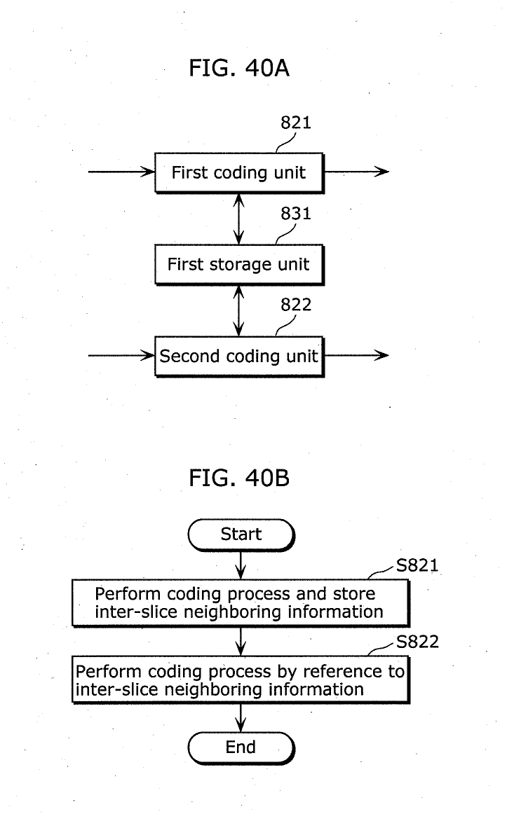

FIG. 40A is a block diagram showing a characteristic configuration of the image coding device in Embodiment 6.

The image coding device shown in FIG. 40A includes a first coding unit 821, a second coding unit 822, and a first storage unit 831. The first coding unit 821, the second coding unit 822, and the first storage unit 831 are implemented by the coding unit 108, the coding unit 109, and the neighboring information memory 110 shown in FIG. 34, respectively. The image coding device shown in FIG. 40A codes an image having a plurality of slices.

The first coding unit 821 is a processing unit which codes a block included in a first slice among the slices.

The second coding unit 822 is a processing unit which codes a block included in a second slice different from the first slice among the slices.

The first storage unit 831 is a storage unit which stores inter-slice neighboring information. Here, the inter-slice neighboring information is generated by coding a boundary block that is included in the first slice and is adjacent to the second slice. Moreover, the inter-slice neighboring information is referenced when a boundary neighboring block that is included in the second slice and is adjacent to the boundary block is coded.

The first coding unit 821 stores, into the first storage unit 831, the inter-slice neighboring information generated by coding the boundary block.

The second coding unit 822 codes the boundary neighboring block by reference to the inter-slice neighboring information stored in the first storage unit 831.

FIG. 40B is a flowchart showing a characteristic operation performed by the image coding device shown in FIG. 40A.

Firstly, the first coding unit 821 codes a block included in the first slice among the slices. Here, the first coding unit 821 stores, into the first storage unit 831, the inter-slice neighboring information generated by coding the boundary block (S821).

Following this, the second coding unit 822 codes a block included in the second slice different from the first slice, among the slices. Here, the second coding unit 822 codes the boundary neighboring block by reference to the inter-slice neighboring information stored in the first storage unit 831 (S822).

It should be noted that the information referenced only within the slice may be stored in the first storage unit 831 or a separate storage unit.

This is the description of the characteristic components in Embodiment 6.

### [6-5. Advantageous Effect]

In this way, as is the case with Embodiment 1, the image coding device according to Embodiment 6 includes the two coding units 108 and 109 and the neighboring information memory 110. The neighboring information memory 110 stores only the data necessary for reference. The data which is not to be referenced again is discarded, so that new data necessary for reference can be written. This can reduce the capacity of the neighboring information memory 110.

Moreover, sufficient space can be ensured in the neighboring information memory 110. This can reduce the waiting times taken before the processes performed by the two coding units 108 and 109 and thus increase the efficiency of the coding process. Accordingly, even when an operating frequency of the image coding device is low, high-speed image coding can be achieved via parallel processing.

### [6-6. Supplemental Remarks]

Embodiment 6 has described an example where the configuration of the neighboring information memory is the same as in the image decoding device shown in Embodiment 1. However, the configuration may be based on any other Embodiment described above.

Embodiment 6 has described an example of the application to the variable-length coding method. However, the coding method may be any other coding method, such as arithmetic coding, Huffman coding, or run-length coding, as long as the method references to data on a neighboring macroblock.

Moreover, the number of coding units is two in Embodiment 6. However, the number of coding units is not limited two, and may be three, four, or more.

Furthermore, the number of macroblocks in a slice in a vertical direction is three in Embodiment 6. However, the number of macroblocks in a slice in the vertical direction is not limited to three, and may be less or more than three. Moreover, although the number of slices in a picture is four in Embodiment 6, a picture may include any number of slices.

Moreover, in Embodiment 6, the neighboring information checking is performed before each process and the neighboring information writing is performed after each process. However, the neighboring information checking and the neighboring information writing may be performed on a macroblock-by-macroblock basis. When these checking and writing processes are performed, on a macroblock-by-macroblock basis, the number of management tables may be one.

Furthermore, Embodiment 6 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 6, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 6. However, the component which stores information may be any other memory element, such as a flip-flop.

Moreover, in Embodiment 6, a single neighboring information memory stores all the pieces of neighboring information used for, for example, arithmetic coding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 7

### [7-1. Overview]

Next, an overview of an image decoding device according to Embodiment 7 of the present invention is described.

The image decoding device according to Embodiment 7 reads a video stream which has been separated from an AV-multiplexed stream by a system decoder, using a plurality of decoding units. The video stream is previously constructed so as be read by the decoding units.

The image decoding device in Embodiment 7 performs a variable-length decoding process and temporarily buffers a result of the decoding process, in a former stage. Then, the image decoding device in Embodiment 7 performs a pixel decoding process in a latter stage.

With this configuration, even when variations in the time taken for calculation in the variable-length decoding process are large, the buffer allows the entire processing times to be equalized. Accordingly, the decoding process can be executed more efficiently.

This is the overview of the image decoding device according to Embodiment 7.

### [7-2. Configuration]

Next, a configuration of the image decoding device according to Embodiment 7 is described.

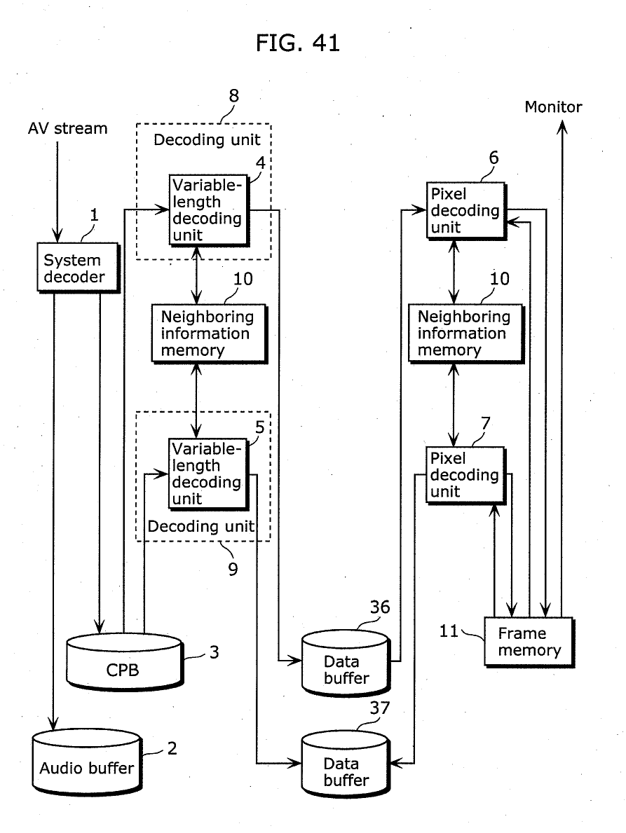

FIG. 41 a block diagram showing the configuration of the image decoding device in Embodiment 7. The image decoding device in Embodiment 7 includes a data buffer 36 which temporarily holds data received from a variable-length decoding unit 4 and stores data to be referenced by a pixel decoding unit 6. Moreover, the image decoding device in Embodiment 7 includes a data buffer 37 which temporarily holds data received from a variable-length decoding unit 5 and stores data to be referenced by a pixel decoding unit 7. The other components are identical to those shown in FIG. 1 in Embodiment 1.

This is the description of the configuration of the image decoding device according to Embodiment 7.

### [7-3. Operation]

Next, an operation performed by the image decoding device in Embodiment 7 is described.

The operation performed by the image decoding device in Embodiment 7 is identical to the operation performed in Embodiment 1. However, data from the two variable-length decoding units 4 and 5 is temporarily held by the two data buffers 36 and 37, respectively, instead of being sent directly to the two pixel decoding units 6 and 7. Each of the data buffers 36 and 37 has sufficient capacity corresponding to the data provided during the process executed by the corresponding one of the two variable-length decoding units 4 and 5. Therefore, the processing times can be equalized.

The processing time taken by each of the two variable-length decoding units 4 and 5 is basically proportionate to the corresponding number of bits. According to the H.264 standard, when an average stream bit rate is approximately 20 Mbps and a frame rate is 30 frames per second, the number of bits per picture is approximately 0.67 Mbits.

In reality, however, the number of bits allowed per picture is up to approximately ten times as many as 0.67 Mbits. Since the average bit rate is approximately 20 Mbps, a picture that follows a picture with the largest number of bits has a small number of bits. Therefore, the processing time significantly varies depending on a picture. This means that a smooth decoding process can be only achieved when the operating frequency is increased.

The image decoding device in Embodiment 7 implements a smooth decoding process by equalizing the processing times among pictures, without increasing the operating frequency.

It should be noted that, when the total coding amount of target slices is equal between the decoding units, performance required of the decoding units can be suppressed.

### [7-4. Characteristic Components]

The following describes the characteristic components in Embodiment 7.

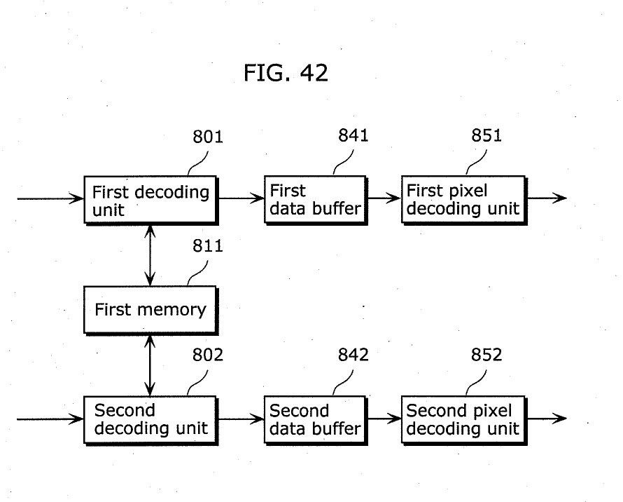

FIG. 42 is a block diagram showing a characteristic configuration of the image decoding device shown in FIG. 41.

The image decoding device shown in FIG. 42 includes a first decoding unit 801, a second decoding unit 802, a first storage unit 811, a first data buffer 841, a second data buffer 842, a first pixel decoding unit 851, and a second pixel decoding unit 852. The first decoding unit 801, the second decoding unit 802, the first storage unit 811, the first data buffer 841, the second data buffer 842, the first pixel decoding unit 851, and the second pixel decoding unit 852 are implemented by the decoding unit 8, the decoding unit 9, the neighboring information memory 10, the two data buffers 36 and 37, and the two pixel decoding units 6 and 7 shown in FIG. 41, respectively. The image decoding device shown in FIG. 42 decodes an image having a plurality of slices.

The first decoding unit 801 is a processing unit which decodes a block included in a first slice among the slices.

The second decoding unit 802 is a processing unit which decodes a block included in a second slice different from the first slice among the slices.

The first storage unit 811 is a storage unit which stores inter-slice neighboring information.

The above components are identical to those included in the image decoding device shown in FIG. 18A in Embodiment 1. To the image decoding device shown in FIG. 42, the first data buffer 841, the second data buffer 842, the first pixel decoding unit 851, and the second pixel decoding unit 852 are further added.

The first data buffer 841 and the second data buffer 842 are storage units which store data.

The first decoding unit 801 performs a variable-length decoding process on the block included in the first slice. Then, the first decoding unit 801 stores the variable-length decoded data into the first data buffer 841.

The first pixel decoding unit 851 converts the data stored in the first data buffer 841 into a pixel value.

The second decoding unit 802 performs a variable-length decoding process on the block included in the second slice. Then, the second decoding unit 802 stores the variable-length decoded data into the second data buffer 842.

The second pixel decoding unit 852 converts the data stored in the second data buffer 842 into a pixel value.

It should be noted that the second decoding unit 802 may perform the variable-length decoding process on the block included in the second slice and then stores the variable-length decoded data into the first data buffer 841. Moreover, the data on which the variable-length decoding process has been performed by the second decoding unit 802 may be converted into the pixel value by the first pixel decoding unit 851.

This is the description of the characteristic components in Embodiment 7.

### [7-5. Advantageous Effect]

Even when the processing time taken by the variable-length decoding unit is significantly longer than the processing time taken by the pixel decoding unit, the image decoding device in Embodiment 7 can equalize the processing times using the two data buffers 36 and 37. Accordingly, even when the operating frequency is low, the image decoding device in Embodiment 7 can smoothly implement an image decoding process.

### [7-6. Supplemental Remarks]

Embodiment 7 has described an example where the configuration of the neighboring information memory is the same as in the image decoding device according to Embodiment 1. However, the configuration may be based on any other Embodiment described above.

Moreover, in order to reduce the capacity of the data buffer or reduce the bandwidth to access the data buffer, the data on which the variable-length decoding process has been performed by the variable-length decoding unit may be compressed and then the pixel decoding unit may decompress the compressed data before performing the pixel decoding process.

Moreover, the number of decoding units is two in Embodiment 7. However, the number of decoding units is not limited two, and may be three, four, or more.

Embodiment 7 includes the two variable-length decoding units and the two pixel decoding units. However, the number of variable-length decoding units may be different from the number of pixel decoding units. For example, the number of variable-length decoding units may be one and then the number of pixel decoding units may be two. These numbers can be determined freely as long as performance is satisfied.

Embodiment 7 has described an example of the application to the variable-length coding method. However, the coding method may be any other coding method, such as arithmetic coding, Huffman coding, or run-length coding, as long as the method references to data on a neighboring macroblock.

Furthermore, the number of macroblocks in a slice in a vertical direction is three in Embodiment 7. However, the number of macroblocks in a slice in the vertical direction is not limited to three, and may be less or more than three. Moreover, although the number of slices in a picture is four in Embodiment 7, a picture may include any number of slices.

Moreover, in Embodiment 7, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 7 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 7, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 7. However, the component which stores information may be any other memory element, such as a flip-flop.

Moreover, in Embodiment 7, a single neighboring information memory stores all the pieces of neighboring information used for, for example, arithmetic decoding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 8

### [8-1. Overview]

Next, an overview of an image coding device according to Embodiment 8 of the present invention is described.

The image coding device in Embodiment 8 codes an image using a plurality of coding units to convert the image into a video stream. Moreover, a system encoder multiplexes the video stream and an audio stream that has been separately coded, and outputs the resulting stream. The coded video stream is constructed so as to be read out by a plurality of decoding units.

The coding units make reference to each other via a neighboring information memory to obtain a coded parameter and a partial result of a local decoding process. Then, the coding units perform the image coding process in synchronization with each other.

The image decoding device in Embodiment 8 performs a pixel coding process and temporarily buffers a result of the coding process, in a former stage. Then, the image decoding device in Embodiment 8 performs a variable-length coding process in a latter stage.

With this configuration, even when variations in the time taken for calculation in the variable-length coding process are large, the buffer allows the entire processing times to be equalized. Accordingly, the coding process can be executed more efficiently.

This is the overview of the image coding device according to Embodiment 8.

### [8-2. Configuration]

Next, a configuration of the image decoding device according to Embodiment 7 is described.

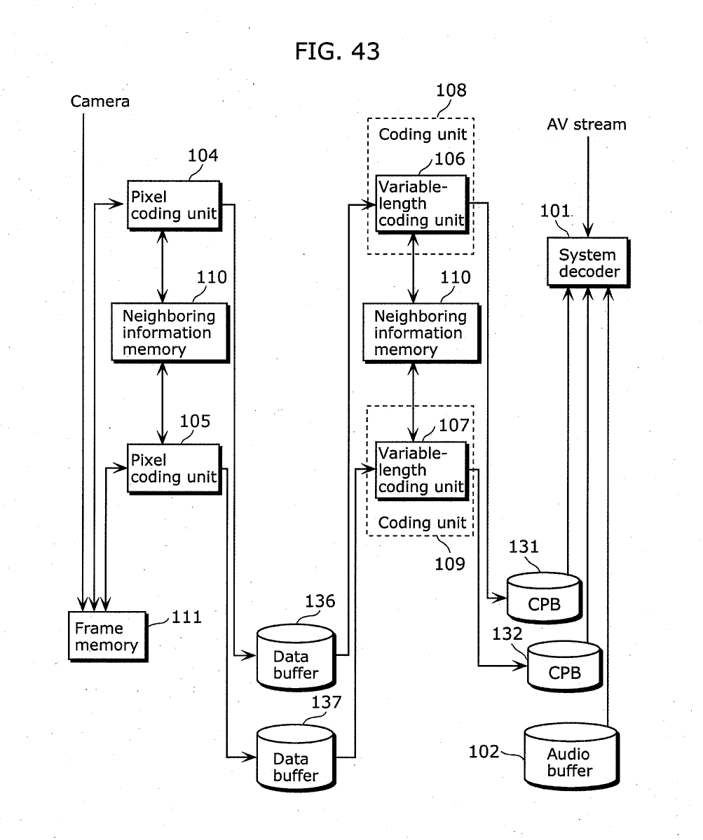

FIG. 43 is a block diagram showing the configuration of the image coding device in Embodiment 8. The image coding device in Embodiment 8 includes a data buffer 136 which temporarily holds data received from a pixel coding unit 104 and stores data to be referenced by a variable-length coding unit 106. Moreover, the image coding device in Embodiment 8 includes a data buffer 137 which temporarily holds data received from a pixel coding 105 and stores data to be referenced by a variable-length coding unit 107. The other components are identical to those shown in FIG. 34 in Embodiment 6.

This is the description of the configuration of the image coding device according to Embodiment 8.

### [8-3. Operation]

Next, an operation performed by the image coding device in Embodiment 8 is described.

The operation performed by the image coding device in is Embodiment 8 is identical to the operation performed in Embodiment 6. However, data from the two pixel coding units 104 and 105 is temporarily held by the two data buffers 136 and 137, respectively, instead of being sent directly to the two variable-length coding units 106 and 107. Each of the data buffers 136 and 137 has sufficient capacity corresponding to the data provided during the process executed by the corresponding one of the two variable-length coding units 106 and 107. Therefore, the processing times can be equalized.

The processing time taken by each of the two variable-length coding units 106 and 107 is basically proportionate to the corresponding number of bits. According to the H.264 standard, when an average stream bit rate is approximately 20 Mbps and a frame rate is 30 frames per second, the number of bits per picture is approximately 0.67 Mbits.

In reality, however, the number of bits allowed per picture is up to approximately ten times as many as 0.67 Mbits. Since the average bit rate is approximately 20 Mbps, a picture that follows a picture with the largest number of bits has a small number of bits. Therefore, the processing time significantly varies depending on a picture. This means that a smooth coding process can be only achieved when the operating frequency is increased.

The image coding device in Embodiment 8 implements a smooth coding process by equalizing the processing times among pictures, without increasing the operating frequency.

It should be noted that, when the total coding amount of target slices is equal between the coding units, performance required of the decoding units can be suppressed.

Even when the processing time taken by the variable-length coding unit is significantly longer than the processing time taken by the pixel coding unit, the image coding device in Embodiment 8 can equalize the processing times using the two data buffers 136 and 137. Accordingly, even when the operating frequency is low, the image coding device in Embodiment 8 can smoothly implement an image coding process.

### [8-5. Supplemental Remarks]

Embodiment 8 has described an example where the configuration of the neighboring information memory is the same as in the image coding device according to Embodiment 6. However, the configuration may be based on any other Embodiment described above.

Moreover, in order to reduce the capacity of the data buffer or reduce the bandwidth to access the data buffer, the data on which the pixel coding process has been performed by the pixel coding unit may be compressed and then the variable-length coding unit may decompress the compressed data before performing the variable-length coding process.

Embodiment 8 includes the two variable-length coding units and the two pixel coding units. However, the number of variable-length coding units may be different from the number of pixel coding units. For example, the number of variable-length coding units may be one and then the number of pixel coding units may be two. These numbers can be determined freely as long as performance is satisfied.

Moreover, the number of coding units is two in Embodiment 8. However, the number of coding units is not limited two, and may be three, four, or more.

Embodiment 8 has described an example of the application to the variable-length coding method. However, the coding method may be any other coding method, such as arithmetic coding, Huffman coding, or run-length coding, as long as the method references to data on a neighboring macroblock.

Furthermore, the number of macroblocks in a slice in a vertical direction is three in Embodiment 8. However, the number of macroblocks in a slice in the vertical direction is not limited to three, and may be less or more than three. Moreover, although the number of slices in a picture is four in Embodiment 8, a picture may include any number of slices.

Moreover, in Embodiment 8, the neighboring information checking is performed before each process and the neighboring information writing is performed after each process. However, the neighboring information checking and the neighboring information writing may be performed on a macroblock-by-macroblock basis. When these checking and writing processes are performed on a macroblock-by-macroblock basis, the number of management tables may be one.

Furthermore, Embodiment 8 describes each process based on an example compliant with the H.264 standard, except for the process of making reference between the slices. However, the coding method may be any other method, such as MPEG-2, MPEG-4, or VC-1, as long as the method performs coding by reference to information on a neighboring macroblock.

Moreover, in Embodiment 8, the target macroblock references to four macroblocks, which are the left, immediately-above, upper-right, and upper-left macroblocks. However, only the left macroblock or only the left and immediately-above macroblocks may be referenced. Alternatively, the macroblocks to be referenced may be different depending on a process.

Furthermore, the component which stores information is a memory in Embodiment 8. However, the component which stores information may be any other memory element, such as a flip-flop.

Moreover, in Embodiment 8, a single neighboring information memory stores all the pieces of neighboring information used for, for example, arithmetic coding, motion vector calculation, intra-picture prediction, and deblocking filtering. However, the neighboring information may be stored for each process in a different memory or in a memory element such as a flip-flop.

Moreover, the neighboring information memory may store the data on the entire macroblock, as to the motion vector, the reconstructed image, or the result of the deblocking filter process. Alternatively, the neighboring information memory may store only the data to be referenced later, thereby further reducing the capacity of the neighboring information memory.

### Embodiment 9

Next, an image decoding device according to Embodiment 9 of the present invention is described.

In Embodiment 9, the image decoding device according to Embodiment 1 is implemented into a large scale integration (LSI) which is typically a semiconductor integrated circuit.

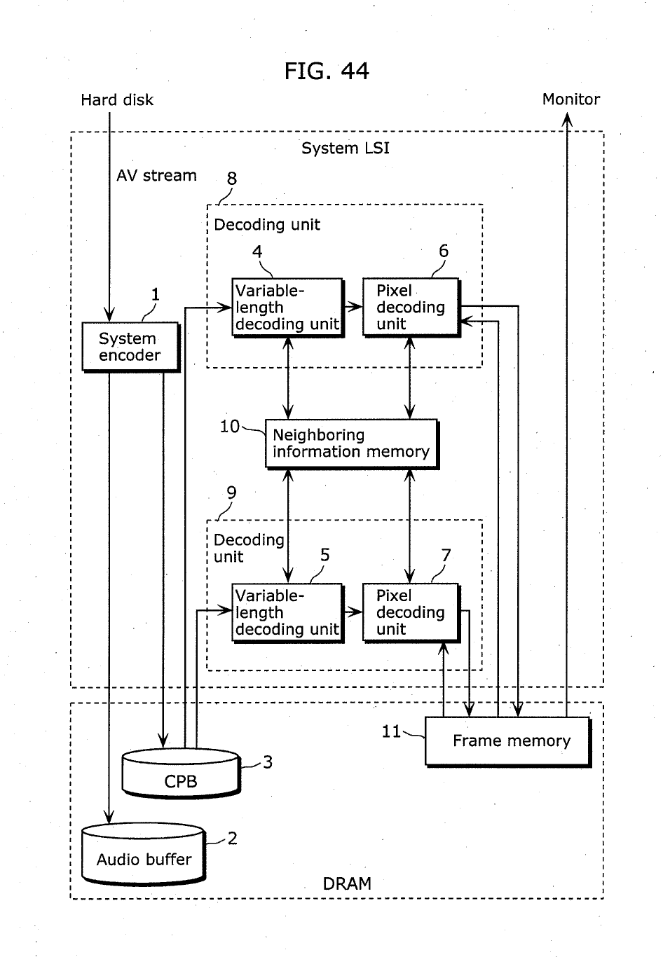

FIG. 44 is a block diagram showing the image decoding device in Embodiment 9.

The components shown may be integrated into individual chips or some or all of them may be integrated into one chip. Although referred to as the LSI here, the integrated circuit may be referred to as an integrated circuit (IC), a system LSI, a super LSI, or an ultra LSI depending on the degree of integration.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Moreover, when a circuit integration technology that replaces LSIs comes along owing to advances of the semiconductor technology or to a separate derivative technology, the function blocks should be understandably integrated using that technology. There can be a possibility of adaptation of biotechnology, for example.

In addition, the semiconductor chip on which the image decoding device according to Embodiment 9 can be combined with a display for drawing images, to form an image drawing device depending on various applications. The present invention can thereby be used as an information drawing means for a mobile phone, a television set, a digital video recorder, a digital camcorder, a vehicle navigation device, and the like. The display in the combination may be, for example: a cathode-ray tube (CRT); a flat display such as a liquid crystal display, a plasma display panel (PDP), or an organic electroluminescent (EL) display; or a projection display represented by a projector.

Embodiment 9 is configured with the system LSI and a dynamic random access memory (DRAM). However, Embodiment 9 may be configured with a different storage device, such as an embedded DRAM (eDRAM), a static random access memory (SRAM), or a hard disk.

### Embodiment 10

Next, an image coding device according to Embodiment 10 of the present invention is described.

In Embodiment 10, the image coding device according to Embodiment 6 is implemented into an LSI which is typically a semiconductor integrated circuit.

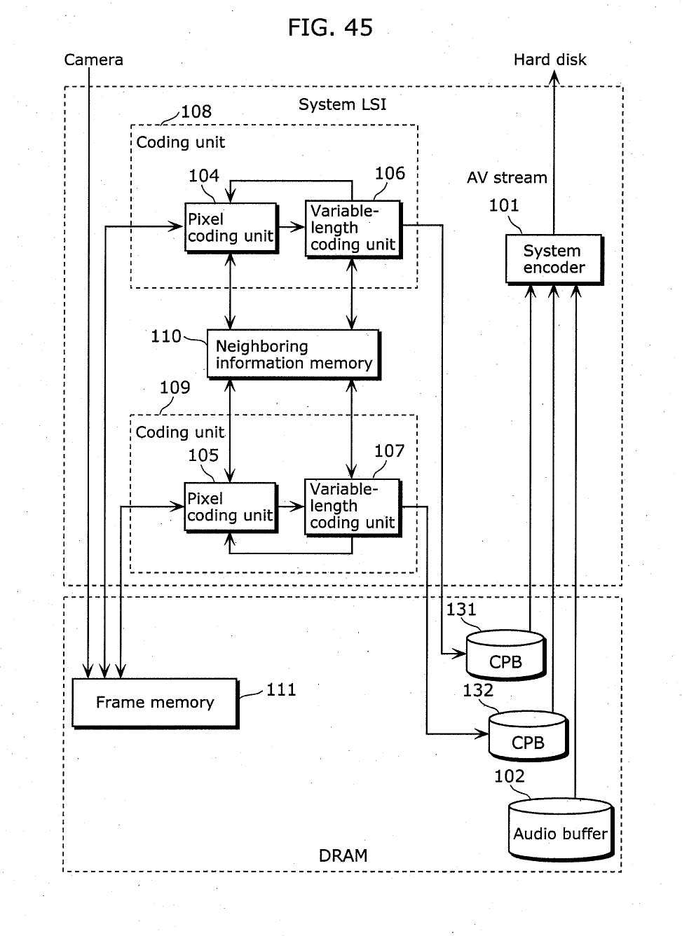

FIG. 45 is a block diagram showing the image coding device in Embodiment 10.

The components shown may be integrated into individual chips or some or all of them may be integrated into one chip. Although referred to as the LSI here, the integrated circuit may be referred to as an integrated circuit (IC), a system LSI, a super LSI, or an ultra LSI depending on the degree of integration.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Moreover, when a circuit integration technology that replaces LSIs comes along owing to advances of the semiconductor technology or to a separate derivative technology, the function blocks should be understandably integrated using that technology. There can be a possibility of adaptation of biotechnology, for example.

In addition, the semiconductor chip on which the image coding device according to Embodiment 10 can be combined with a display for drawing images, to form an image drawing device depending on various applications. The present invention can thereby be used as an information drawing means for a mobile phone, a television set, a digital video recorder, a digital camcorder, a digital still camera, and the like.

Embodiment 10 is configured with the system LSI and a DRAM. However, Embodiment 10 may be configured with a different storage device, such as an eDRAM, an SRAM, or a hard disk.

### Embodiment 11

By recording a program, which realizes the image coding method and the image decoding method described in each of the embodiments, onto a recording medium, it is possible to easily perform the processing as described in each of the embodiments in an independent computer system. The recording medium may be any mediums, such as a magnetic disk, an optical disk, a magnet-optical disk, an integrated circuit (IC) card, and a semiconductor memory, as far as the mediums can record the program.

Furthermore, the applications of the image coding method and the image decoding method described in each of the above embodiments, and a system using such applications are described below.

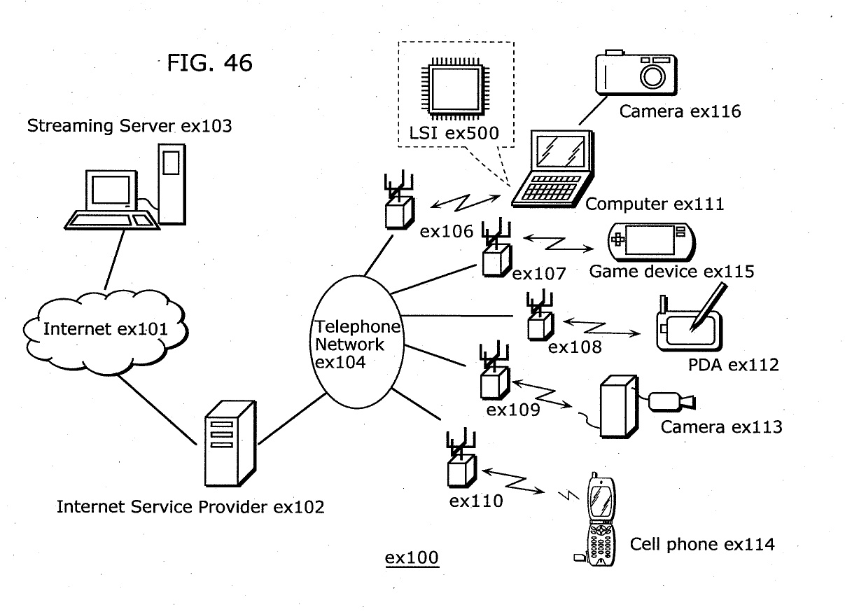

FIG. 46 is a block diagram showing the overall configuration of a content supply system ex100 for realizing content distribution service. The area for providing communication service is divided into cells of desired size, and base stations ex106 to ex110 which are fixed wireless stations, are placed in respective cells.

In this content supply system ex100, various devices such as a computer ex111, a Personal Digital Assistant (PDA) ex112, a camera ex113, a cell phone ex114 and a game device ex115 are connected to one another, via a telephone network ex104 and base stations ex106 to ex110. Furthermore, the various devices are connected to the Internet ex101 via an Internet service provider ex102.

However, the content supply system ex100 is not limited to the combination as shown in FIG. 46, and may include a combination of any of these devices which are connected to each other. Also, each device may be connected directly to the telephone network ex104, not through the base stations ex106 to ex110 which are the fixed wireless stations. Furthermore, the devices may be connected directly to one another via Near Field Communication (NFC) or the like.

The camera ex113 is a device such as a digital video camera capable of shooting moving images. The camera ex116 is a device such as a digital video camera capable of shooting still images and moving images. The cell phone ex114 may be any of a cell phone of a Global System for Mobile Communications (GSM) system, a Code Division Multiple Access (CDMA) system, a Wideband-Code Division Multiple Access (W-CDMA) system, a Long Term Evolution (LTE) system, a High Speed Packet Access (HSPA) system, a Personal Handy-phone System (PHS), and the like.

In the content supply system ex100, the camera ex113 is connected to a streaming server ex103 via the base station ex109 and the telephone network ex104, which realizes live distribution or the like. In the live distribution, the coding as described in the above embodiments is performed for a content (such as a video of a live music performance) shot by a user using the camera ex113, and the coded content is provided to the streaming server ex103. On the other hand, the streaming server ex103 makes steam distribution of the received content data to the clients at their requests. The clients include the computer ex111, the PDA ex112, the camera ex113, the cell phone ex114, the game device ex115, and the like, capable of decoding the above-mentioned coded data. Each device receiving the distributed data decodes the received data to be reproduced.

Here, the coding of the data shot by the camera may be performed by the camera ex113, the streaming server ex103 for transmitting the data, or the like. Likewise, either the client or the streaming server ex103 may decode the distributed data, or both of them may share the decoding. Also, the still image and/or moving image data shot by the camera ex116 may be transmitted not only to the camera ex113 but also to the streaming server ex103 via the computer ex111. In this case, either the camera ex116, the computer ex111, or the streaming server ex103 may perform the coding, or all of them may share the coding.

It should be noted that the above-described coding and the decoding are performed by a Large Scale Integration (LSI) ex500 generally included in each of the computer ex111 and the devices. The LSI ex500 may be implemented as a single chip or a plurality of chips. It should be noted that software for coding and decoding images may be integrated into any type of a recording medium (such as a CD-ROM, a flexible disk and a hard disk) that is readable by the computer ex111 or the like, so that the coding and decoding are performed by using the software. Furthermore, if the cell phone ex114 is a camera-equipped cell phone, it may transmit generated moving image data. This moving image data is the data coded by the LSI ex500 included in the cell phone ex114.

It should be noted that the streaming server ex103 may be implemented as a plurality of servers or a plurality of computers, so that data is divided into pieces to be processed, recorded, and distributed separately.

As described above, the content supply system ex100 enables the clients to receive and reproduce coded data. Thus, in the content supply system ex100, the clients can receive information transmitted by the user, then decode and reproduce it, so that the user without specific rights nor equipment can realize individual broadcasting.

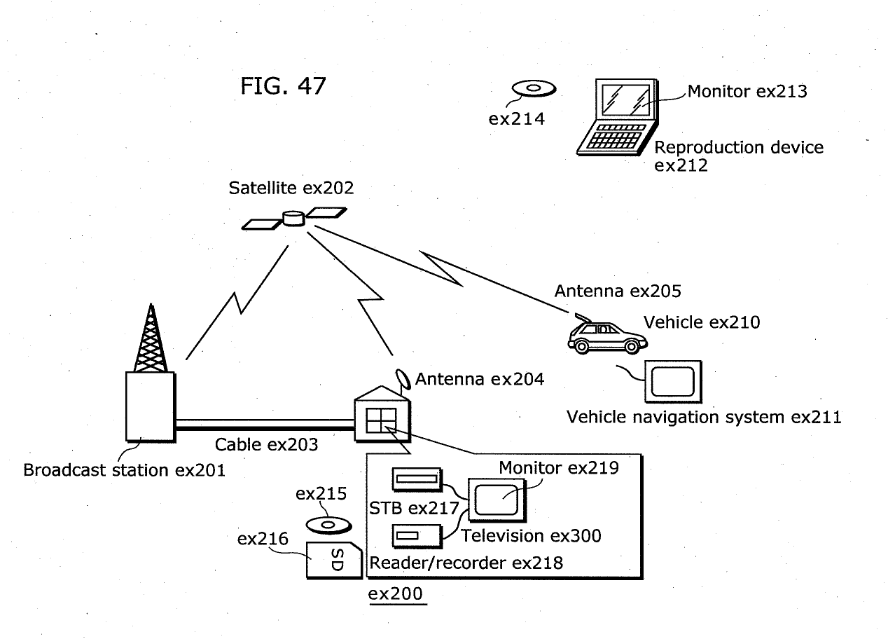

The present invention is not limited to the example of the content supply system ex100. At least either the image coding device or the image decoding device in the above embodiments can be incorporated into the digital broadcast system ex200 as shown in FIG. 47. More specifically, a bit stream of video information is transmitted from a broadcast station ex201 to a communication or broadcast satellite ex202 via radio waves. The bitstream is a coded bitstream generated by the image coding method described in the above embodiments. Upon receipt of it, the broadcast satellite ex202 transmits radio waves for broadcasting, and a home antenna ex204 with a satellite broadcast reception function receives the radio waves. A device such as a television (receiver) ex300 or a Set Top Box (STB) ex217 decodes the coded bit stream for reproduction.

The image decoding device described in the above embodiments can be implemented in a reproduction device ex212 for reading and decoding a coded bit stream recorded on a recording medium ex214 such as a CD and DVD that is a recording medium. In this case, the reproduced video signals are displayed on a monitor ex213.

The image decoding device or the image coding device described in the above embodiments can be implemented in a reader/recorder ex218 for reading and decoding a coded bitstream recorded on a recording medium ex215 such as a DVD and a BD or for coding and writing video signals into the recording medium ex215. In this case, the reproduced video signals are displayed on a monitor ex219, and the recording medium ex215, on which the coded bitstream is recorded, allows a different device of system to reproduce the video signals. It is also conceived to implement the image decoding device in the set top box ex217 connected to a cable ex203 for cable television or the antenna ex204 for satellite and/or terrestrial broadcasting so as to reproduce them on a monitor ex219 of the television. The image decoding device may be incorporated into the television, not in the set top box.

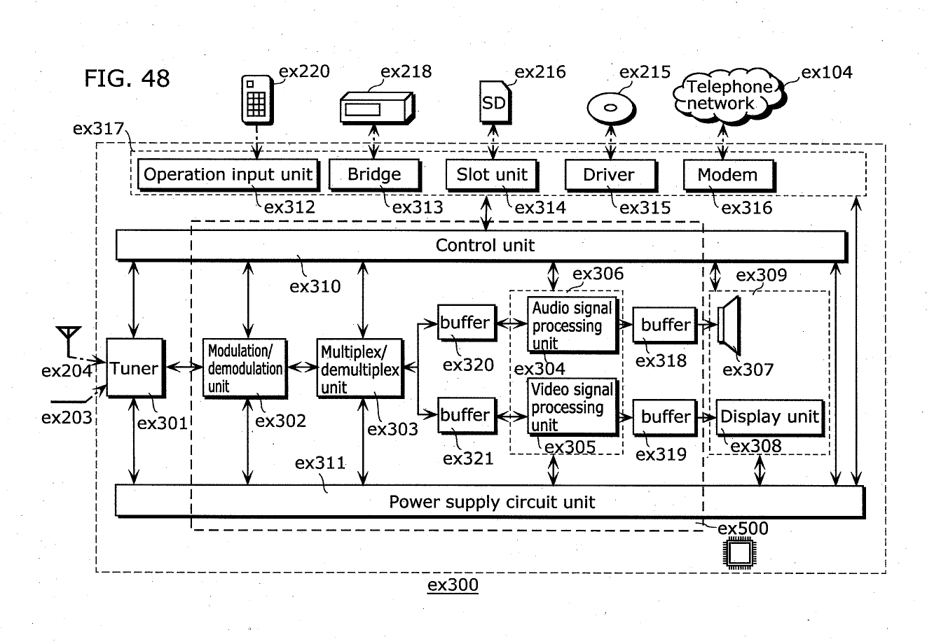

FIG. 48 is a diagram showing a television (receiver) ex300 using the image decoding method described in the above embodiments. The television ex300 includes: a tuner ex301 that receives or outputs a bitstream of video information via the antenna ex204, the cable ex203, or the like that receives the above broadcasting; a modulation/demodulation unit ex302 that demodulates the received coded data or modulates generated coded data to be transmitted to the outside; and a multiplex/demultiplex unit ex303 that demultiplexes the modulated video data from the modulated voice data or multiplexes the coded video data and the coded voice data.

In addition, the television ex300 includes: a signal processing unit ex306 having (a) a voice signal processing unit ex304 that decodes or codes voice data and (b) a video signal processing unit ex305 that decodes or codes video data; and an output unit ex309 having (c) a speaker ex307 that outputs the decoded voice signal and (d) a display unit ex308, such as a display, that displays the decoded video signal. Furthermore, the television ex300 includes an interface unit ex317 having an operation input unit ex312 that receives inputs of user operations, and the like. Moreover, the television ex300 includes: a control unit ex310 for the overall controlling of the respective units; and a power supply circuit unit ex311 that supplies the respective units with power.

In addition to the operation input unit ex312, the interface unit ex317 may include: a bridge ex313 connected to external devices such as the reader/recorder ex218; a slot unit ex314 enabling the recording medium ex216 such as a SD card to be attached to the interface unit ex317; a driver ex315 for connecting to an external recording medium such as a hard disk; a modem ex316 connected to a telephone network; and the like. It should be noted that the recording medium ex216 enables information to be electrically recorded on a stored nonvolatile/volatile semiconductor memory device.

The units in the television ex300 are connected to one another via a synchronous bus.

First, the description is given for the structure by which the television ex300 decodes and reproduces data received from the outside via the antenna ex204 or the like. The television ex300 receives a user operation from a remote controller ex220 or the like. Then, under the control of the control unit ex310 having a CPU and the like, the television ex300 demodulates video data and voice data at the modulation/demodulation unit ex302, and demultiplexes the demodulated video data from the demodulated voice data at the multiplex/demultiplex unit ex303. In addition, the television ex300 decodes the demultiplexed voice data at the voice signal processing unit ex304, and decodes the demultiplexed video data at the video signal processing unit ex305 using the decoding method described in the above embodiments. The decoded voice signal and the decoded video signal are separately outputted from the output unit ex309 to the outside. When outputting the signals, the signals may be temporarily accumulated in, for example, buffers ex318 and ex319, so that the voice signal and the video signal are reproduced in synchronization with each other. Furthermore, the television ex300 may read the coded bitstream, not from broadcasting or the like but from the recording mediums ex215 and ex216 such as a magnetic/optical disk and a SD card.

Next, the description is given for the structure by which the television ex300 codes voice signal and video signal, and transmits the coded signals to the outside or writes them onto a recording medium or the like. The television ex300 receives a user operation from the remote controller ex220 or the like, and then, under the control of the control unit ex310, codes voice signal at the voice signal processing unit ex304, and codes video data at the video signal processing unit ex305 using the coding method described in the above embodiments. The coded voice signal and the coded video signal are multiplexed at the multiplex/demultiplex unit ex303 and then outputted to the outside. When multiplexing the signals, the signals may be temporarily accumulated in, for example, buffers ex320 and ex321, so that the voice signal and the video signal are in synchronization with each other.

It should be noted that the buffers ex318 to ex321 may be implemented as a plurality of buffers as shown, or may share one or more buffers. It should also be noted that, besides the shown structure, it is possible to include a buffer, for example, between the modulation/demodulation unit ex302 and the multiplex/demultiplex unit ex303, so that the buffer serves as a buffer preventing system overflow and underflow, and thereby accumulate data in the buffer.

It should also be noted that, in addition to the structure for receiving voice data and video data from broadcasting, recording mediums, and the lie, the television ex300 may also have a structure for receiving audio inputs from a microphone and a camera, so that the coding is preformed for the received data. Here, although it has been described that the television ex300 can perform the above-described coding, multiplexing, and providing to the outside, it is also possible that the television ex300 cannot perform all of them but can perform one of the coding, multiplexing, and providing to the outside.

It should be noted that, when the reader/recorder ex218 is to read or write a coded bitstream from/into a recording medium, either the television ex300 or the reader/recorder ex218 may perform the above-described decoding or coding, or the television ex300 and the reader/recorder ex218 may share the above-described decoding or coding.

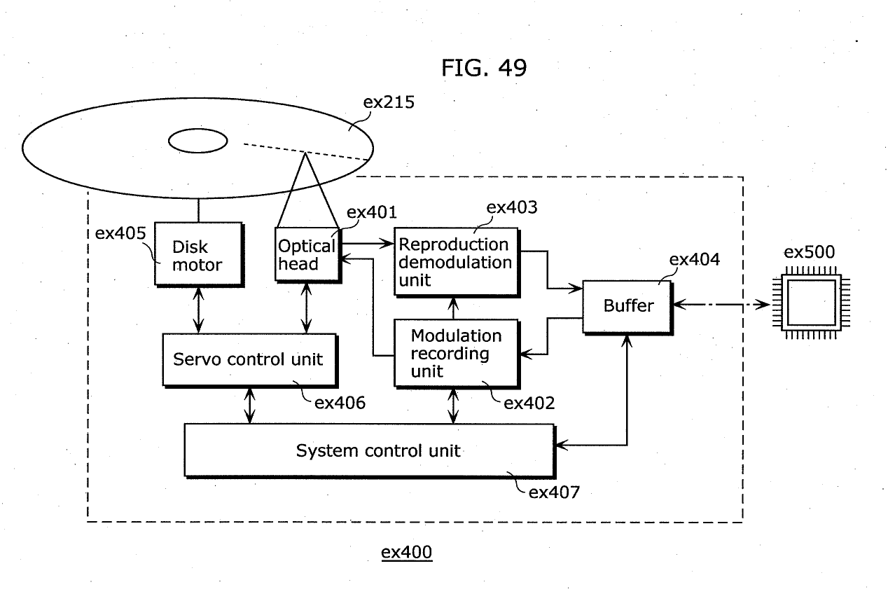

For one example, FIG. 49 shows a structure of an information reproducing/recording unit ex400 in the case where data is read from or written into an optical disk. The information reproducing/recording unit ex400 includes the following units ex401 to ex407.

The optical head ex401 writes information into the recording medium ex215 as an optical disk by irradiating laser spot on a recording surface of the recording medium ex215, and reads information from the recording medium ex215 by detecting light reflected on the recording surface of the recording medium ex215. The modulation recording unit ex402 electrically drives a semiconductor laser included in the optical head ex401, and thereby modulates laser light according to recorded data. A reproduction demodulation unit ex403 amplifies reproduction signal that is obtained by electrically detecting light reflected on the recording surface by a photo detector included in the optical head ex401, then demultiplexes and demodulates signal components recorded on the recording medium ex215, and reproduces necessary information. A buffer ex404 temporarily holds the information to be recorded onto the recording medium ex215, and the information reproduced from the recording medium ex215. A disk motor ex405 rotates the recording medium ex215. A servo control unit ex406 moves the optical head ex401 to a predetermined information track while controlling rotation driving of the disk motor ex405, thereby performing tracking processing of the laser spot.

The system control unit ex407 controls the overall information reproducing/recording unit ex400. The above-described reading and writing are realized when the system control unit ex407 records and reproduces information via the optical head ex401 while cooperating the modulation recording unit ex402, the reproduction demodulation unit ex403, and the servo control unit ex406, by using various information stored in the buffer ex404 and new information generated and added as needed. The system control unit ex407 includes, for example, a microprocessor, and performs the above processing by executing a reading/writing program.

Although it has been described above that the optical head ex401 irradiates laser spot, the optical head ex401 may perform higher-density recording by using near-field light.

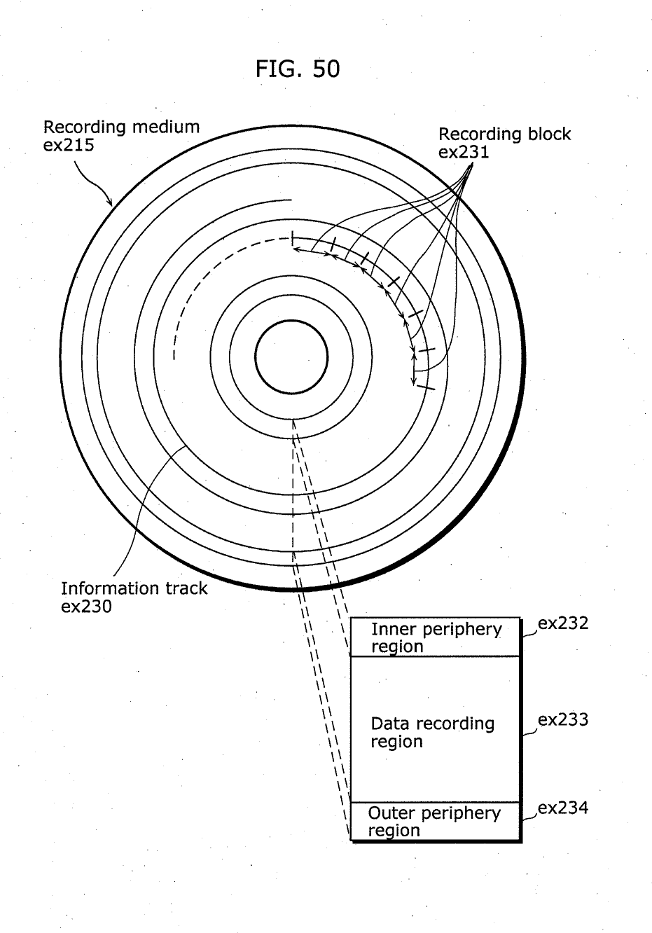

FIG. 50 shows a schematic diagram of the recording medium ex215 that is an optical disk. On the recording surface of the recording medium ex215, guide grooves are formed in a spiral shape, and on an information track ex230, address information indicating an absolute position on the disk is previously recorded using a change of the groove shape. The address information includes information for identifying a position of a recording block ex231 that is a unit for recording data, and a devise performing recording and reproduction is capable of specifying the recording block by reproducing the information track ex230 to read the address information. Moreover, the recording medium ex215 includes a data recording region ex233, an inner periphery region ex232, and an outer periphery region ex234. The data recording region ex233 is a region on which user data is recorded. The inner periphery region ex232 and the outer periphery region ex234 which are provided in the inner periphery and the outer periphery, respectively, of the data recording region ex233 are for specific uses except the user data recording.

The information reproducing/recording unit ex400 reads/writes coded voice data and video data or coded data generated by multiplexing them, from/into such data recording region ex233 of the recording medium ex215.

Although the above has been described giving the example of a one-layer optical disk such as a DVD or a BD, the optical disk is not limited to the above but may be a multi-layer optical disk so that data can be recorded onto other regions in addition to the surface. Furthermore, the optical disk may have a structure for multidimensional recording/reproducing, such as data recording using color lights having various different wavelengths on the same position of the disk, or recording of layers of different pieces of information from various angles.

It should also be noted that it is possible in the digital broadcasting system ex200 that the vehicle ex210 having the antenna ex205 receives data from the satellite ex202 or the like, and reproduces moving images on the display device such as the vehicle navigation system ex211 or the like in the vehicle ex210. As for the configuration of the vehicle navigation system ex211, a configuration added with a GPS receiving unit to the units as shown in FIG. 48, is conceivable. The same applies to the computer ex111, the cell phone ex114 and others. Moreover, likewise the television ex300, three types of implementations can be conceived for a terminal such as the above-mentioned cell phone ex114: a communication terminal equipped with both an encoder and a decoder; a sending terminal equipped with an encoder only; and a receiving terminal equipped with a decoder only.

Thus, the image coding method and the image decoding method described in the above embodiments can be used in any of the above-described devices and systems, and thereby the effects described in the above embodiments can be obtained.

It should be noted that the present invention is not limited to the above embodiments but various variations and modifications are possible in the embodiments without departing from the scope of the present invention.

### Embodiment 12

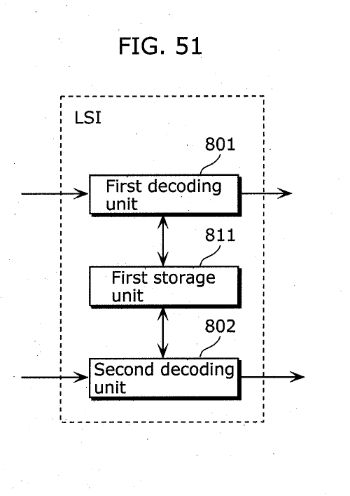

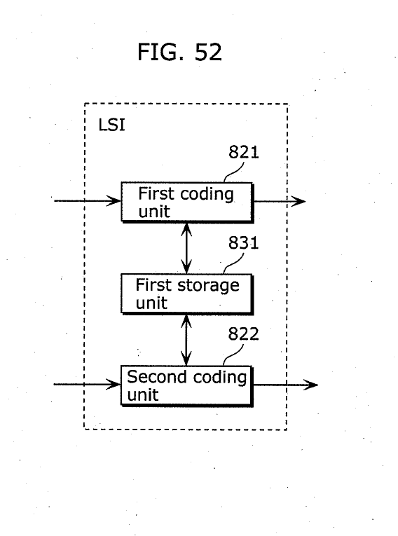

In Embodiment 12, the image decoding device according to Embodiment 1 and the image coding device according to Embodiment 6 are implemented into LSIs which are typically semiconductor integrated circuits. FIG. 51 and FIG. 52 show Embodiment 12. The components included in the image decoding device are implemented into the LSI shown in FIG. 51, and the components included in the image coding device are implemented into the LSI shown in FIG. 52.

These may be integrated separately, or a part or all of them may be integrated into a single chip. Here, the integrated circuit is referred to as a LSI, but the integrated circuit can be called an IC, a system LSI, a super LSI or an ultra LSI depending on their degrees of integration.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

Moreover, the semiconductor chip on which the image decoding device according to the embodiments is combined with a display for drawing images to form an image drawing device depending on various applications. The present invention can thereby be used as an information drawing means for a mobile phone, a television set, a digital video recorder, digital camcorder, a vehicle navigation device, and the like. The display in the combination may be a cathode-ray tube (CRT), a flat display such as a liquid crystal display, a plasma display panel (PDP), or an organic light emitting display (OLED), a projection display represented by a projector, or the like.

It should also be noted that the LSI according to Embodiment 12 may perform coding and decoding in cooperation with a bitstream buffer on which coded streams are accumulated and a Dynamic Random Access Memory (DRAM) including a frame memory on which images are accumulated. The LSI according to Embodiment 12 may be cooperated not with a DRAM, but with a different storage device such as an embedded DRAM (eDRAM), a Static Random Access Memory (SRAM), or a hard disk.

### Embodiment 13

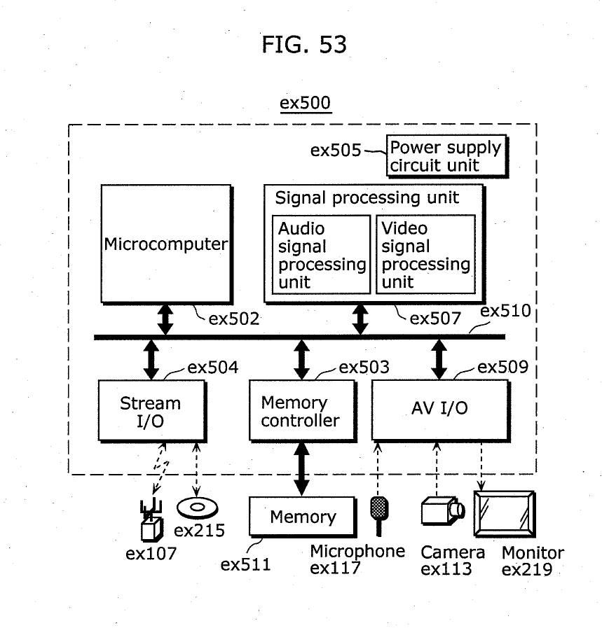

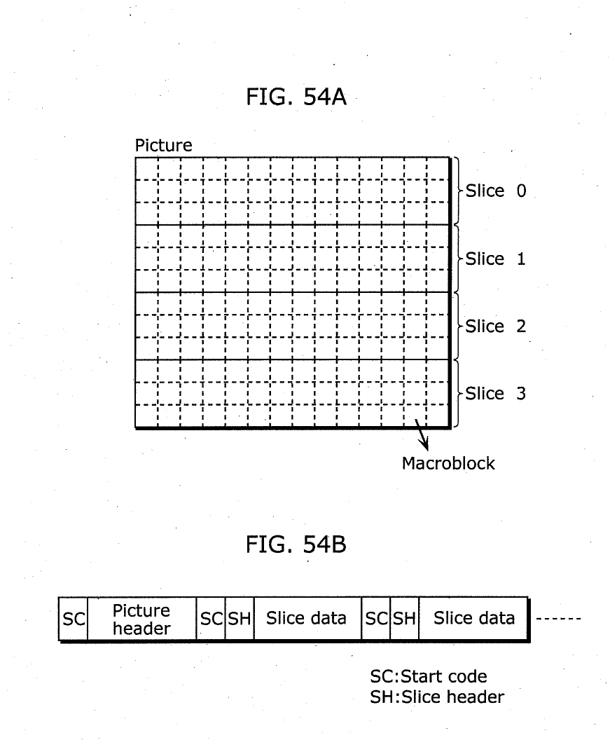

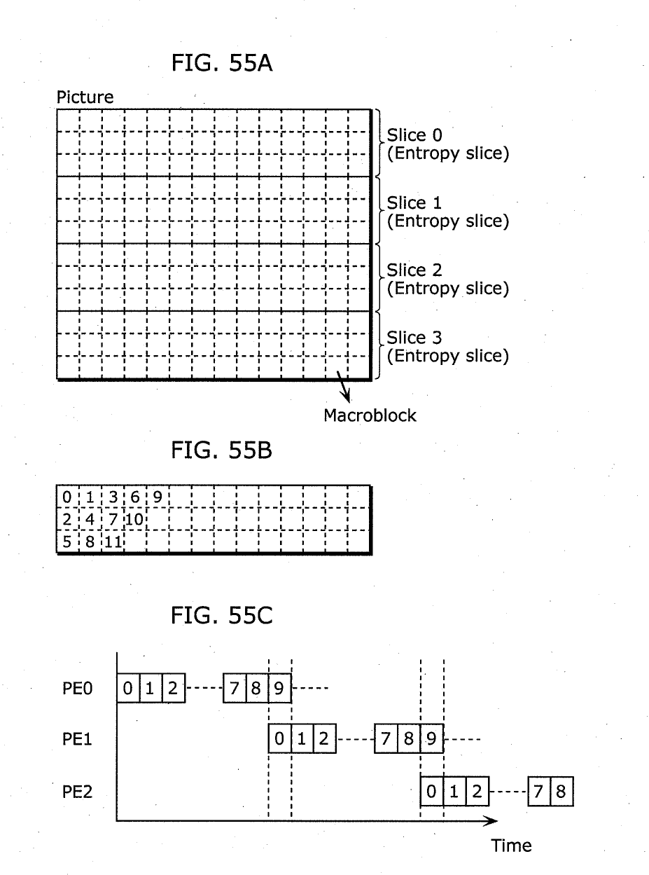

In Embodiment 13, the image coding device, the image decoding device, the image coding method, and the image decoding method which have been described in the above embodiments are typically implemented into a Large Scale Integration (LSI) which is an integrated circuit. As one example, FIG. 53 shows a structure of a LSI ex500 on which they are integrated into a single chip. The LSI ex500 includes the following units ex502 to ex509 which are connected to one another via a bus ex510. When a power source is ON, a power supply circuit unit ex505 supplies power to the respective units to activate them to be capable of operating.

For example, in the case of coding, the LSI ex500 receives input audio/visual (AV) signals from an AV I/O ex509 via the microphone ex117, the camera ex113, or the like. The input AV signals are temporarily accumulated in an external memory ex511 such as a SDRAM. The accumulated data is, for example, divided into a plurality of times depending on a processing amount and a processing speed, and eventually provided to a signal processing unit ex507. The signal processing unit ex507 performs coding of voice signal and/or coding of video signal. Here, the coding of video signal is the coding described in the above embodiments. Furthermore, the signal processing unit ex507 performs multiplexing of the coded voice data and the coded video data and other processing as needed, and provides the resulting data from a stream I/O ex504 to the outside. The output bitstream is transmitted to the base station ex107, or written to the recording medium ex215.

Moreover, for example, in the case of decoding, under the control of the microcomputer ex502, the LSI ex500 temporarily accumulates, to a memory ex511 or the like, coded data that is obtained using the stream I/O ex504 via the base station ex107, or coded data that is obtained by reading it from the recording medium ex215. Under the control of the microcomputer ex502, the accumulated data is, for example, divided into a plurality of times depending on a processing amount and a processing speed, and eventually provided to the signal processing unit ex507. The signal processing unit ex507 performs decoding of voice signal and/or decoding of video signal. Here, the decoding of video signal is the decoding described in the above embodiments. It is preferable that the decoded voice signal and the decoded video signal are temporarily accumulated in the memory ex511 or the like as needed, so that they can be reproduced in synchronization with each other. The decoded output signal is outputted from the AV I/O ex509 to the monitor ex219 or the like appropriately via the memory ex511 or the like. The access to the memory ex511 is actually performed via the memory controller ex503.

Although it has been described above that the memory ex511 is outside the LSI ex500, the memory ex511 may be included in the LSI ex500. It is possible that the LSI ex500 may be integrated into a single chip, or may be integrated separately.

Here, the integrated circuit is referred to as a LSI, but the integrated circuit can be called an IC, a system LSI, a super LSI or an ultra LSI depending on their degrees of integration.

The technique of integrated circuit is not limited to the LSI, and it may be implemented as a dedicated circuit or a general-purpose processor. It is also possible to use a Field Programmable Gate Array (FPGA) that can be programmed after manufacturing the LSI, or a reconfigurable processor in which connection and setting of circuit cells inside the LSI can be reconfigured.

Furthermore, if due to the progress of semiconductor technologies or their derivations, new technologies for integrated circuits appear to be replaced with the LSIs, it is, of course, possible to use such technologies to implement the functional blocks as an integrated circuit. For example, biotechnology and the like can be applied to the above implementation.

As described thus far, the image coding device and the image decoding device in Embodiments above are capable of using the spatial dependence across the boundary between the slices. Thus, the parallel processing is implemented efficiently.

Although the image coding device and the image decoding device in the present invention have been described based on the embodiments described above, the present invention is not limited to these embodiments. It is to be noted that various changes and modifications will be apparent to those skilled in the art. Therefore, unless such changes and modifications depart from the scope of the present invention, they should be construed as being included therein.

Moreover, the present invention can be implemented not only as the image coding device and the image decoding device, but also as methods including, as steps, the processing units included in the image coding device and the image decoding devices. Furthermore, the present invention can be implemented as a program causing a computer to execute these steps. Moreover, the present invention can be implemented as a computer-readable recording medium, such as a CD-ROM, having the program recorded thereon.

### INDUSTRIAL APPLICABILITY

The image decoding device and the image coding device in the present invention can be used for various applications. For example, the present invention can be used and is highly useful in high-resolution information display devices such as television sets, digital video recorders, vehicle navigation devices, mobile phones, digital cameras, and digital camcorders, and in image capturing devices.

### REFERENCE SIGNS LIST

1 system decoder
2, 102 audio buffer
3, 131, 132 CPB
4, 5 variable-length decoding unit
6, 7 pixel decoding unit
8, 9 decoding unit
10, 110 neighboring information memory
11, 111 frame memory
12, 13, 112, 113 stream buffer
14, 15 variable-length decoding processing unit
16, 116 inverse quantization unit
17, 117 inverse frequency transformation unit
18, 118 reconstruction unit
19, 119 intra-picture prediction unit
20 motion vector calculation unit
21, 121 motion compensation unit
22, 122 deblocking filter unit
23, 24 arithmetic decoding unit
25, 26 de-binarization unit
27, 28 inside-slice neighboring information memory
29, 50, 51 inter-slice neighboring information memory
36, 37, 136, 137 data buffer
101 system encoder
104, 105 pixel coding unit
106, 107 variable-length coding unit
108, 109 coding unit
114, 115 variable-length coding processing unit
133 difference calculation unit
134 frequency transformation unit
135 quantization unit
138 motion estimation unit
801 first decoding unit
802 second decoding unit
811, 831 first storage unit
812 second storage unit
813 third storage unit
821 first coding unit
822 second coding unit
841 first data buffer
842 second data buffer
851 first pixel decoding unit
852 second pixel decoding unit
ex100 content supply system
ex101 Internet
ex102 Internet service provider
ex103 streaming server
ex104 telephone network
ex106, ex107, ex108, ex109, ex110 base station
ex111 computer
ex112 Personal Digital Assistant (PDA)
ex113, ex116 camera
ex114 cell phone
ex115 game device
ex117 microphone
ex200 digital broadcasting system
ex201 broadcast station
ex202 broadcast satellite (satellite)
ex203 cable
ex204, ex205 antenna
ex210 vehicle
ex211 vehicle navigation system
ex212 reproduction device
ex213, ex219 monitor
ex214, ex215, ex216, recording medium
ex217 Set Top Box (STB)
ex218 reader/recorder
ex220 remote controller
ex230 information track
ex231 recording block
ex232 inner periphery region
ex233 data recording region
ex234 outer periphery region
ex300 television (receiving device)
ex301 tuner
ex302 modulation/demodulation unit
ex303 multiplex/demultiplex unit
ex304 voice signal processing unit
ex305 video signal processing unit
ex306, ex507 signal processing unit
ex307 speaker
ex308 display unit
ex309 output unit
ex310 control unit
ex311, ex505 power supply circuit unit
ex312 operation input unit
ex313 bridge
ex314 slot unit
ex315 driver
ex316 modem
ex317 interface unit
ex318, ex319, ex320, ex321, ex404 buffer
ex400 information reproducing/recording unit
ex401 optical head
ex402 modulation recording unit
ex403 reproduction demodulation unit
ex405 disk motor
ex406 servo control unit
ex407 system control unit
ex500 LSI
ex502 microcomputer
ex503 memory controller
ex504 stream I/O
ex509 AV I/O
ex510 bus
ex511 memory

1. An image decoding device that decodes an image having a plurality of slices each including at least one block, said image decoding device comprising:
a first decoding unit configured to decode at least one block included in a first slice among the slices;
a second decoding unit configured to decode at least one block included in a second slice different from the first slice among the slices;
a first storage unit configured to store inter-slice neighboring information that is (i) generated by decoding a boundary block that is one of the at least one block included in the first slice and is adjacent to the second slice and (ii) referenced when a boundary neighboring block that is one of the at least one block included in the second slice and is adjacent to the boundary block is decoded;
a second storage unit configured to store inside first-slice neighboring information that is (i) generated by decoding an inside first-slice block that is one of the at least one block included in the first slice and (ii) referenced when an inside first-slice neighboring block that is one of the at least one block included in the first slice and is adjacent to the inside first-slice block is decoded; and
a third storage unit configured to store inside second-slice neighboring information that is (i) generated by decoding an inside second-slice block that is one of the at least one block included in the second slice and (ii) referenced when an inside second-slice neighboring block that is one of the at least one block included in the second slice and is adjacent to the inside second-slice block is decoded,
wherein said first decoding unit is configured to: generate the inter-slice neighboring information by decoding the boundary block; store the generated inter-slice neighboring information into said first storage unit; generate the inside first-slice neighboring information by decoding the inside first-slice block; store the generated inside first-slice neighboring information into said second storage unit; and decode the inside first-slice neighboring block by reference to the inside first-slice neighboring information stored in said second storage unit, and
said second decoding unit is configured to: generate the inside second-slice neighboring information by decoding the inside second-slice block; store the generated inside second-slice neighboring information into said third storage unit; decode the inside second-slice neighboring block by reference to the inside second-slice neighboring information stored in said third storage unit; and decode the boundary neighboring block by reference to the inter-slice neighboring information stored in said first storage unit.

2-4. (canceled)

5. The image decoding device according to claim 1,
wherein said second decoding unit is configured to decode a block that is the boundary neighboring block and is the inside second-slice neighboring block, by reference to the inter-slice neighboring information stored in said first storage unit and the inside second-slice neighboring information stored in said third storage unit.

6. The image decoding device according to claim 1
wherein, after making reference to the inter-slice neighboring information stored in said first storage unit, said second decoding unit is configured to release an area storing the inter-slice neighboring information in said first storage unit when the inter-slice neighboring information is not to be referenced again.

7. The image decoding device according to claim 1, further comprising:
a first data buffer; and
a second data buffer,
wherein said first decoding unit is configured to perform a variable-length decoding process on the at least one block included in the first slice, and store first variable-length decoded data obtained as a result of the variable-length decoding process into said first data buffer,
said second decoding unit is configured to perform a variable-length decoding process on the at least one block included in the second slice, and store second variable-length decoded data obtained as a result of the variable-length decoding process into said second data buffer, and
said image decoding device further comprises:
a first pixel decoding unit configured to convert, into a pixel value, the first variable-length decoded data stored in the said first data buffer; and
a second pixel decoding unit configured to convert, into a pixel value, the second variable-length decoded data stored in the said second data buffer.

8. The image decoding device according to claim 1,
wherein said first storage unit is configured to store a management table indicating whether or not the inter-slice neighboring information is stored in said first storage unit,
said first decoding unit is configured to update the management table to indicate that the inter-slice neighboring information is stored in said first storage unit, when storing the inter-slice neighboring information into said first storage unit, and
said second decoding unit is configured to decode the boundary neighboring block by reference to the inter-slice neighboring information stored in said first storage unit, after verifying by reference to the management table that the inter-slice neighboring information is stored in said first storage unit.

9. The image decoding device according to claim 1,
wherein said first decoding unit is configured to notify said second decoding unit that the inter-slice neighboring information is stored in said first storage unit, after storing the inter-slice neighboring information into said first storage unit, and
said second decoding unit is configured to decode the boundary neighboring block by reference to the inter-slice neighboring information stored in said first storage unit, after being notified by said first decoding unit that the inter-slice neighboring information is stored in said first storage unit.

10. The image decoding device according to claim 1
wherein said second decoding unit is configured to verify whether or not the inter-slice neighboring information is stored in said first storage unit at predetermined intervals and, after verifying that the inter-slice neighboring information is stored in said first storage unit, decode the boundary neighboring block by reference to the inter-slice neighboring information stored in said first storage unit.

11. The image decoding device according to claim 1,
wherein said first decoding unit is configured to generate, by decoding the boundary block, coefficient information indicating whether or not a non-zero coefficient is present, and store the generated coefficient information as the inter-slice neighboring information into said first storage unit, and
said second decoding unit is configured to decode the boundary neighboring block by reference to the coefficient information stored as the inter-slice neighboring information in said first storage unit.

12. An image coding device that codes an image having a plurality of slices each including at least one block, said image coding device comprising:
a first coding unit configured to code at least one block included in a first slice among the slices;
a second coding unit configured to code at least one block included in a second slice different from the first slice among the slices;
a first storage unit configured to store inter-slice neighboring information that is (i) generated by coding a boundary block that is one of the at least one block included in the first slice and is adjacent to the second slice and (ii) referenced when a boundary neighboring block that is one of the at least one block included in the second slice and is adjacent to the boundary block is coded;
a second storage unit configured to store inside first-slice neighboring information that is (i) generated by coding an inside first-slice block that is one of the at least one block included in the first slice and (ii) referenced when an inside first-slice neighboring block that is one of the at least one block included in the first slice and is adjacent to the inside first-slice block is coded; and
a third storage unit configured to store inside second-slice neighboring information that is (i) generated by coding an inside second-slice block that is one of the at least one block included in the second slice and (ii) referenced when an inside second-slice neighboring block that is one of the at least one block included in the second slice and is adjacent to the inside second-slice block is coded,
wherein said first coding unit is configured to: generate the inter-slice neighboring information by coding the boundary block; store the generated inter-slice neighboring information into said first storage unit; generate the inside first-slice neighboring information by coding the inside first-slice block; store the generated inside first-slice neighboring information into said second storage unit; and code the inside first-slice neighboring block by reference to the inside first-slice neighboring information stored in said second storage unit, and
said second coding unit is configured to: generate the inside second-slice neighboring information by coding the inside second-slice block; store the generated inside second-slice neighboring information into said third storage unit; code the inside second-slice neighboring block by reference to the inside second-slice neighboring information stored in said third storage unit; and code the boundary neighboring block by reference to the inter-slice neighboring information stored in said first storage unit.

13. An image decoding method of decoding an image having a plurality of slices each including at least one block, said image decoding method comprising:
decoding at least one block included in a first slice among the slices; and
decoding at least one block included in a second slice different from the first slice among the slices,
wherein, in said decoding of the at least one block included in the first slice: inter-slice neighboring information is generated and stored into a first storage unit; inside first-slice neighboring information is generated and stored into a second storage unit; and an inside first-slice neighboring block is decoded by reference to the inside first-slice neighboring information stored in the second storage unit, the inter-slice neighboring information being (i) generated by decoding a boundary block that is one of the at least one block included in the first slice and is adjacent to the second slice and (ii) referenced when a boundary neighboring block that is one of the at least one block included in the second slice and is adjacent to the boundary block is decoded, and the inside first-slice neighboring information being (i) generated by decoding an inside first-slice block that is one of the at least one block included in the first slice and (ii) referenced when the inside first-slice neighboring block that is one of the at least one block included in the first slice and is adjacent to the inside first-slice block is decoded, and
in said decoding of the at least one block included in the second slice: inside second-slice neighboring information is generated and stored into a third storage unit; an inside second-slice neighboring block is decoded by reference to the inside second-slice neighboring information stored in the third storage unit; and the boundary neighboring block is decoded by reference to the inter-slice neighboring information stored in the first storage unit, the inside second-slice neighboring information being (i) generated by decoding an inside second-slice block that is one of the at least one block included in the second slice and (ii) referenced when the inside second-slice neighboring block that is one of the at least one block included in the second slice and is adjacent to the inside second-slice block is decoded.

14. An image coding method of coding an image having a plurality of slices each including at least one block, said image coding method comprising:
coding at least one block included in a first slice among the slices; and
coding at least one block included in a second slice different from the first slice among the slices,
wherein, in said coding of the at least one block included in the first slice: inter-slice neighboring information is generated and stored into a first storage unit; inside first-slice neighboring information is generated and stored into a second storage unit; and an inside first-slice neighboring block is coded by reference to the inside first-slice neighboring information stored in the second storage unit, the inter-slice neighboring information being (i) generated by coding a boundary block that is one of the at least one block included in the first slice and is adjacent to the second slice and (ii) referenced when a boundary neighboring block that is one of the at least one block included in the second slice and is adjacent to the boundary block is coded, and the inside first-slice neighboring information being (i) generated by coding an inside first-slice block that is one of the at least one block included in the first slice and (ii) referenced when the inside first-slice neighboring block that is one of the at least one block included in the first slice and is adjacent to the inside first-slice block is coded, and
in said coding of the at least one block included in the second slice: inside second-slice neighboring information is generated and stored into a third storage unit; an inside second-slice neighboring block is coded by reference to the inside second-slice neighboring information stored in the third storage unit; and the boundary neighboring block is coded by reference to the inter-slice neighboring information stored in the first storage unit, the inside second-slice neighboring information being (i) generated by coding an inside second-slice block that is one of the at least one block included in the second slice and (ii) referenced when the inside second-slice neighboring block that is one of the at least one block included in the second slice and is adjacent to the inside second-slice block is coded.

15. A non-transitory computer-readable recording medium for use in a computer, the recording medium having a computer program recorded thereon for causing the computer to execute the image decoding method according to claim 13.

16. A non-transitory computer-readable recording medium for use in a computer, the recording medium having a computer program recorded thereon for causing the computer to execute the image coding method according to claim 14.

17. An integrated circuit that decodes an image having a plurality of slices each including at least one block, said integrated circuit comprising:
a first decoding unit configured to decode at least one block included in a first slice among the slices;
a second decoding unit configured to decode at least one block included in a second slice different from the first slice among the slices;
a first storage unit configured to store inter-slice neighboring information that is (i) generated by decoding a boundary block that is one of the at least one block included in the first slice and is adjacent to the second slice and (ii) referenced when a boundary neighboring block that is one of the at least one block included in the second slice and is adjacent to the boundary block is decoded;
a second storage unit configured to store inside first-slice neighboring information that is (i) generated by decoding an inside first-slice block that is one of the at least one block included in the first slice and (ii) referenced when an inside first-slice neighboring block that is one of the at least one block included in the first slice and is adjacent to the inside first-slice block is decoded; and
a third storage unit configured to store inside second-slice neighboring information that is (i) generated by decoding an inside second-slice block that is one of the at least one block included in the second slice and (ii) referenced when an inside second-slice neighboring block that is one of the at least one block included in the second slice and is adjacent to the inside second-slice block is decoded,
wherein said first decoding unit is configured to: generate the inter-slice neighboring information by decoding the boundary block; store the generated inter-slice neighboring information into said first storage unit; generate the inside first-slice neighboring information by decoding the inside first-slice block; store the generated inside first-slice neighboring information into said second storage unit; and decode the inside first-slice neighboring block by reference to the inside first-slice neighboring information stored in said second storage unit, and
said second decoding unit is configured to: generate the inside second-slice neighboring information by decoding the inside second-slice block; store the generated inside second-slice neighboring information into said third storage unit; decode the inside second-slice neighboring block by reference to the inside second-slice neighboring information stored in said third storage unit; and decode the boundary neighboring block by reference to the inter-slice neighboring information stored in said first storage unit.

18. An integrated circuit that codes an image having a plurality of slices each including at least one block, said integrated circuit comprising:
a first coding unit configured to code at least one block included in a first slice among the slices;
a second coding unit configured to code at least one block included in a second slice different from the first slice among the slices;
a first storage unit configured to store inter-slice neighboring information that is (i) generated by coding a boundary block that is one of the at least one block included in the first slice and is adjacent to the second slice and (ii) referenced when a boundary neighboring block that is one of the at least one block included in the second slice and is adjacent to the boundary block is coded;
a second storage unit configured to store inside first-slice neighboring information that is (i) generated by coding an inside first-slice block that is one of the at least one block included in the first slice and (ii) referenced when an inside first-slice neighboring block that is one of the at least one block included in the first slice and is adjacent to the inside first-slice block is coded; and
a third storage unit configured to store inside second-slice neighboring information that is (i) generated by coding an inside second-slice block that is one of the at least one block included in the second slice and (ii) referenced when an inside second-slice neighboring block that is one of the at least one block included in the second slice and is adjacent to the inside second-slice block is coded,
wherein said first coding unit is configured to: generate the inter-slice neighboring information by coding the boundary block; store the generated inter-slice neighboring information into said first storage unit; generate the inside first-slice neighboring information by coding the inside first-slice block; store the generated inside first-slice neighboring information into said second storage unit; and code the inside first-slice neighboring block by reference to the inside first-slice neighboring information stored in said second storage unit, and
said second coding unit is configured to: generate the inside second-slice neighboring information by coding the inside second-slice block; store the generated inside second-slice neighboring information into said third storage unit; code the inside second-slice neighboring block by reference to the inside second-slice neighboring information stored in said third storage unit; and code the boundary neighboring block by reference to the inter-slice neighboring information stored in said first storage unit.
